(19) United States
(12) Patent Application Publication
(10) Pub. No.: US 2026/0046647 A1
(43) Pub. Date: Feb. 12, 2026

(54) DATA FOR TRAINING OF ARTIFICIAL INTELLIGENCE MODELS FOR BEAM PREDICTION

(71) Applicant: QUALCOMM Incorporated, San Diego, CA (US)

(72) Inventors: Rajeev KUMAR, San Diego, CA (US); Hamed PEZESHKI, SAN DIEGO, CA (US)

(21) Appl. No.: 19/288,891

(22) Filed: Aug. 1, 2025

Related U.S. Application Data
(60) Provisional application No. 63/681,040, filed on Aug. 8, 2024.

(51) Int. Cl. H04W 24/08

(52) U.S. Cl. CPC H04W 24/08

(57) ABSTRACT

Some wireless communications systems log data for measuring network performance or for determining coverage areas. In some examples, data logging may be performed in response to one or more events. Some examples of the techniques described herein may provide events for the collection or reporting of training data at a user equipment (UE) for network side models for beam management procedures. For instance, information for configuring these events may be provided to a UE. In some examples, events may be configured via reference signal configurations, or associated identifiers may be configured in a channel state information (CSI) report configuration. In some examples, the configuration information may be communicated via one or more radio resource control (RRC) or uplink control information (UCI) messages.

### CROSS REFERENCE

The present Application for Patent claims the benefit of U.S. Provisional Patent Application No. 63/681,040 by Kumar et al., entitled “DATA FOR TRAINING OF ARTIFICIAL INTELLIGENCE MODELS FOR BEAM PREDICTION,” filed Aug. 8, 2024, assigned to the assignee hereof, and which is expressly incorporated by reference herein.

### FIELD OF TECHNOLOGY

The following relates to wireless communications, including data for training of artificial intelligence models for beam prediction.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, at a first location, a first reference signal that corresponds to a first beam, storing first data for training of an artificial intelligence (AI) model for beam prediction, the first data based on the first reference signal, receiving, at a second location, a second reference signal that corresponds to a second beam, determining whether to store second data for training of the AI model for beam prediction based on a distance between the first location and the second location, the second data based on the second reference signal, and transmitting, to a network entity, at least one of the first data or the second data.

A UE for wireless communications is described. The UE may include one or more memories storing processor executable code, and one or more processors coupled with the one or more memories. The one or more processors may individually or collectively be operable to execute the code to cause the UE to receive, at a first location, a first reference signal that corresponds to a first beam, store first data for training of an AI model for beam prediction, the first data based on the first reference signal, receive, at a second location, a second reference signal that corresponds to a second beam, determine whether to store second data for training of the AI model for beam prediction based on a distance between the first location and the second location, the second data based on the second reference signal, and transmit, to a network entity, at least one of the first data or the second data.

Another UE for wireless communications is described. The UE may include means for receiving, at a first location, a first reference signal that corresponds to a first beam, means for storing first data for training of an AI model for beam prediction, the first data based on the first reference signal, means for receiving, at a second location, a second reference signal that corresponds to a second beam, means for determine whether to store second data for training of the AI model for beam prediction based on a distance between the first location and the second location, the second data based on the second reference signal, and means for transmitting, to a network entity, at least one of the first data or the second data.

A non-transitory computer-readable medium storing code for wireless communications is described. The code may include instructions executable by one or more processors to receive, at a first location, a first reference signal that corresponds to a first beam, store first data for training of an AI model for beam prediction, the first data based on the first reference signal, receive, at a second location, a second reference signal that corresponds to a second beam, determine whether to store second data for training of the AI model for beam prediction based on a distance between the first location and the second location, the second data based on the second reference signal, and transmit, to a network entity, at least one of the first data or the second data.

In some examples of the method, UEs, and non-transitory computer-readable medium described herein, the UE stores the second data based on the distance between the first location and the second location that satisfies a threshold distance.

In some examples of the method, UEs, and non-transitory computer-readable medium described herein, the UE refrains from storing the second data based on the distance between the first location and the second location failing to satisfy a threshold distance.

Some examples of the method, UEs, and non-transitory computer-readable medium described herein may further include operations, features, means, or instructions for receiving configuration information that indicates a threshold distance, where the first reference signal may be received at a first occasion of a set of occasions and the second reference signal may be received at a second occasion of the set of occasions, and where the UE stores the second data based on the distance between the first location and the second location that satisfies the threshold distance.

In some examples of the method, UEs, and non-transitory computer-readable medium described herein, the determination whether to store the second data may be based on a trajectory of the UE, the distance between the first location and the second location, or a quantity of occasions to receive reference signals.

A method for wireless communications by a UE is described. The method may include receiving, at a first occasion, a first reference signal that corresponds to a first beam, storing first data for training of an AI model for beam prediction based on a first indicator that corresponds to the first beam, the first data based on the first reference signal, receiving, at a second occasion, a second reference signal that corresponds to a second beam, determining whether to store second data for training of the AI model for beam prediction based on a second indicator that corresponds to the second beam, the second data based on the second reference signal, and transmitting, to a network entity, at least one of the first data or the second data.

A UE for wireless communications is described. The UE may include one or more memories storing processor executable code, and one or more processors coupled with the one or more memories. The one or more processors may individually or collectively be operable to execute the code to cause the UE to receive, at a first occasion, a first reference signal that corresponds to a first beam, store first data for training of an AI model for beam prediction based on a first indicator that corresponds to the first beam, the first data based on the first reference signal, receive, at a second occasion, a second reference signal that corresponds to a second beam, determine whether to store second data for training of the AI model for beam prediction based on a second indicator that corresponds to the second beam, the second data based on the second reference signal, and transmit, to a network entity, at least one of the first data or the second data.

Another UE for wireless communications is described. The UE may include means for receiving, at a first occasion, a first reference signal that corresponds to a first beam, means for storing first data for training of an AI model for beam prediction based on a first indicator that corresponds to the first beam, the first data based on the first reference signal, means for receiving, at a second occasion, a second reference signal that corresponds to a second beam, means for determining whether to store second data for training of the AI model for beam prediction based on a second indicator that corresponds to the second beam, the second data based on the second reference signal, and means for transmitting, to a network entity, at least one of the first data or the second data.

A non-transitory computer-readable medium storing code for wireless communications is described. The code may include instructions executable by one or more processors to receive, at a first occasion, a first reference signal that corresponds to a first beam, store first data for training of an AI model for beam prediction based on a first indicator that corresponds to the first beam, the first data based on the first reference signal, receive, at a second occasion, a second reference signal that corresponds to a second beam, determine whether to store second data for training of the AI model for beam prediction based on a second indicator that corresponds to the second beam, the second data based on the second reference signal, and transmit, to a network entity, at least one of the first data or the second data.

Some examples of the method, UEs, and non-transitory computer-readable medium described herein may further include operations, features, means, or instructions for receiving configuration information that indicates at least one indicator, a periodicity for sample collection, and at least one quantity of samples for collection, where the UE stores a first quantity of samples of the first reference signal of the first beam based on whether the first indicator corresponds to the at least one indicator and whether the first occasion corresponds to the periodicity for sample collection, and where the first quantity of samples may be less than or equal to the at least one quantity of samples for collection.

Some examples of the method, UEs, and non-transitory computer-readable medium described herein may further include operations, features, means, or instructions for refraining from storing the second data when the second indicator does not correspond to the at least one indicator or the second occasion does not correspond to the periodicity.

In some examples of the method, UEs, and non-transitory computer-readable medium described herein, the UE stores a second quantity of samples of the second reference signal of the second beam based on whether the second indicator corresponds to the at least one indicator and whether the second occasion corresponds to the periodicity for sample collection, and the second quantity of samples may be a different quantity than the first quantity of samples.

In some examples of the method, UEs, and non-transitory computer-readable medium described herein, the first indicator indicates a rank of the first beam in an order of beams based on a first measurement of the first beam, and the second indicator indicates a rank of the second beam in the order of beams based on a second measurement of the second beam.

In some examples of the method, UEs, and non-transitory computer-readable medium described herein, the UE stores the second data for the second occasion based on a change of the rank of the second indicator to a highest rank of the order of beams and the rank of the second indicator that corresponds to the second beam changes to the highest rank of the order of beams from the rank of the first indicator that corresponds to the first beam.

In some examples of the method, UEs, and non-transitory computer-readable medium described herein, the UE stores the second data for the second occasion based on a change of the rank of the second indicator to a highest rank of the order of beams and a satisfaction of a threshold quantity of samples and the highest rank of the order of beams changes from the first indicator that corresponds to the first beam to the second indicator that corresponds to the second beam for at least the threshold quantity of samples.

In some examples of the method, UEs, and non-transitory computer-readable medium described herein, the UE stores the first data for the first occasion based on a last sample of the first beam before a change of the rank of the second indicator to a highest rank of the order of beams.

In some examples of the method, UEs, and non-transitory computer-readable medium described herein, the UE stores the first data for the first occasion based on a last sample of the first beam before a change to a highest rank of the order of beams, and stores the second data for the second occasion based on an initial sample of the second beam after the change to the highest rank of the order of beams.

Some examples of the method, UEs, and non-transitory computer-readable medium described herein may further include operations, features, means, or instructions for refraining from storing the second data based on no change to one or more ranks of a set of highest ranks that includes the rank of the first beam in the order of beams.

Some examples of the method, UEs, and non-transitory computer-readable medium described herein may further include operations, features, means, or instructions for refraining from storing the second data based on a change that may be less than a rank threshold change to, or no change to, one or more highest ranks, or less than a measurement threshold change to one or more measurements of one or more respective beams.

Some examples of the method, UEs, and non-transitory computer-readable medium described herein may further include operations, features, means, or instructions for receiving configuration information, where the configuration information indicates one or more first conditions to store data for training of the AI model associated with a first set of beams, and indicates one or more second conditions to store data for training of the AI model associated with a second set of beams.

Some examples of the method, UEs, and non-transitory computer-readable medium described herein may further include operations, features, means, or instructions for receiving configuration information, where the configuration information indicates one or more conditions to store data for training of the AI model associated with a first set of beams and a second set of beams.

Some examples of the method, UEs, and non-transitory computer-readable medium described herein may further include operations, features, means, or instructions for receiving configuration information, where the configuration information indicates one or more first conditions to store the first data associated with the first indicator that corresponds to the first beam, and indicates one or more second conditions to store the second data associated with the second indicator that corresponds to the second beam.

Some examples of the method, UEs, and non-transitory computer-readable medium described herein may further include operations, features, means, or instructions for receiving configuration information from the network entity, where the configuration information indicates one or more conditions to store data for training of the AI model associated with one or more beams or one or more sets of beams, and indicates one or more indicators associated with the one or more beams or the one or more sets of beams.

A method for wireless communications by a network entity is described. The method may include transmitting configuration information that indicates a threshold distance from a first location at which a UE stores first data for training of an AI model for beam prediction and obtaining, from the UE, at least one of the first data associated with the first location or second data for training of the AI model associated with a second location, where the second data is obtained based on whether a distance between the first location and the second location satisfies the threshold distance.

A network entity for wireless communications is described. The network entity may include one or more memories storing processor executable code, and one or more processors coupled with the one or more memories. The one or more processors may individually or collectively be operable to execute the code to cause the network entity to transmit configuration information that indicates a threshold distance from a first location at which a UE stores first data for training of an AI model for beam prediction and obtain, from the UE, at least one of the first data associated with the first location or second data for training of the AI model associated with a second location, where the second data is obtained based on whether a distance between the first location and the second location satisfies the threshold distance.

Another network entity for wireless communications is described. The network entity may include means for transmitting configuration information that indicates a threshold distance from a first location at which a UE stores first data for training of an AI model for beam prediction and means for obtaining, from the UE, at least one of the first data associated with the first location or second data for training of the AI model associated with a second location, where the second data is obtained based on whether a distance between the first location and the second location satisfies the threshold distance.

A non-transitory computer-readable medium storing code for wireless communications is described. The code may include instructions executable by one or more processors to transmit configuration information that indicates a threshold distance from a first location at which a UE stores first data for training of an AI model for beam prediction and obtain, from the UE, at least one of the first data associated with the first location or second data for training of the AI model associated with a second location, where the second data is obtained based on whether a distance between the first location and the second location satisfies the threshold distance.

In some examples of the method, network entities, and non-transitory computer-readable medium described herein, the second data may be not obtained based on the distance between the first location and the second location failing to satisfy the threshold distance.

In some examples of the method, network entities, and non-transitory computer-readable medium described herein, the second data may be obtained based on one or more distances between the first location and at least one second distance that satisfies the threshold distance.

In some examples of the method, network entities, and non-transitory computer-readable medium described herein, the second data may be obtained based on a trajectory of the UE, the distance between the first location and the second location, or a quantity of occasions to receive reference signals.

Some examples of the method, network entities, and non-transitory computer-readable medium described herein may further include operations, features, means, or instructions for training the AI model based on at least one of the first data associated with the first location or the second data associated with the second location.

A method for wireless communications by a network entity is described. The method may include transmitting configuration information that indicates at least one indicator that includes a first indicator that corresponds to a first beam and obtaining, from a UE, at least one of first data for training of an AI model for beam prediction or second data for training of the AI model for beam prediction, where the first data is based on the first beam that corresponds to the first indicator, and where the second data is obtained based on a second indicator that corresponds to a second beam.

A network entity for wireless communications is described. The network entity may include one or more memories storing processor executable code, and one or more processors coupled with the one or more memories. The one or more processors may individually or collectively be operable to execute the code to cause the network entity to transmit configuration information that indicates at least one indicator that includes a first indicator that corresponds to a first beam and obtain, from a UE, at least one of first data for training of an AI model for beam prediction or second data for training of the AI model for beam prediction, where the first data is based on the first beam that corresponds to the first indicator, and where the second data is obtained based on a second indicator that corresponds to a second beam.

Another network entity for wireless communications is described. The network entity may include means for transmitting configuration information that indicates at least one indicator that includes a first indicator that corresponds to a first beam and means for obtaining, from a UE, at least one of first data for training of an AI model for beam prediction or second data for training of the AI model for beam prediction, where the first data is based on the first beam that corresponds to the first indicator, and where the second data is obtained based on a second indicator that corresponds to a second beam.

A non-transitory computer-readable medium storing code for wireless communications is described. The code may include instructions executable by one or more processors to transmit configuration information that indicates at least one indicator that includes a first indicator that corresponds to a first beam and obtain, from a UE, at least one of first data for training of an AI model for beam prediction or second data for training of the AI model for beam prediction, where the first data is based on the first beam that corresponds to the first indicator, and where the second data is obtained based on a second indicator that corresponds to a second beam.

In some examples of the method, network entities, and non-transitory computer-readable medium described herein, the configuration information further indicates at least one indicator, a periodicity for sample collection, and at least one quantity of samples for collection, the first data may be obtained based on whether the first indicator corresponds to the at least one indicator and whether a first occasion to collect the first data corresponds to the periodicity for sample collection, and a first quantity of samples of the first data may be limited to the at least one quantity of samples for collection.

In some examples of the method, network entities, and non-transitory computer-readable medium described herein, the second data may be not obtained when the second indicator does not correspond to the at least one indicator or a second occasion to collect the second data does not correspond to the periodicity.

In some examples of the method, network entities, and non-transitory computer-readable medium described herein, the second data may be obtained based on whether the second indicator corresponds to the at least one indicator and whether a second occasion to collect the second data corresponds to the periodicity for sample collection, and the second data may be limited to a different quantity of samples than the first data.

In some examples of the method, network entities, and non-transitory computer-readable medium described herein, the first indicator indicates a rank of the first beam in an order of beams based on a first measurement of the first beam.

In some examples of the method, network entities, and non-transitory computer-readable medium described herein, the second data may be obtained for a second occasion based on a change to a highest rank of the order of beams and a rank of the second indicator that corresponds to the second beam changes to the highest rank of the order of beams from the rank of the first indicator that corresponds to the first beam.

In some examples of the method, network entities, and non-transitory computer-readable medium described herein, the second data may be obtained for a second occasion based on a change to a highest rank of the order of beams and a satisfaction of a threshold quantity of samples and the highest rank of the order of beams changes from the first indicator that corresponds to the first beam to the second indicator that corresponds to the second beam for at least the threshold quantity of samples.

In some examples of the method, network entities, and non-transitory computer-readable medium described herein, the first data for a first occasion may be obtained based on a last sample of the first beam before a change to a highest rank of the order of beams.

In some examples of the method, network entities, and non-transitory computer-readable medium described herein, the first data for a first occasion may be obtained based on a last sample of the first beam before a change to a highest rank of the order of beams, and the second data for a second occasion may be obtained based on an initial sample of the second beam after the change to the highest rank of the order of beams.

In some examples of the method, network entities, and non-transitory computer-readable medium described herein, the second data may be not obtained based on no change to one or more ranks of a set of highest ranks that includes the rank of the first beam in the order of beams.

In some examples of the method, network entities, and non-transitory computer-readable medium described herein, the second data may be not obtained based on a change that may be less than a rank threshold change to, or no change to, one or more highest ranks or less than a measurement threshold change to one or more measurements of one or more respective beams.

In some examples of the method, network entities, and non-transitory computer-readable medium described herein, the configuration information indicates one or more first conditions to report data for training of the AI model associated with a first set of beams, and indicates one or more second conditions to report data for training of the AI model associated with a second set of beams.

In some examples of the method, network entities, and non-transitory computer-readable medium described herein, the configuration information indicates one or more conditions to report data for training of the AI model associated with a first set of beams and a second set of beams.

In some examples of the method, network entities, and non-transitory computer-readable medium described herein, the configuration information indicates one or more first conditions to report the first data for training of the AI model associated with the first indicator that corresponds to the first beam, and indicates one or more second conditions to report the second data for training of the AI model associated with the second indicator that corresponds to the second beam.

In some examples of the method, network entities, and non-transitory computer-readable medium described herein, the configuration information indicates one or more conditions to report data for training of the AI model associated with one or more beams or one or more sets of beams, and indicates one or more indicators associated with the one or more beams or the one or more sets of beams.

Some examples of the method, network entities, and non-transitory computer-readable medium described herein may further include operations, features, means, or instructions for training the AI model based on at least one of the first data or the second data.

A method for wireless communications by a UE is described. The method may include receiving, via first radio resource control (RRC) information, configuration information indicative of a reference signal configuration for measurement of one or more reference signals, where the configuration information is indicative of one or more events for transmission of the measurement of the one or more reference signals, and where the configuration information is received from a network entity in a non-split architecture or from a central unit (CU) in a split architecture and transmitting, via second RRC information and based on the one or more events, data indicative of the measurement of the one or more reference signals.

A UE for wireless communications is described. The UE may include one or more memories storing processor executable code, and one or more processors coupled with the one or more memories. The one or more processors may individually or collectively be operable to execute the code to cause the UE to receive, via first RRC information, configuration information indicative of a reference signal configuration for measurement of one or more reference signals, where the configuration information is indicative of one or more events for transmission of the measurement of the one or more reference signals, and where the configuration information is received from a network entity in a non-split architecture or from a CU in a split architecture and transmit, via second RRC information and based on the one or more events, data indicative of the measurement of the one or more reference signals.

Another UE for wireless communications is described. The UE may include means for receiving, via first RRC information, configuration information indicative of a reference signal configuration for measurement of one or more reference signals, where the configuration information is indicative of one or more events for transmission of the measurement of the one or more reference signals, and where the configuration information is received from a network entity in a non-split architecture or from a CU in a split architecture and means for transmitting, via second RRC information and based on the one or more events, data indicative of the measurement of the one or more reference signals.

A non-transitory computer-readable medium storing code for wireless communications is described. The code may include instructions executable by one or more processors to receive, via first RRC information, configuration information indicative of a reference signal configuration for measurement of one or more reference signals, where the configuration information is indicative of one or more events for transmission of the measurement of the one or more reference signals, and where the configuration information is received from a network entity in a non-split architecture or from a CU in a split architecture and transmit, via second RRC information and based on the one or more events, data indicative of the measurement of the one or more reference signals.

Some examples of the method, UEs, and non-transitory computer-readable medium described herein may further include operations, features, means, or instructions for receiving the one or more reference signals based on the configuration information and performing the measurement of the one or more reference signals, where the measurement may be stored based on the one or more events.

Some examples of the method, UEs, and non-transitory computer-readable medium described herein may further include operations, features, means, or instructions for storing, based on the one or more events, training data for training an AI model, the training data based on the one or more reference signals.

In some examples of the method, UEs, and non-transitory computer-readable medium described herein, the one or more events include a first event of a serving cell signal that may be greater than a first absolute threshold, a second event of a serving cell signal that may be less than a second absolute threshold, or a combination thereof.

In some examples of the method, UEs, and non-transitory computer-readable medium described herein, the configuration information may be indicative of one or more identifiers corresponding to the reference signal configuration.

In some examples of the method, UEs, and non-transitory computer-readable medium described herein, the second RRC information includes layer 3 (L3) measurements or minimization of drive test (MDT) information.

In some examples of the method, UEs, and non-transitory computer-readable medium described herein, the reference signal configuration corresponds to one or more sets of beams for measurement.

A method for wireless communications by a network entity is described. The method may include outputting, via first RRC information, configuration information indicative of a reference signal configuration for measurement of one or more reference signals, where the configuration information is indicative of one or more events for transmission of the measurement of the one or more reference signals, and where the network entity is a network entity in a non-split architecture or is a CU in a split architecture and obtaining, via second RRC information and based on the one or more events, data indicative of the measurement of the one or more reference signals.

A network entity for wireless communications is described. The network entity may include one or more memories storing processor executable code, and one or more processors coupled with the one or more memories. The one or more processors may individually or collectively be operable to execute the code to cause the network entity to output, via first RRC information, configuration information indicative of a reference signal configuration for measurement of one or more reference signals, where the configuration information is indicative of one or more events for transmission of the measurement of the one or more reference signals, and where the network entity is a network entity in a non-split architecture or is a CU in a split architecture and obtain, via second RRC information and based on the one or more events, data indicative of the measurement of the one or more reference signals.

Another network entity for wireless communications is described. The network entity may include means for outputting, via first RRC information, configuration information indicative of a reference signal configuration for measurement of one or more reference signals, where the configuration information is indicative of one or more events for transmission of the measurement of the one or more reference signals, and where the network entity is a network entity in a non-split architecture or is a CU in a split architecture and means for obtaining, via second RRC information and based on the one or more events, data indicative of the measurement of the one or more reference signals.

A non-transitory computer-readable medium storing code for wireless communications is described. The code may include instructions executable by one or more processors to output, via first RRC information, configuration information indicative of a reference signal configuration for measurement of one or more reference signals, where the configuration information is indicative of one or more events for transmission of the measurement of the one or more reference signals, and where the network entity is a network entity in a non-split architecture or is a CU in a split architecture and obtain, via second RRC information and based on the one or more events, data indicative of the measurement of the one or more reference signals.

Some examples of the method, network entities, and non-transitory computer-readable medium described herein may further include operations, features, means, or instructions for outputting the one or more reference signals based on the configuration information.

Some examples of the method, network entities, and non-transitory computer-readable medium described herein may further include operations, features, means, or instructions for obtaining, from a distributed unit (DU), an indication of the one or more events, where the configuration information may be based on the indication of the one or more events.

In some examples of the method, network entities, and non-transitory computer-readable medium described herein, the indication of the one or more events may be obtained via a midhaul communication link.

In some examples of the method, network entities, and non-transitory computer-readable medium described herein, the one or more events include a first event of a serving cell signal that may be greater than a first absolute threshold, a second event of a serving cell signal that may be less than a second absolute threshold, or a combination thereof.

In some examples of the method, network entities, and non-transitory computer-readable medium described herein, the configuration information may be indicative of one or more identifiers corresponding to the reference signal configuration.

In some examples of the method, network entities, and non-transitory computer-readable medium described herein, the second RRC information includes L3 measurements or MDT information.

In some examples of the method, network entities, and non-transitory computer-readable medium described herein, the reference signal configuration corresponds to one or more sets of beams for measurement.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports collection of data for training of artificial intelligence (AI) models for beam prediction in accordance with one or more aspects of the present disclosure.

FIG. 2 shows an example of a network architecture that supports collection of data for training of AI models for beam prediction in accordance with one or more aspects of the present disclosure.

FIG. 3 shows an example of a wireless communications system that supports collection of data for training of AI models for beam prediction in accordance with one or more aspects of the present disclosure.

FIG. 4 shows an example of a timing diagram that supports collection of data for training of AI models for beam prediction in accordance with one or more aspects of the present disclosure.

FIG. 5 shows an example of a timing diagram that supports collection of data for training of AI models for beam prediction in accordance with one or more aspects of the present disclosure.

FIG. 6 shows an example of a timing diagram that supports collection of data for training of AI models for beam prediction in accordance with one or more aspects of the present disclosure.

FIG. 7 shows an example of a timing diagram that supports collection of data for training of AI models for beam prediction in accordance with one or more aspects of the present disclosure.

FIG. 8 shows an example of a timing diagram that supports collection of data for training of AI models for beam prediction in accordance with one or more aspects of the present disclosure.

FIG. 9 shows an example of a process flow that supports collection of data for training of AI models for beam prediction in accordance with one or more aspects of the present disclosure.

FIG. 10 shows an example of a node diagram that supports collection of data for training of AI models for beam prediction in accordance with one or more aspects of the present disclosure.

FIGS. 11 and 12 show block diagrams of devices that support collection of data for training of AI models for beam prediction in accordance with one or more aspects of the present disclosure.

FIG. 13 shows a block diagram of a communications manager that supports collection of data for training of AI models for beam prediction in accordance with one or more aspects of the present disclosure.

FIG. 14 shows a diagram of a system including a device that supports collection of data for training of AI models for beam prediction in accordance with one or more aspects of the present disclosure.

FIGS. 15 and 16 show block diagrams of devices that support collection of data for training of AI models for beam prediction in accordance with one or more aspects of the present disclosure.

FIG. 17 shows a block diagram of a communications manager that supports collection of data for training of AI models for beam prediction in accordance with one or more aspects of the present disclosure.

FIG. 18 shows a diagram of a system including a device that supports collection of data for training of AI models for beam prediction in accordance with one or more aspects of the present disclosure.

FIGS. 19 through 30 show flowcharts illustrating methods that support data collection or reporting in accordance with one or more aspects of the present disclosure.

### DETAILED DESCRIPTION

Some wireless communications systems utilize event-based measurements and reporting for the purpose of user equipment (UE) mobility management. However, these events may be inadequate for training models for beam prediction, as these events are defined for mobility management when a channel change is observed at the serving cell(s). Some events may be defined for monitoring of beam management. However, these events may be utilized for UE-side models or may be defined for when a UE is equipped with models. In some other examples, events-based measurements and reporting are performed for performance monitoring of an artificial intelligence (AI) or machine learning (ML) feature, feature groups, functionalities, or models. This event-based measurement collection and reporting may be inadequate for training models for beam prediction.

Some examples of the techniques described herein may collect data (e.g., log data or measurements) for performing AI/ML model training for one or more AI/ML features, feature groups, or functionalities to enhance network performance. For performing training for an AI/ML feature, feature groups, or functionalities, for example, beam management events may be defined for measurement collection, reporting, or logging. This may enable the network to collect data that may indicate how channels are varying, leading to indications or triggers for changing serving beams, rather than data for when an actual beam failure occurs. This may help the network to collect sufficient data for model training, such that an AI/ML-enabled feature, feature groups, functionality or model may avoid or prevent such beam failures from occurring. For example, models for AI/ML-enabled beam management may be trained with sufficient data to enable efficient determination of a beam or set of beams (e.g., a best beam or set of beams). While the network may demand more data for model training, redundancies of the collected data may be avoided to improve model performance.

Some examples of the techniques described herein may provide events for the collection or reporting of training data at a UE for network side models for beam management procedures. For instance, information for configuring these events may be provided to a UE. In some examples, events may be configured via reference signal configurations, or associated identifiers may be configured in a channel state information (CSI) report configuration. In some examples, the configuration information may be communicated via one or more radio resource control (RRC) messages.

Aspects of the disclosure are initially described in the context of wireless communications systems. Aspects of the disclosure are also described in the context of a network architecture, timing diagrams, a process flow, and a node diagram. Aspects of the disclosure are further illustrated by and described with reference to apparatus diagrams, system diagrams, and flowcharts that relate to data for training of AI models for beam prediction.

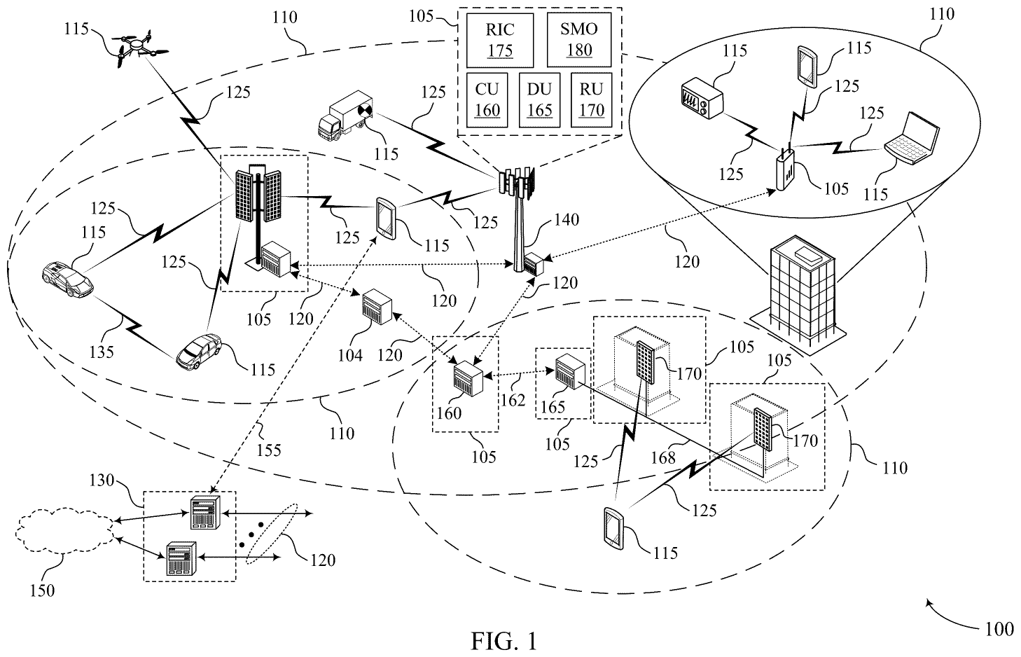

FIG. 1 shows an example of a wireless communications system 100 that supports collection of data for training of AI models for beam prediction in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, event-based measurements and reporting are performed for the purpose of UE mobility management. Some events for mobility scenarios may include one or more of the following: An event A1 may occur when a serving cell signal becomes greater than an absolute threshold. An event A2 may occur when a serving cell signal becomes less than an absolute threshold. An event A3 may occur when a neighbor cell signal reaches an amount of an offset greater than a signal of a primary cell (PCell) or primary secondary cell group (SCG) cell (PSCell). An event A4 may occur when a neighbor cell signal becomes greater than an absolute threshold. An event A5 may occur when a PCell or PSCell signal becomes less than a first absolute threshold and a signal of a neighbor or secondary cell (SCell) becomes greater than a second absolute threshold. An event A6 may occur when a signal of a neighbor cell reaches an amount of an offset greater than a signal of an SCell. An event D1 may occur when a distance between a UE and a first reference location referenceLocation1 becomes larger than a configured first threshold distanceThreshFromReference1 and a distance between a UE and a second reference location referenceLocation2 becomes shorter than a configured second threshold distanceThreshFromReference2. An event D2 may occur when a distance between a UE and a moving reference location based on movingReferenceLocation and its corresponding satellite ephemeris and epoch time broadcast in a system information block 19 (SIB19) for the serving cell becomes larger than a configured first threshold distanceThreshFromReference1 and a distance between a UE and a moving reference location determined based on referenceLocation2 becomes shorter than a configured second threshold distanceThreshFromReference2.

A conditional event A3 may occur when a conditional reconfiguration candidate reaches an amount of an offset greater than a PCell or PSCell. A conditional event A4 may occur when a conditional reconfiguration candidate becomes greater than an absolute threshold where condEventA4 can also be used for a current PSCell (e.g., in a case it is configured as candidate PSCell for CondEvent A4 evaluation) for conditional handover (CHO) with a candidate SCG(s) case. A conditional event A5 may occur when a signal of a PCell or PSCell becomes less than a first absolute threshold1 and a conditional reconfiguration candidate signal becomes greater than a second absolute threshold2. A conditional event D1 may occur when a distance between a UE and a first reference location referenceLocation1 becomes larger than a configured first threshold distanceThreshFromReference1 and a distance between a UE and a second reference location referenceLocation2 of a conditional reconfiguration candidate becomes shorter than a configured second threshold distanceThreshFromReference2. A conditional event D2 may occur when a distance between a UE and a moving reference location determined based on movingReferenceLocation and its corresponding satellite ephemeris and epoch time broadcast in SIB19 for the serving cell becomes larger than a configured first threshold distanceThreshFromReference1 and a distance between a UE and a moving reference location determined based on referenceLocation2 of a conditional reconfiguration candidate becomes shorter than configured second threshold distanceThreshFromReference2. A conditional event T1 may occur when a time measured at a UE becomes more than a configured threshold t1-Threshold but is less than t1-Threshold+duration.

An event X1 may occur when a signal of a serving layer 2 (L2) UE-to-network (U2N) relay UE becomes less than an absolute threshold1 and a signal of a New Radio (NR) cell becomes greater than another absolute threshold2. An event X2 may occur when a signal of a serving L2 U2N relay UE becomes less than an absolute threshold. For an event I1, a measurement reporting event may be based on cross link interference (CLI) measurement results, which can be derived based on a sounding reference signal (SRS) reference signal received power (RSRP) or a CLI reference signal strength indicator (RSSI). An event I1 may occur when interference becomes higher than an absolute threshold.

Reporting events concerning an aerial UE altitude may be labelled HN with N equal to 1 or 2. Additionally, reporting events concerning an aerial UE altitude and neighboring cell measurements simultaneously may be labelled AMHN with M equal to 3, 4, or 5 and N equal to 1 or 2. An event H1 may occur when an aerial UE altitude becomes higher than a threshold. An event H2 may occur when an aerial UE altitude becomes lower than a threshold. An event A3H1 may occur when a signal of a neighbor cell reaches an offset greater than a signal of a special cell (SpCell) and the aerial UE altitude becomes higher than a threshold. An event A3H2 may occur when a signal of a neighbor cell reaches an offset greater than a signal of a SpCell and the aerial UE altitude becomes lower than a threshold. An event A4H1 may occur when a signal of a neighbor cell becomes greater than a threshold1 and the aerial UE altitude becomes higher than a threshold2. An event A4H2 may occur when a signal of a neighbor cell becomes greater than a threshold1 and the aerial UE altitude becomes lower than a threshold2. An event A5H1 may occur when a signal of an SpCell becomes less than a threshold1, a signal of a neighbor cell becomes greater than a threshold2, and the aerial UE altitude becomes higher than a threshold3. An event A5H2 may occur when an SpCell becomes less than a threshold1, a signal of a neighbor cell becomes greater than a threshold2, and the aerial UE altitude becomes lower than a threshold3. In some examples, one or more of the foregoing mobility-related events may be inadequate for training models for beam prediction, as these events are defined for mobility management when a channel change is observed at the serving cell(s). In some another examples, events-based measurements and reporting are performed for performance monitoring of AI/ML feature, feature groups, functionalities, or models. This event-based measurement collection and reporting may be inadequate for training models for beam prediction.

Some events may be defined for monitoring of beam management. Some examples of events for a UE-initiated or event-driven performance monitoring report are provided as follows. An event-1 or an event-2 may be based on beam prediction accuracy. For instance, an event-1 may occur when a top measured beam (e.g., a beam with a strongest or highest measurement) is not among a quantity K (e.g., top K) of predicted beams from a performance monitoring set, where K may be configured by a gNB. An event-2 may occur when a top predicted beam is not among a quantity K (e.g., top K) measured beams from a performance monitoring set. An event-3 or an event-4 may be based on a difference of measured L1-RSRPs. An event-3 may occur when a measured L1-RSRP of a top predicted beam is not within an amount of (e.g., X₃) decibels (dB) of a top measured L1-RSRP from a performance monitoring set. An event-4 may occur when a highest measured L1-RSRP among a quantity (e.g., top K) predicted beams is not within an amount (e.g., X₄) dB of a top measured L1-RSRP from a performance monitoring set. An event-5 or an event-6 may be based on a difference of measured and predicted L1-RSRPs. An event-5 may occur when a predicted L1-RSRP of a top predicted beam is not within an amount (e.g., X₅) dB of a top measured L1-RSRP from a performance monitoring set. An event-6 may occur when a highest predicted L1-RSRP among a quantity (e.g., top K) predicted beams is not within an amount (e.g., X₆) dB of a top measured L1-RSRP from a performance monitoring set. For events 3, 4, 5, and 6, X₃, X₄, X₅, and X₆ may be configured by a gNB, and may be a function of a top measured L1-RSRP from a performance monitoring set. The criterion for reporting may be an occurrence of each of the foregoing events in a standalone manner, or an occurrence of at least two of the foregoing events. One or more of the foregoing events for beam management may be utilized for UE-side models or may be defined for when a UE is equipped with models. For instance, one or more of the events for beam management may be utilized for a model on the UE side, but may be less useful for model training or execution on a network side.

For performing training for an AI/ML feature, feature groups, or functionalities, one or more beam management events may be defined for measurement collection, reporting, or logging. This may enable the network to collect data that may indicate how channels are varying, leading to indications or triggers for changing serving beams, rather than data for when an actual beam failure occurs. This may help the network to collect sufficient data for model training, such that an AI/ML-enabled feature, feature groups, functionality or model may avoid or prevent such beam failures from occurring. For example, models for AI/ML-enabled beam management may be trained with sufficient data to enable efficient determination of a beam or set of beams (e.g., a best beam or set of beams). While the network may demand more data for model training, redundancies of the collected data may be avoided to improve model performance. Some examples of the techniques described herein may relate to event triggered data collection or reporting of data for network-sided model training. For instance, one or more events may be utilized for network-focused (e.g., for RRC signaling between a UE 115 and a network entity 105) reporting or one or more instances of logged L1 measurement results from a UE 115 to a network entity 105 via an RRC message or Uplink Control Information (UCI), where the logging or reporting may be configured by a network entity 105. In some examples, network-focused data collection may be performed for the training of a network-sided model (e.g., one or more AI/ML models trained or utilized on the network side). In some examples, periodic or event-based data collection or reporting may be supported.

In some examples, events may be provided for the collection or reporting of training data at a UE for network side models for beam management procedures (e.g., event-triggered measurement collection for network-side model training for beam management). For instance, information for configuring these events may be provided to a UE. In some examples, events may be configured via reference signal configurations, or associated identifiers may be configured in a channel state information (CSI) report configuration. In some examples, the configuration information may be communicated via one or more RRC messages or UCI.

Some examples of the techniques described herein may relate to AI/ML based spatial and temporal beam prediction (e.g., downlink beam prediction) based on L1 beam measurements. For example, in one or more of the aspects described herein, beam prediction may refer to a prediction of a beam (e.g., best beam, a beam with greatest signal strength, throughput, or quality, among other examples) from a set of beams for uplink or downlink communication. In a first case (e.g., Case #1), spatial downlink beam prediction may be performed for Set-A beams based on measurement results of Set-B beams. In some approaches, Set-B beams may be relatively wide beams (e.g., SSB beams), and set-A beams may be relatively narrow beams (e.g., CSI-RS beams). In some approaches, Set-B beams may be relatively narrow beams, and Set-A beams may be other relatively narrow beams. In a second case (e.g., case #2), temporal downlink beam prediction may be performed for Set-A beams based on historic measurement results of Set-B beams. In some approaches, Set-A and Set-B beams may be similar (e.g., for temporal beam prediction). In some approaches, Set-A and Set-B beams may be different (e.g., for spatial and temporal beam prediction). In some examples, an identifier (e.g., an associated ID) may be utilized for achieving reliability between training and inference. Some examples of the techniques described herein may be utilized on the network-side or UE-side, for single-cell or multi-cell scenarios.

In some aspects, the UE 115 may log data for network-side model training. Logging redundant data, however, may increase resource (e.g., memory, energy, or communication resource) consumption. Some examples of the techniques described herein may help to avoid logging redundant data for network-side model training at the UE 115. One or more events may be utilized for collection of data or reporting collected data. In some approaches, for AI/ML-based mobility, topological layout information (on the cell or beam level) may be utilized to achieve enhanced performance.

As used herein, the terms “AI,” “AI/ML,” “AI-based,” or “ML-based” may refer to AI or ML techniques. The term “AI model” may refer to one or more AI models (with or without ML) or to one or more ML models. As used herein, an AI model may be referred to as an “AI-based model,” an “ML model,” or an “ML-based model.”

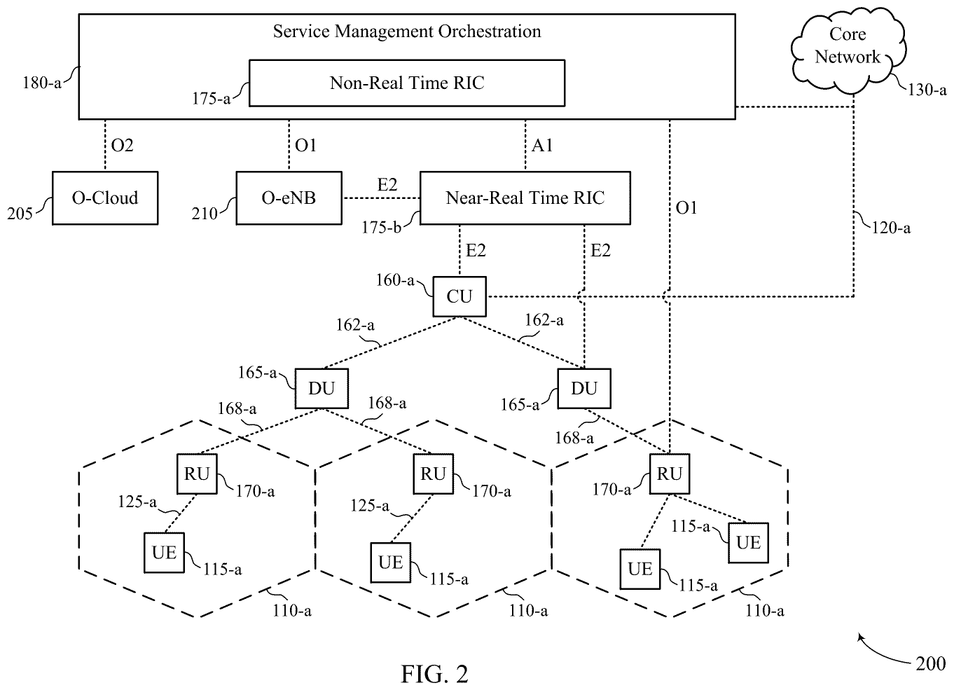

FIG. 2 shows an example of a network architecture 200 (e.g., a disaggregated base station architecture, a disaggregated RAN architecture) that supports collection of data for training of AI models for beam prediction in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

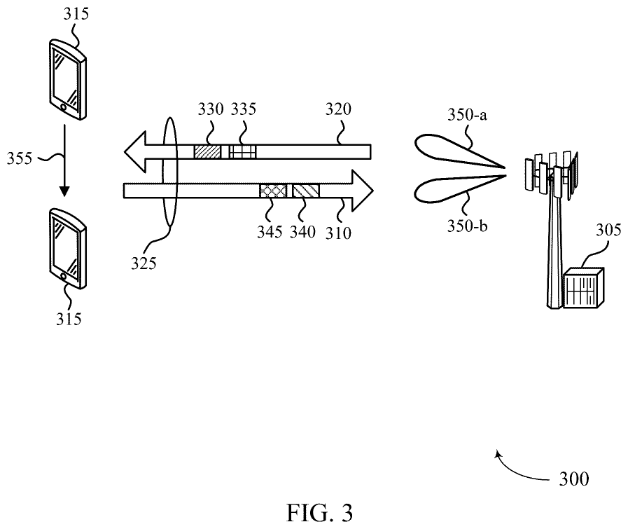

FIG. 3 shows an example of a wireless communications system 300 that supports collection of data for training of AI models for beam prediction in accordance with one or more aspects of the present disclosure. The wireless communications system 300 may implement aspects of or may be implemented by aspects of the wireless communications system 100. For example, the wireless communications system 300 includes a UE 315, which may be an example of a UE 115 described with reference to FIG. 1 or a UE 115-a described with reference to FIG. 2. The wireless communications system 300 also includes a network entity 305, which may be an example of a network entity 105 described with reference to FIG. 1 or an RU 170-a, DU 165-a, or CU 160-a described with reference to FIG. 2.

The UE 315 may communicate with the network entity 305 using a link 325, which may be an example of a communication link 125 described with reference to FIG. 1 a communication link 125-a described with reference to FIG. 2, or another link. The link 325 may include a bi-directional link that enables uplink or downlink network communications. For example, the UE 315 may transmit one or more uplink transmissions 310, such as uplink control signals or uplink data signals, to the network entity 305 using the link 325, or the network entity 305 may transmit one or more downlink transmissions 320, such as downlink control signals or downlink data signals, to the UE 315 using the link 325.

While one communication link 325 and one network entity 305 are illustrated in FIG. 3, the UE 315 may communicate with one or more network entities 305 via one or more communication links 325 over time. For instance, the UE 315 may perform one or more handover or cell reselection procedures between network entities 305 or cells. One or more of the operations or communications described with reference to FIG. 3 may be performed via one or more communication links 325 or with one or more network entities 305. For instance, a first reference signal 330 and a second reference signal 335 may both be received from one network entity 305, or the first reference signal 330 may be received from a first network entity 305 and the second reference signal may be received from a second network entity 305. Additionally, or alternatively, first data 340 or second data 345 may be communicated to a same or different network entity(ies) 305 as a network entity(ies) 305 from which the first reference signal 330 or the second reference signal 335 are received.

In some examples, the UE 315 may undergo a transition 355. In some examples, the transition 355 may denote a change in position, a change in time (e.g., occasion), or a combination thereof. For instance, the UE 315 may remain relatively stationary or motionless over time (e.g., over two or more occasions), or the UE 315 may move (e.g., change position) over time.

One or more events may be defined for training data collection for one or more network-side AI models. To avoid redundancy in the collection of data, events may be defined based on the location of the UE 315 or based on one or more measurements performed by the UE 315. In some examples, one or more events may be defined such that UE 315 may avoid collecting redundant data (e.g., a relatively large quantity of consecutive samples) at a same location or similar locations (e.g., locations relatively near to each other). Data collection may include collecting of samples of one or more signals (e.g., reference signals). In one or more of the aspects described herein, the term “sample” (which may also be referred to as “sampling” or other variations thereof) may refer to the act of determining information (e.g., a measurement or rank, among other examples) associated with a signal at a given time. It should be understood that the term “sample” may additionally or alternatively refer to the information (e.g., a measurement or rank, among other examples) itself. Examples of data collection (e.g., events) based on UE 315 location are given as follows.

In some examples, the UE 315 may receive, at a first location, a first reference signal 330 that corresponds to a first beam 350-a. For instance, a reference signal that corresponds to a beam may be a reference signal that is received via the beam (e.g., the first reference signal 330 may correspond to the first beam 350-a by being received via the first beam 350-a). A location may be a geographical position or a position in space. In some examples, a location may correspond to a coverage area or cell. The UE 315 may determine a location (the first location of the UE 315 or a second location of the UE 315, for instance) utilizing one or more positioning procedures. Examples of positioning procedures may include one or more operations of assisted global navigation satellite system (A-GNSS), observed time difference of arrival (OTDOA), enhanced cell identifier (E-CID), sensor-based positioning, wireless local area network (WLAN)-based positioning, Bluetooth-based positioning, terrestrial beacon systems (TBS) positioning, downlink time difference of arrival (DL-TDOA), downlink angle of departure (DL-AoD), multi-round-trip time (Multi-RTT), New Radio enhanced cell identifier (NR E-CID), uplink time difference of arrival (UL-TDOA), uplink angle of arrival (UL-AoA), or AI-based positioning procedures, among other examples. Some examples of the positioning procedures may be managed by, assisted by, or performed by the UE 315 or another device (e.g., location management function (LMF) of the network).

A reference signal (e.g., the first reference signal 330 or the second reference signal 335) may be a signal (e.g., electromagnetic signal, RF signal) for sampling or measurement. In some examples, a reference signal may have one or more established characteristics (e.g., signaling pattern, scheduling, strength, amplitude, magnitude, frequency, timing, modulation, phase, or data, among other examples). For instance, the UE 315 or the network entity 305 may store information indicating one or more of the characteristics of a reference signal, which may allow for comparison of one or more stored characteristics and one or more characteristics of the received reference signal. In some approaches, a reference signal (e.g., the comparison) may enable channel estimation (e.g., channel attenuation, phase, frequency shift, or Doppler effects, among other examples), positioning, or tracking. Examples of a reference signal may include a reference signal of a synchronization signal block (SSB), a channel state information reference signal (CSI-RS), a sounding reference signal (SRS), a demodulation reference signal (DMRS), a positioning reference signal (PRS), or a tracking reference signal (TRS), among other examples.

A beam may be an electromagnetic field that is spatially directed in a direction or range of directions. For instance, the network entity 305 may perform beamforming or spatial filtering to concentrate RF energy in a direction or range of directions. In some examples, the network entity 305 may form one or more beams in one or more directions or ranges. Directing a beam towards a receiving device (e.g., the UE 315) may enhance the strength or quality of the signal received at the receiving device.

In some examples, the UE 315 may generate data (e.g., one or more samples, measurements, or other information) based on a reference signal (e.g., the first reference signal 330 or the second reference signal 335). For instance, the UE 315 may measure a signal strength of a reference signal at one or more times to generate the measurements. Examples of the measurements may include signal strength data, reference signal received power (RSRP) data, received signal strength indicator (RSSI) data, reference signal received quality (RSRQ) data, signal-to-interference plus noise ratio (SINR) data, SNR data, channel impulse response (CIR) data, channel quality indicator (CQI) data, or channel state information (CSI) data, among other examples.

One or more samples, measurements, or information based on a reference signal may be stored as data. For example, the UE 315 may store or log the first data 340 in memory based on the first reference signal 330. In some approaches, the UE 315 may store the first data 340 to train an AI model for beam prediction, where the first data 340 is based on the first reference signal 330. For instance, the first data 340 may be utilized (e.g., by the network entity 305, the UE 315, or another device as ground truth data) to train an AI model for beam prediction. In some aspects, the first data 340 may associate samples, measurements, or information with the first beam 350-a. Accordingly, the first data 340 may provide an indication of signal quality (e.g., a signal strength measurement of a reference signal) or communication performance when communicating via the first beam 350-a.

In some examples, the UE 315 may receive, at a second location, a second reference signal 335 that corresponds to a second beam 350-b. For instance, the transition 355 may be an amount of movement from the first location to the second location. In some cases, the second location may be different from the first location or may be the same as the first location.

The UE 315 may measure or log second data 345 (e.g., new training samples) once the UE 315 has moved a threshold distance (e.g., a configured threshold distance) since the first data 340 (e.g., last data) was logged. In some approaches, the UE 315 may perform a determination to store second data 345 to train the AI model for beam prediction based on a distance between the first location and the second location. For example, the UE 315 may determine a distance between the first location and the second location (e.g., by finding a distance between coordinates of the first location and the second location). In some approaches, the UE 315 may store the second data 345 to train the AI model for beam prediction if the distance between the first location and the second location satisfies a threshold distance. For instance, in a case that the distance between the first location and the second location satisfies the threshold distance, the UE 315 may sample, measure, or store the second data 345 based on the second reference signal 335. In some aspects, the second data 345 may associate samples, measurements, or information with the second beam 350-b. Accordingly, the second data 345 may provide an indication of signal quality or communication performance when communicating via the second beam 350-b. Some examples of the techniques described herein may provide UE location-based events for training data collection or logging.

In some approaches, if the UE 315 has not moved the threshold distance (e.g., a configured threshold distance) since the first data 340 (e.g., last data) was logged, the UE 315 may not measure or log second data 345 (e.g., new training samples). For example, the UE 315 may refrain from storing the second data 345 (or the network entity 305 may not obtain the second data 345) to train the AI model for beam prediction if the distance between the first location and the second location fails to satisfy the threshold distance. For instance, if the threshold distance is not satisfied, the UE 315 may not sample, measure, store, or transmit the second data 345 based on the second reference signal 335. The UE 315 moving (or not moving) a threshold distance may be an example of an event for data collection, logging, or reporting (e.g., to sample, measure, store, or report training data).

In some aspects, the network entity 305 may output, or the UE 315 may receive, configuration information that indicates the threshold distance (e.g., a threshold distance from the first location at which the UE 315 stores first data 340 to train the AI model). For instance, the network entity 305 may configure the UE 315 with a threshold distance by communicating configuration information to the UE 315 indicating the threshold distance.

In some examples, an event may be defined based on a threshold distance and a quantity of (e.g., K) occasions (e.g., most recent measurement occasions). For instance, if the UE 315 has not moved the threshold distance (e.g., a configured threshold distance) since any of the last K occasions, the UE 315 may not sample, measure, or store (e.g., log) the second data 345 (e.g., new training samples or data). An occasion (e.g., measurement occasion) may be a time or instance in which a sample(s), measurement(s), or data may be generated (e.g., an instance in which a reference signal may be communicated for measurement). In some aspects, the quantity (e.g., K) may be configured by the network entity 305. For instance, the network entity 305 may configure the UE 315 with the quantity (e.g., K) by communicating configuration information to the UE 315 indicating the quantity.

In some approaches, the first reference signal 330 may be received at a first occasion of a set of occasions (e.g., K occasions) and the second reference signal 335 may be received at a second occasion of the set of occasions. The UE 315 may store the second data 345 to train the AI model for beam prediction based on whether the distance between the first location and the second location satisfies the threshold distance. For example, the UE 315 may collect or log an Mth measurement (e.g., the first data 340) at a location L_{M}. The UE 315 may measure or collect new samples if the UE 315 is a threshold distance (e.g., a configured threshold distance) farther from one or more (e.g., any or all K) previous locations {L_{M-K+1}, . . . , L_{M}}. In some examples, an occurrence of this event may indicate that the previously described event using the threshold distance is also applicable. In some approaches, a window of the set of occasions (e.g., K measurement occasions) may be a moving window. For instance, an oldest measurement occasion may be removed from the set of occasions when a new occasion occurs.

In some examples, an event may be defined based on a UE 315 trajectory (e.g., predicted trajectory), distance (e.g., predicted distance), a quantity of occasions (e.g., K) or a quantity of samples. For instance, the determination to store the second data 345 may be based on a trajectory of the UE 315, the distance between the first location and the second location, or a quantity of occasions to receive reference signals. In some aspects, the trajectory or distance may be measured or predicted by the UE 315 (e.g., computed by the UE 315) or may be measured or predicted by the network entity 305 (e.g., computed by the network entity 305). For instance, if a predicted distance satisfies a threshold distance (or a threshold distance for a quantity of occasions, for example), the second data 345 may be sampled, measured, or reported. Additionally, or alternatively, if a predicted trajectory satisfies a condition (e.g., is within an angular range of an angle where a change in beam may occur), the second data 345 may be sampled, measured, or reported. The network entity 305 may obtain the second data 345 based on the trajectory of the UE 315, the distance between the first location and the second location, or a quantity of occasions to receive reference signals.

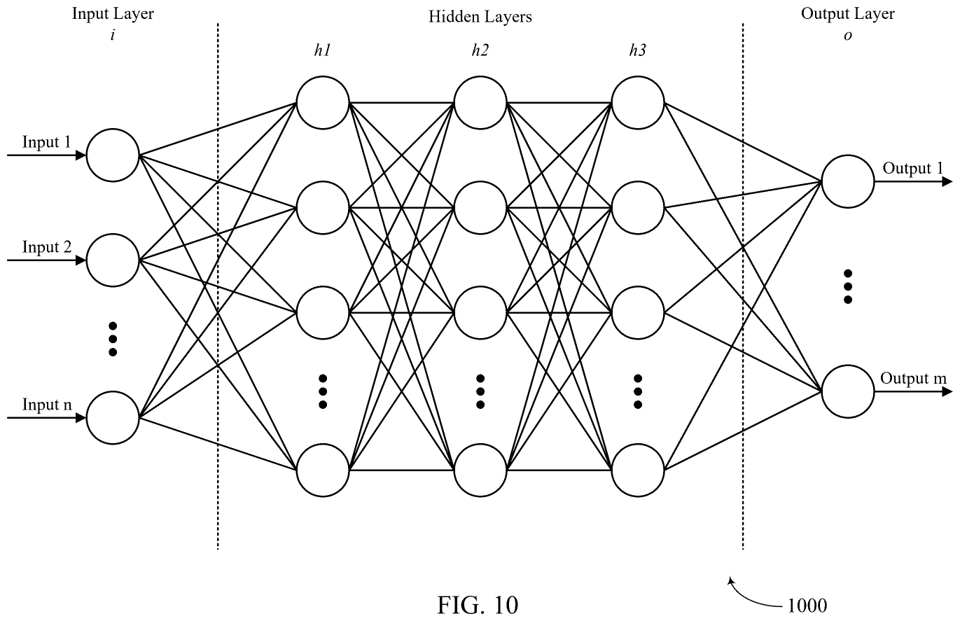

The UE 315 may transmit, to the network entity 305, at least one of the first data 340 or the second data 345 to train the AI model. For instance, the UE 315 may transmit the first data 340 or the second data 345, which the network entity 305 or another device may utilize to the train the AI model for beam prediction. In some aspects, the UE 315 may transmit, or the network entity 305 may obtain (e.g., receive) the first data 340 associated with the first location or the second data 345 associated with a second location, where the second data 345 to train the AI model is obtained based on whether a distance between the first location and the second location satisfies the threshold distance. The network entity 305 or another device (e.g., another network entity or a server, among other examples) may train the AI model based on the first data 340 or the second data 345. For instance, the network entity 305 or another device may utilize the first data 340 or the second data 345 as ground truth data for training of the AI model to predict beam measurements or beam usage. An example of a structure of an AI model that may be utilized for beam prediction is given with reference to FIG. 10.

In some examples, one or more events may be defined such that the UE 315 may avoid logging current measurements if the current measurements are not significantly different from previously collected measurements. For instance, one or more events may be defined based on one or more indicators that correspond to one or more beams. Examples of indicators that correspond to a beam may include a beam identifier, a beam index, or other information associated with a beam (e.g., SSB information).

In some approaches, the UE 315 may receive, at a first occasion, a first reference signal 330 that corresponds to a first beam 350-a. The UE 315 may store first data 340 to train an AI model for beam prediction based on a first indicator that corresponds to the first beam 350-a. The first indicator may be information associated with the first beam 350-a. Examples of the first indicator may include a first beam identifier, beam index, SSB information, or CSI-RS information, among other examples. The first data 340 may be based on the first reference signal 330 as similarly described herein. The UE 315 may receive, at a second occasion, a second reference signal 335 that corresponds to a second beam 350-b. A determination to store second data 345 to train the AI model for beam prediction may be based on a second indicator that corresponds to the second beam 350-b. The second indicator may be information associated with the second beam 350-b. Examples of the second indicator may include a second beam identifier, beam index, SSB information, or CSI-RS information, among other examples. The UE 315 may transmit, to the network entity 305, at least one of the first data 340 or the second data 345 to train the AI model. For instance, the network entity 305 may obtain, from the UE 315, at least one of first data 340 to train the AI model for beam prediction or second data 345 to train the AI model for beam prediction, where the first data 340 is based on the first beam 350-a that corresponds to the first indicator, and where the second data 345 to train the AI model is obtained based on a second indicator that corresponds to a second beam 350-b.

In some examples, the network entity 305 may output, or the UE 315 may receive, configuration information that indicates at least one indicator, a periodicity for sample collection, or at least one quantity of samples for collection. For instance, the configuration information may indicate one or more indicators (e.g., beam identifiers, beam indices, SSBs, or CSI-RS indicators, among other examples) corresponding to one or more beams for which data is to be collected. The periodicity for sample collection may indicate a quantity of time, quantity of slots, an offset, scheduled resources, or another indication of a temporal period for periodic (e.g., cyclic or repeating occasions for) collection of samples. The at least one quantity of samples for collection may indicate a quantity of samples to collect per beam or per period. For instance, a quantity of samples for collection may indicate that the UE 315 is to collect up to a maximum quantity of five samples per period. The UE 315 may stop collecting samples when a maximum quantity of samples is reached for one or more configured beams (e.g., serving beams or highest ranked beams).

A quantity of samples for collection may be associated with the indicator. In some aspects, different quantities of samples for collection may be associated with different indicators for different beams. For example, the configuration information may indicate that the UE 315 is to collect up to five samples per period for a beam with an index of 1, and may indicate that the UE 315 is to collect up to two samples per period for a beam with an index of 2.

In some approaches, the configuration information may indicate or define an event, where the UE 315 may be provided with a distribution of measurements to be logged for one or more beams (e.g., serving beam(s) or highest ranked beam(s) corresponding to an SSB(s) or CSI-RS(s)). The UE 315 may be configured with a quantity of samples to be collected when a beam is beam (e.g., serving beam(s) or highest ranked beam(s) corresponding to an SSB(s) or CSI-RS(s)), with a periodicity of measurement logging for the beam. In some examples, the configuration information (e.g., the network) may define different periodicities for measurement or logging when beams (e.g., serving beams or highest ranked beams) are different.

In an example, the UE 315 may store a first quantity of samples of the first reference signal 330 of the first beam 350-a based on whether the first indicator corresponds to the at least one indicator and whether the first occasion corresponds to the periodicity for sample collection. The first quantity of samples may be limited to the at least one quantity of samples for collection. For instance, in a case that the beam index for the first beam 350-a matches the at least one indicator from the configuration information and that the first reference signal 330 is received in a period of the indicated periodicity for sample collection, the UE 315 may collect samples of the first reference signal 330 up to the configured quantity of samples for the first beam 350-a. In some examples, the first beam 350-a may be a serving beam or a highest ranked beam (e.g., top beam, beam with a greatest signal measurement, beam with greatest throughput, or beam with a highest quality, among other examples). In some approaches, storing, logging, reporting, or obtaining (e.g., receiving) samples (e.g., the first quantity of samples of the first reference signal 330 of the first beam 350-a) may be conditioned on whether the first beam 350-a is a serving beam, highest ranked beam, or other beam (e.g., a non-serving beam or beam that is ranked lower than the highest ranked beam, among other examples). For instance, one or more samples may be stored, logged, reported, or obtained if the first beam 350-a is a serving beam or highest ranked beam.

The UE 315 may transmit, or the network entity 305 may obtain (e.g., receive) the first data 340 based on whether the first indicator corresponds to the at least one indicator or whether a first occasion to collect the first data 340 corresponds to the periodicity for sample collection, and where a first quantity of samples of the first data 340 may be limited to the at least one quantity of samples for collection.

The UE 315 may store or report, or the network entity 305 may obtain, the second data 345 (e.g., a second quantity of samples of the second reference signal 335 of the second beam 350-b) based on whether the second indicator corresponds to the (e.g., matches) at least one indicator and whether the second occasion corresponds to the periodicity for sample collection. The second quantity of samples may be a different quantity than the first quantity of samples. In some examples, the second beam 350-b may be a serving beam or a highest ranked beam (e.g., top beam, beam with a greatest signal measurement, beam with greatest throughput, or beam with a highest quality, among other examples). In some approaches, storing, logging, reporting, or obtaining (e.g., receiving) samples (e.g., the second quantity of samples of the first reference signal 335 of the second beam 350-b) may be conditioned on whether the second beam 350-b is a serving beam, highest ranked beam, or other beam (e.g., a non-serving beam or beam that is ranked lower than the highest ranked beam, among other examples). For instance, one or more samples may be stored, logged, reported, or obtained if the second beam 350-b is a serving beam or highest ranked beam.

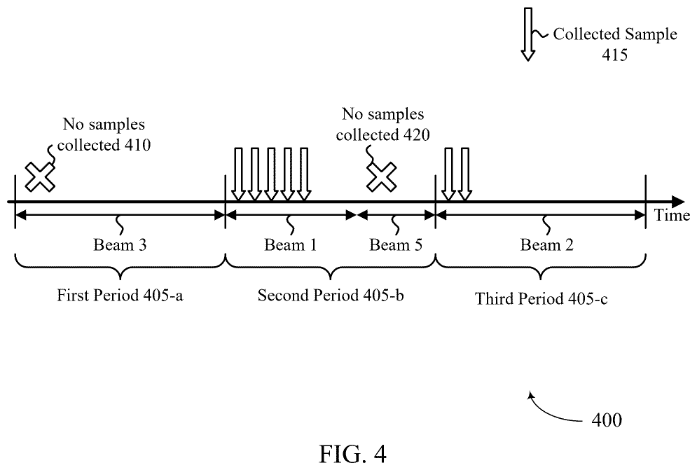

The UE 315 may refrain from storing or reporting the second data 345 in a case that the second indicator does not correspond to the at least one indicator or the second occasion does not correspond to the periodicity. For instance, the network entity 305 may not obtain the second data 345 in a case that the second indicator does not correspond to the at least one indicator or a second occasion to collect the second data 345 does not correspond to the periodicity. An example of storing samples in accordance with configured indicators, periodicity, and quantities of samples is given with reference to FIG. 4.

In some examples, the indicators may indicate ranks of beams based on beam measurements (e.g., signal strength or another measurement for each beam). In some approaches, the rank may be determined based on an order of signal strength measurements corresponding to the beams. For example, a beam associated with a greatest signal strength measurement of a set of beams may have a highest rank in the set of beams, with other beams having ranks in a descending order of signal strength measurements. In other examples, one or more other metrics may be utilized to rank the beams. For instance, a beam with a lowest noise measurement may have a highest rank or a beam with a highest channel quality may have a highest rank, among other examples. In some aspects, the first indicator may indicate a rank of the first beam 350-a in an order of beams based on a first measurement of the first beam 350-a, and the second indicator may indicate a rank of the second beam 350-b in the order of beams based on a second measurement of the second beam 350-b.

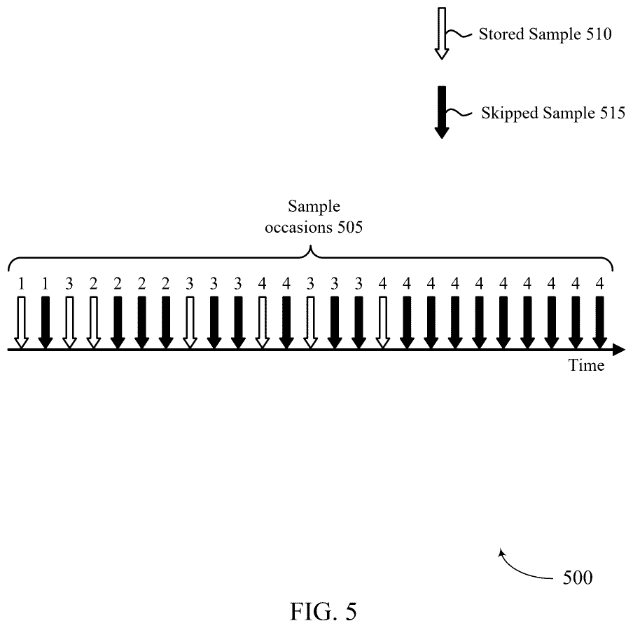

In some approaches, an event for storing (e.g., logging) or reporting data may be based on a change in rank in the order of beams. For example, the UE 315 may store or report (or the network entity 305 may obtain) the second data 345 for the second occasion based on a change to a highest rank of the order of beams. For instance, the rank of the second indicator that corresponds to the second beam 350-b may change to the highest rank of the order of beams from the rank of the first indicator that corresponds to the first beam 350-a. If the highest rank (e.g., a top single beam index) has not changed, then the UE 315 may not store (e.g., log) or report (or the network entity 305 may not obtain) the second data 345 (e.g., new training samples or data). An example of data storage or reporting based on the change in highest rank is given with reference to FIG. 5.

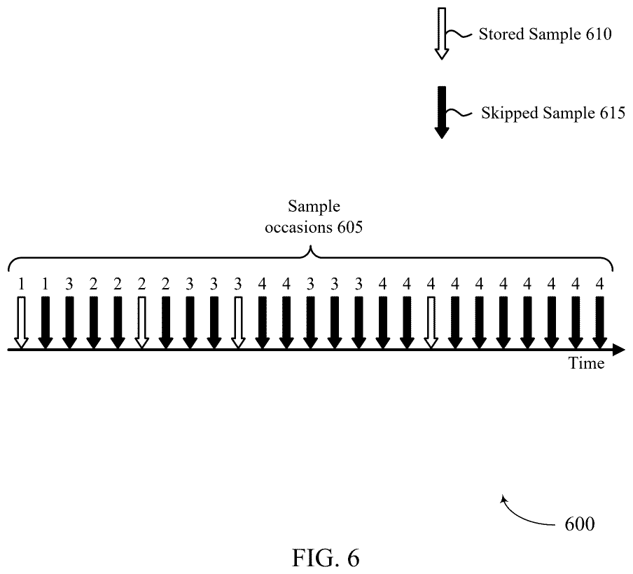

In some examples, the UE 315 may store (e.g., log) or report data (e.g., new measurements) when another beam becomes the highest ranked (e.g., highest single ranked) beam for a threshold quantity of samples (e.g., K samples) since data was last stored or reported (e.g., since the most recent logged or reported measurement). The UE 315 may store or report, or the network entity 305 may obtain (e.g., receive), the second data 345 for the second occasion based on a change to a highest rank of the order of beams and a satisfaction of a threshold quantity of samples. For example, the highest rank of the order of beams may change from the first indicator that corresponds to the first beam 350-a to the second indicator that corresponds to the second beam 350-b for at least the threshold quantity of samples. An example of data storage or reporting based on the change in rank for the threshold quantity of samples is given with reference to FIG. 6.

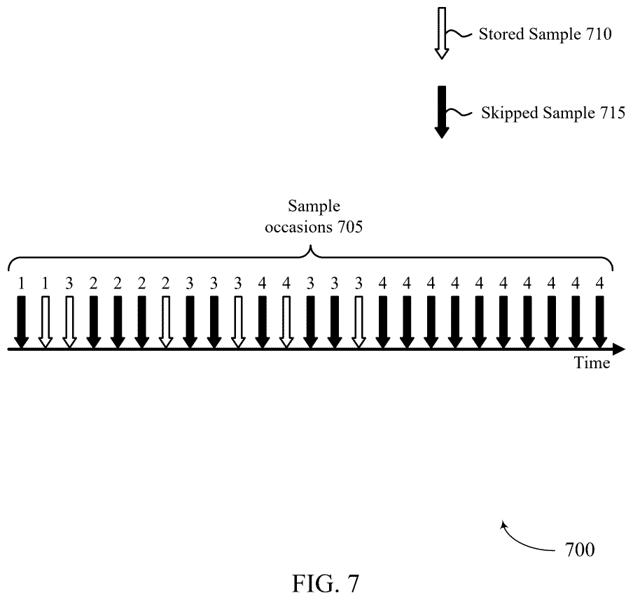

In some aspects, the UE 315 may store (e.g., log) or report a first, last, or latest measurement sample in a moving window based on a change to the highest rank in the order of beams (e.g., if another beam reaches the highest rank). The UE 315 may store or report, or the network entity 305 may obtain, the first data 340 for the first occasion based on a last sample of the first beam 350-a before a change to a highest rank of the order of beams. For instance, the UE 315 may store or report a last measurement sample corresponding to a beam before a change to the highest rank in the order of beams. In some examples, a threshold quantity of samples may also be utilized. For instance, the UE 315 may store or report, or the network entity 305 may obtain, a first, last, or latest measurement of the first beam 350-a before a change in the highest rank if a threshold quantity of samples (e.g., K consecutive samples) of the first beam 350-a is satisfied before a change to the highest rank. An example of data storage or reporting of a last sample based on the change in rank is given with reference to FIG. 7.

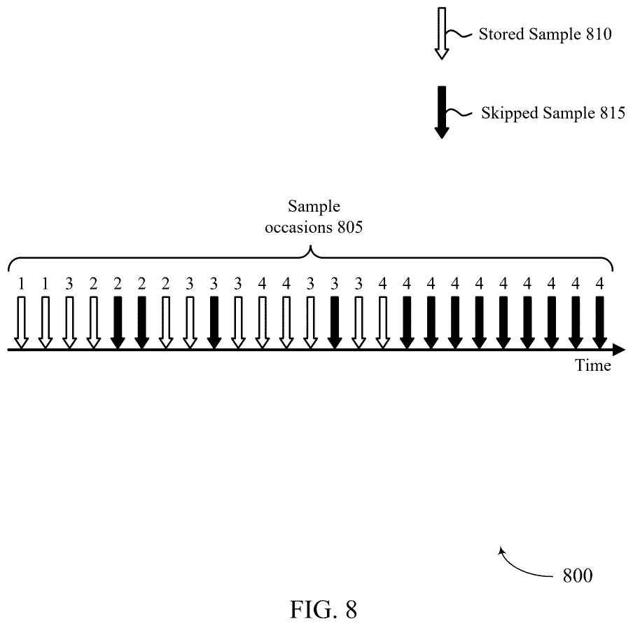

In some approaches, each time a highest ranked beam (e.g., highest single ranked beam) changes, the UE 315 may report the measurement sample corresponding to the change and a last measurement sample before the change (e.g., avoiding duplications). The UE 315 may store or report, or the network entity 305 may obtain, the first data 340 for the first occasion based on a last sample of the first beam 350-a before a change to a highest rank of the order of beams. The UE 315 may store or report, or the network entity 305 may obtain, the second data 345 for the second occasion based on an initial sample of the second beam 350-b after the change to the highest rank of the order of beams. An example of data storage or reporting of a last sample and an initial sample based on the change in rank is given with reference to FIG. 8.

In some examples, the UE 315 may store or report, or the network entity 305 may obtain, data based on whether a set of highest ranks has changed. For example, the UE 315 may store or report, or the network entity 305 may obtain, the second data 345 based on a change to one or more of a set of highest ranks that includes the rank of the first beam 350-a in the order of beams. In some aspects, the UE 315 may not store or report, or the network entity 305 may not obtain, the second data 345 based on no change to a set of highest ranks that includes the rank of the first beam 350-a in the order of beams. For instance, an event may be defined for the highest K beams (e.g., beam indices. If the top K beams or beam indices have not changed, then the UE 315 may not store (e.g., log), or the network entity 305 may not obtain, new data (e.g., new training sample data). In some approaches, to further avoid redundancy, a time or sample window or threshold may be defined (e.g., where data is stored or reported if a change to the top K beams persists for a sample window or threshold quantity of samples). Variations of utilizing the change to the set of highest ranks may be implemented in conjunction with one or more of the concepts described with reference to one or more of FIGS. 5-8.

In some aspects, for one or more of the events described herein, the network entity 305 may output (e.g., transmit) configuration information to the UE 315, where the configuration information indicates a quantity of samples (or a threshold quantity of samples) for the UE 315 to store, log, or report when a highest ranked beam changes or when one or more (e.g., any) of a set of highest ranked beam changes. For instance, the configuration information may include an indication of a quantity of samples to store, log, or report based on a change of the rank of an indicator to a highest rank or based on a change of one or more ranks of one or more indicators of a set of highest ranked indicators.

In some approaches, an event may be defined based on whether a measurement or rank of one or more highest ranked beams is changed by a threshold amount (e.g., hysteresis). For example, if the rank or measurement (e.g., index or L1-RSRP) of one or more highest ranked beams has not reduced by a threshold amount or hysteresis (where the threshold amount or hysteresis may be configured via configuration information signaled from the network entity 305, for instance), then the UE 315 may not store (e.g., log) data (e.g., new training sample data). For instance, the UE 315 may refrain from storing, or the network entity 305 may not obtain, the second data 345 based on less than a rank threshold change to one or more highest ranks or less than a measurement threshold change to one or more measurements of one or more respective beams. An event may be defined, where if at least one among the top K beams (e.g., indices or L1-RSRPs) has not reduced by a threshold amount or hysteresis (where the threshold amount or hysteresis may be configured via configuration information signaled from the network entity 305, for instance), then the UE 315 may not store (e.g., log) new data (e.g., new training sample data). In some approaches, to further avoid redundancy, a time or sample window or threshold may be defined (e.g., where data is stored or reported if the threshold amount of change to the highest beam persists for a sample window or threshold quantity of samples). Variations of utilizing the threshold amount of change to the highest ranked beam may be implemented in conjunction with one or more of the concepts described with reference to one or more of FIGS. 5-8.

In some aspects, the network entity 305 may output, or the UE 315 may receive, configuration information, where the configuration information may indicate one or more first conditions to store data for training of the AI model associated with a first set of beams, or may indicate one or more second conditions to store data for training of the AI model associated with a second set of beams. A first condition to store data may be an event or an aspect of an event to trigger storage of data associated with the first set of beams. A second condition to store data may be an event or an aspect of an event to trigger storage of data associated with the second set of beams. One or more of the events or aspects of the events (e.g., threshold(s)) described herein may be examples of the first condition to store data or the second condition to store data. For example, one or more of the described events may be defined for a first set of beams (e.g., set A) and a second set of beams (e.g., set B) separately. For instance, the network (e.g., network entity 305) may indicate the first set of beams (e.g., set A) and the second set of beams (e.g., set B) to the UE 315, and may configure one or more thresholds separately for the first set of beams and the second set of beams.

In some approaches, the network entity 305 may output, or the UE 315 may receive, configuration information, where the configuration information may indicate one or more conditions to store data for training of the AI model associated with a first set of beams and a second set of beams. For example, one or more of the described events may be defined jointly for the first set of beams (e.g., set A) and the second set of beams (e.g., set B). For instance, the network (e.g., network entity 305) may not indicate the first set of beams or the second set of beams, or may provide one or more thresholds for both sets of beams.

In some aspects, the network entity 305 may output, or the UE 315 may receive, configuration information, where the configuration information may indicate one or more first conditions to store the first data 340 to train the AI model associated with the first indicator that corresponds to the first beam 350-a, and indicates one or more second conditions to store the second data 345 to train the AI model associated with the second indicator that corresponds to the second beam 350-b. For example, one or more of the events described herein may be defined, where the network (e.g., network entity 305) may define one or more thresholds for different associated identifiers separately. For instance, the network (e.g., network entity 305) may configure different thresholds for different associated identifiers (e.g., different codebook indexes, or other RAN configurations).

In some aspects, the network entity 305 may output, or the UE 315 may receive, configuration information. The configuration information may indicate one or more conditions to store data for training of the AI model associated with one or more beams or one or more sets of beams, and indicates one or more indicators (e.g., identifiers, beam indices, among other examples) associated with the one or more beams or the one or more sets of beams.

In some examples, one or more protocols may be utilized for configuring one or more of the events described herein. One or more options for configuration or reporting procedures for training data collection may be utilized. In some approaches, a reference signal configuration (e.g., one or more reference signal configurations for set A beams or set B beams, or other beams to be measured) and one or more associated identifiers (if provided) may be configured using CSI report configuration signaling. The UE 315 may report the data (e.g., measurements) using RRC or UCI signaling. For instance, layer 3 (L3) measurement signaling or an immediate minimization of drive test (MDT) reporting configuration may be utilized. One or more proposed enhancements may be implemented for protocols for configuring events. For example, the network entity 305 (e.g., a gNB in a non-split architecture) or a DU (e.g., gNB-DU in a split architecture) may configure (e.g., communicate configuration information for) events with the reference signal configuration information (e.g., set A beams or set B beams, or beams to be measured) and one or more associated identifiers (if provided).

In some approaches, a reference signal configuration (e.g., one or more reference signal configurations for set A beams or set B beams, or other beams to be measured) and one or more associated identifiers (if provided) may be configured using RRC or downlink control information (DCI) signaling (e.g., measurement configuration reporting, or enhanced measurement configuration reporting for training data collection). The UE 315 may report the data (e.g., measurements) using RRC or UCI signaling. For instance, L3 measurement signaling or an immediate MDT reporting configuration may be utilized. One or more proposed enhancements may be implemented for protocols for configuring events. For example, the network entity 305 (e.g., a gNB in a non-split architecture) or a CU (e.g., gNB-CU in a split architecture) may configure (e.g., communicate configuration information for) events with the reference signal configuration information (e.g., set A beams or set B beams, or beams to be measured) and one or more associated identifiers (if provided). In some approaches, the reference signal configuration information (e.g., set A beams or set B beams, or beams to be measured), one or more associated identifiers (if provided), or one or more events may be determined by a DU (e.g., gNB-DU), and provided to the CU (e.g., gNB-CU) via F1 signaling.

Some examples of events for data collection for model training are provided herein. Events for data collection and reporting may be utilized for collecting data while reducing power or memory consumption at the UE 315. Event-triggered data collection for network-side model training may be provided for beam management use cases. For example, events for the data collection for the network-side model training may be defined to achieve collection of meaningful data for model training and reduction of redundant data collection and reporting (including logging, for instance) at the UE 315.

In some aspects, event-triggered data collection for network-side model training may be supported for beam management. One or more different events may be utilized to trigger data collection, logging, or reporting. To achieve the diversity in the data collections at the UE 315, one or more data collection events may be defined where the UE 315 is configured with one or more distributions of samples (e.g., quantity(ies) of samples) to be collected, logged, or reported when one or more beams are measured as highest ranking (e.g., top) beam.

In some approaches, measurement collection, logging, or reporting may be performed when the UE 315 is configured to report or log a configured quantity of measurement samples when a highest ranked (e.g., top) beam changes. Additionally, or alternatively, one or more events may be defined for when one or more beams among a set of highest ranked (e.g., top K) beams change. The quantity of beams in the set of highest ranked beams (that may change for logging the measurement), or the quantity of samples to be logged upon triggering the event may be configurable by the network (e.g., network entity 305). In some examples, one or more events may be based on one or more measurement (e.g., the L1-RSRP measurement) thresholds for a highest ranked beam (or a set of highest ranked beams).

In some examples, one or more of the following events may be utilized for training data collection for network-side model training. Event 1: the UE 315 may be provided with a distribution of samples (e.g., a quantity of samples) to be collected when a configured beam(s) is a highest ranked (e.g., top) beam. The UE 315 may stop storing, logging, or reporting new measurements if the configured quantity of measurements logged or reported for a given beam (e.g., while the beam is the highest ranked beam) is reached. The UE 315 may log one or more measurements for one or more other beams, while at the highest rank, and the configured quantity of samples has not been logged or reported.

Event 2: the UE 315 may be configured to store, log, or report a measurement when the highest ranked (e.g., top) beam changes. The UE 315 may additionally be configured with a quantity of samples to be logged and a periodicity when the highest ranked (e.g., top) beam changes.

Event 3: the UE 315 may be configured to store, log, or report a measurement when one or more among a set of highest ranked (e.g., top K) beams changes. The network (e.g., network entity 305) may configure a quantity of beams to change to trigger the UE 315 to log measurement samples, a quantity of measurement samples, and periodicity.

Event 4: the UE 315 may be configured to log a measurement when a highest ranked (e.g., top) beam or a measurement (e.g., absolute measurement or L1-RSRP) of the top beam changes by configured value. An observation window may be defined to avoid redundant measurement storage, reporting, or logging. For example, the absolute L1-RSRP of highest ranked beams may be outside the initial L1-RSRP (at the start of the moving window) plus or minus a threshold for at least a configured quantity of measurement samples. Additionally, or alternatively, the UE 315 may be configured with a quantity of samples to be logged and a periodicity.

Event 5: the UE 315 may be configured to log a measurement when one or more of a set of highest ranked (e.g., top K) beams or measurements (e.g., absolute measurements or L1-RSRPs) of one or more the set of highest ranked (e.g., top K) beams changes by a configured value. An observation window may be defined to avoid redundant measurement storage, reporting, or logging. For example, the L1-RSRP of one or more of a set of highest ranked (e.g., top K) beams may be outside the initial L1-RSRP of those beams (at the start of the moving window) plus or minus a threshold for at least a configured quantity of measurement samples. Additionally, or alternatively, the UE 315 may be configured with a quantity of beams to change to trigger the UE 315 to log a measurement, a quantity of samples to be logged, and a periodicity.

In some examples, the network (e.g., network entity 305) may configure the UE 315 with a quantity of samples to be stored, reported, or logged when a configured event occurs, or with a periodicity of for storing, reporting, or logging. In some cases, the configuration may be applicable for one or more of Event 2-Event 5.

In some approaches, the network (e.g., network entity 305) may configure a threshold quantity of beams among a set of highest ranked (e.g., top K) beams to change to trigger UE 315 to store, log, or report the measurements. In some cases, the configuration may be applicable for one or more of Event 3 or Event 5.

For one or more of Event 4 or Event 5, an observation window may be utilized, where the UE 315 may log new measurements when a measurement (e.g., L1-RSRP) of one or more highest ranking (e.g., top) beams (or one or more beams' L1-RSRPs) reaches outside of an initial (e.g., at a start of the moving window) measurement (e.g., L1-RSRP) plus or minus a threshold for at least a configured quantity of measurement samples. The window may or may not be utilized in some approaches.

As used herein, the term “absolute” may refer to an absolute quantity or may refer to an increase or decrease in a quantity. For instance, an absolute measurement may refer to an absolute quantity of the measurement, to an increase in the measurement, or to a decrease in the measurement. In some examples, the term “absolute” may refer one event or separate events utilizing an absolute quantity (e.g., a threshold for an absolute quantity), a decrease in the quantity (e.g., a threshold decrease), or an increase in the quantity (e.g., a threshold increase).

FIG. 4 shows an example of a timing diagram 400 that supports collection of data for training of AI models for beam prediction in accordance with one or more aspects of the present disclosure. The timing diagram 400 of FIG. 4 illustrates an example of storing samples in accordance with configured indicators, periodicity, and quantities of samples for beams (e.g., serving beams or highest ranked beams, among other examples).

In the example of FIG. 4, a first period 405-a, a second period 405-b, and a third period 405-c are illustrated over time. The first period 405-a, second period 405-b, and third period 405-c may be periods in accordance with a periodicity for sampling (e.g., measurement) as described in accordance with one or more of the techniques or operations described with reference to FIG. 3.

A network (e.g., network entity 305) may configure a UE (e.g., the UE 315) with indicators (e.g., beam identifiers, beam indices, SSB information, or CSI-RS information, among other examples) corresponding to beams, the periodicity, and quantities of samples for one or more beams (e.g., serving beams or highest ranked beams). In the example of FIG. 4, the UE is configured to collect five samples on SSB 1 (corresponding to beam 1) and two samples on SSB 2 (corresponding to beam 2).

As illustrated in the example of FIG. 4, the UE utilizes beam 3, beam 1, beam 5, and beam 2 as serving beams or highest ranked beams over time. In the first period 405-a, no samples are collected 410 by the UE, because beam 3 corresponds to SSB 3, which the UE is not configured to sample or measure. In the second period 405-b, the UE collects five samples corresponding to SSB 1 or beam 1. The UE stops sample collection after the five samples (e.g., after the fifth sample 415 shown in FIG. 4) due to the configured quantity of five samples. In the second period 405-b, no samples corresponding to beam 5 are collected 420 by the UE, because beam 5 corresponds to SSB 5, which the UE is not configured to sample or measure. In the third period 405-c, the UE collects two samples corresponding to SSB 2 or beam 2. The UE stops sample collection after the two samples (e.g., after the second sample 415) due to the configured quantity of two samples. In some examples, no measurement or logging may be performed for SSB 5 in the second period 405-b or the third period 405-c. As illustrated in the example of FIG. 4, one or more events may be utilized to capture data relevant to training an AI model for beam prediction, while avoiding capturing redundant data.

FIG. 5 shows an example of a timing diagram 500 that supports collection of data for training of AI models for beam prediction in accordance with one or more aspects of the present disclosure. The timing diagram 500 of FIG. 5 illustrates a set of sample occasions 505, where each sample occasion is denoted with an arrow. The numbers above the arrows indicate beams (e.g., beam identifiers or beam indices) respectively corresponding to the sample occasions 505. Some of the arrows denote stored samples 510 (e.g., sample occasions for which a UE stores or reports samples or measurements corresponding to a reference signal from a beam). Some of the arrows denote skipped samples 515 (e.g., sample occasions for which a UE refrains from storing or reporting samples or measurements corresponding to a reference signal from a beam).

In some approaches, an event for storing (e.g., logging) or reporting data may be based on a change in rank in an order of beams. For example, a UE (e.g., UE 315) may store or report, or a network entity (e.g., network entity 305) may obtain, data based on a change to a highest rank of the order of beams. If the highest rank (e.g., a top single beam index) has not changed, then the UE may not store (e.g., log) or report (or the network entity 305 may not obtain) data (e.g., new training samples or data).

As illustrated in FIG. 5, each time a highest ranked beam changes, the UE stores (e.g., logs) or reports (or the network entity obtains) one or more new samples. For instance, the stored samples 510 include the first sample for beam 1, a sample for beam 3 (after the highest ranked beam changes from beam 1 to beam 3), a sample for beam 2 (after the highest ranked beam changes from beam 3 to beam 2), another sample for beam 3 (after the highest ranked beam changes from beam 2 to beam 3), a sample for beam 4 (after the highest ranked beam changes from beam 3 to beam 4), another sample for beam 3 (after the highest ranked beam changes from beam 4 to beam 3), and another sample for beam 4 (after the highest ranked beam changes from beam 3 to beam 4). The approach (e.g., event) of FIG. 5 may reduce capturing redundant information (but may not capture some dynamicity in the channel in some cases, for instance). In some examples, the approach of FIG. 5 may be utilized with or without a sample window (e.g., a threshold quantity of samples from a beam after a rank change to store or report a sample or measurement). For instance, a window may be configured (e.g., via signaling) or may not be configured. Utilizing a sample window may further reduce redundancy.

FIG. 6 shows an example of a timing diagram 600 that supports collection of data for training of AI models for beam prediction in accordance with one or more aspects of the present disclosure. The timing diagram 600 of FIG. 6 illustrates a set of sample occasions 605, where each sample occasion is denoted with an arrow. The numbers above the arrows indicate beams (e.g., beam identifiers or beam indices) respectively corresponding to the sample occasions 605. Some of the arrows denote stored samples 610 (e.g., sample occasions for which a UE stores or reports samples or measurements corresponding to a reference signal from a beam). Some of the arrows denote skipped samples 615 (e.g., sample occasions for which a UE refrains from storing or reporting samples or measurements corresponding to a reference signal from a beam).

In some examples, a UE (e.g., UE 315) may store (e.g., log) or report data (e.g., new measurements) when another beam becomes the highest ranked (e.g., highest single ranked) beam for a threshold quantity of samples (e.g., K samples) since data was last stored or reported (e.g., since the most recent logged or reported measurement). In FIG. 6, the threshold quantity of samples (e.g., window size) may be K=2. In other examples, the threshold quantity of samples may be a different quantity (e.g., K=0, 1, 3, 4, 5, 20, 100, or 500, among other examples). In some approaches, the network may determine to configure (e.g., via signaling to the UE) another value for K (e.g., K=0). For K=0, for instance, a UE may log or report each time that another beam becomes the highest ranked beam.

As illustrated in FIG. 6, the stored samples 610 include the first sample for beam 1, a sample for beam 2 (after the highest ranked beam changes from beam 3 to beam 2 and the threshold quantity of at least K=2 samples is satisfied after the change), a sample for beam 3 (after the highest ranked beam changes from beam 2 to beam 3 and the threshold quantity of at least K=2 samples is satisfied after the change), and a sample for beam 4 (after the highest ranked beam changes from beam 3 to beam 4 and the threshold quantity of at least K=2 samples is satisfied after the change). The approach (e.g., event) of FIG. 6 may reduce capturing redundant information (but may not capture some dynamicity in the channel in some cases, for instance).

FIG. 7 shows an example of a timing diagram 700 that supports collection of data for training of AI models for beam prediction in accordance with one or more aspects of the present disclosure. The timing diagram 700 of FIG. 7 illustrates a set of sample occasions 705, where each sample occasion is denoted with an arrow. The numbers above the arrows indicate beams (e.g., beam identifiers or beam indices) respectively corresponding to the sample occasions 705. Some of the arrows denote stored samples 710 (e.g., sample occasions for which a UE stores or reports samples or measurements corresponding to a reference signal from a beam). Some of the arrows denote skipped samples 715 (e.g., sample occasions for which a UE refrains from storing or reporting samples or measurements corresponding to a reference signal from a beam).

In some aspects, a UE (e.g., UE 315) may store (e.g., log) or report a first, last, or latest measurement sample in a moving window based on a change to the highest rank in the order of beams (e.g., if another beam reaches the highest rank). For instance, the UE may store or report a last measurement sample corresponding to a beam before a change to the highest rank in the order of beams. In some examples, a UE (e.g., UE 315) may store (e.g., log) or report data (e.g., new measurements) when another beam becomes the highest ranked (e.g., highest single ranked) beam for a threshold quantity of samples (e.g., K samples) since data was last stored or reported (e.g., since the most recent logged or reported measurement). In some approaches, the threshold quantity of samples (e.g., window size) may be K=0, 1, 3, 4, 5, 20, 100, 500, or another value. For instance, a network may determine to configure (e.g., via signaling to the UE) K=0, 2, or another value. In the example of FIG. 7, the threshold quantity of samples (e.g., window) is K=0. For K=0, for instance, a UE may log or report a last sample before a change to a highest ranked beam. A change to a highest ranked beam may occur each time that a beam that was not previously ranked as the highest ranked beam becomes the highest ranked beam.

In FIG. 7, a moving window may capture a first sample when a change to the highest ranked beam occurs, where a last sample or measurement before the change may be stored or reported. As illustrated in FIG. 7, the stored samples 710 include a last sample for beam 1 (before the highest ranked beam changes from beam 1 to beam 3), a last sample for beam 3 (before the highest ranked beam changes from beam 3 to beam 2), a sample for beam 2 (before the highest ranked beam changes from beam 2 to beam 3), a last sample for beam 3 (before the highest ranked beam changes from beam 3 to beam 4), a last sample for beam 4 (before the highest ranked beam changes from beam 4 to beam 3), and a last sample for beam 3 (before the highest ranked beam changes from beam 3 to beam 4). The approach (e.g., event) of FIG. 7 may reduce capturing redundant information (but may not capture some dynamicity in the channel in some cases, for instance).

FIG. 8 shows an example of a timing diagram 800 that supports collection of data for training of AI models for beam prediction in accordance with one or more aspects of the present disclosure. The timing diagram 800 of FIG. 8 illustrates a set of sample occasions 805, where each sample occasion is denoted with an arrow. The numbers above the arrows indicate beams (e.g., beam identifiers or beam indices) respectively corresponding to the sample occasions 805. Some of the arrows denote stored samples 810 (e.g., sample occasions for which a UE stores or reports samples or measurements corresponding to a reference signal from a beam). Some of the arrows denote skipped samples 815 (e.g., sample occasions for which a UE refrains from storing or reporting samples or measurements corresponding to a reference signal from a beam).

In some approaches, each time a highest ranked beam (e.g., highest single ranked beam) changes, a UE (e.g., UE 315) may report the measurement sample corresponding to the change and a last measurement sample before the change (e.g., avoiding duplications). In some aspects, a UE (e.g., UE 315) may store (e.g., log) or report a first and last latest measurement sample based on a change to the highest rank in the order of beams (e.g., if another beam reaches the highest rank). For instance, the UE may store or report a last measurement sample corresponding to a beam before a change to the highest rank in the order of beams and a first measurement sample corresponding to a change of a beam to the highest rank. In some examples, a UE (e.g., UE 315) may store (e.g., log) or report data (e.g., new measurements) without using a window (or without having a window configured, for instance).

In FIG. 8, a UE may store or report a first sample when a change to the highest ranked beam occurs and a last sample or measurement before the change. As illustrated in FIG. 8, the stored samples 810 include a first sample for beam 1, a last sample for beam 1 (before the highest ranked beam changes from beam 1 to beam 3) and a sample of beam 3 (with the change to the highest ranked beam to beam 3), a sample of beam 2 (with the change to the highest ranked beam from beam 3 to beam 2, where the previous sample of beam 3 was already captured), a last sample for beam 2 (before the highest ranked beam changes from beam 2 to beam 3) and a sample of beam 3 (with the change to the highest ranked beam to beam 3), a last sample for beam 3 (before the highest ranked beam changes from beam 3 to beam 4) and a sample of beam 4 (with the change to the highest ranked beam to beam 4), a last sample for beam 4 (before the highest ranked beam changes from beam 4 to beam 3) and a sample of beam 3 (with the change to the highest ranked beam to beam 3), and a last sample for beam 3 (before the highest ranked beam changes from beam 3 to beam 4) and a sample of beam 4 (with the change to the highest ranked beam to beam 4). The approach (e.g., event) of FIG. 8 may capture channel changes.

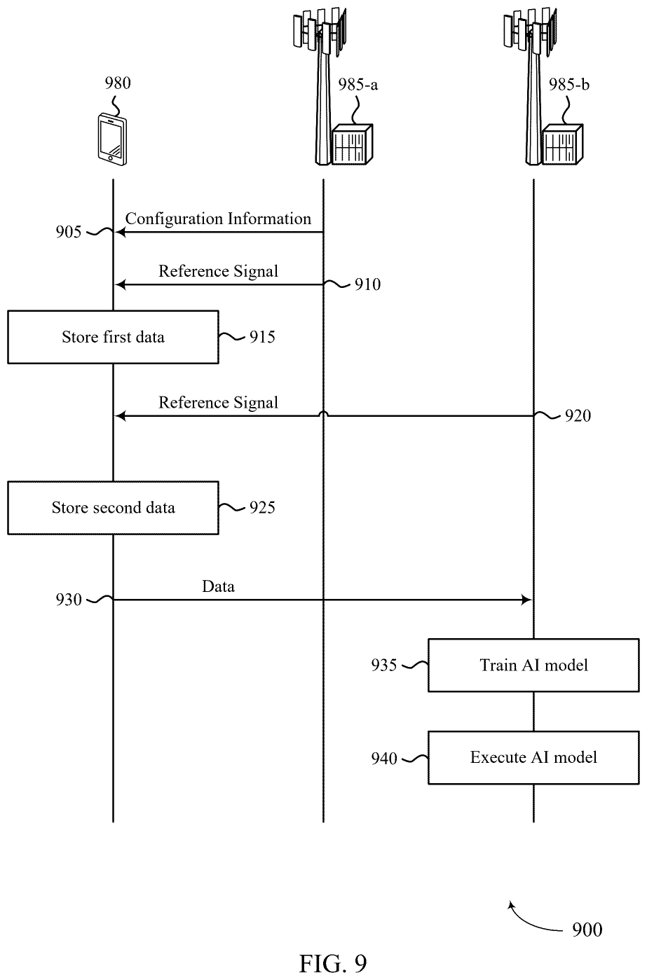

FIG. 9 shows an example of a process flow 900 that supports collection of data for training of AI models for beam prediction in accordance with one or more aspects of the present disclosure. The process flow 900 may include a UE 980, which may be an example of a UE 115, UE 115-a, or UE 315, as described herein. The process flow 900 may also include a network entity 985-a and a network entity 985-b, which may be examples of a network entity 105, CU 160, CU 160-a, DU 165, DU 165-a, RU 170, RU 170-a, or network entity 305, as described herein.

In the following description of the process flow 900, the communications between the UE 980, the network entity 985-a, or the network entity 985-b may be transmitted in a different order than the example order shown, or the operations performed by the UE 980, the network entity 985-a, or the network entity 985-b may be performed in different orders or at different times. One or more operations may be omitted from the process flow 900, or one or more other operations may be added to the process flow 900. Although some operations or signaling may be shown to occur at different times for discussion purposes, these operations may actually occur at the same time or in overlapping time periods in some examples.

At 905, the network entity 985-a may transmit configuration information to the UE 980. For instance, the configuration information may be transmitted to the UE 980 as described with reference to FIG. 4. The configuration information may indicate one or more events or one or more parameters for use in storing or reporting data for training an AI model.

At 910, the network entity 985-a may transmit a reference signal to the UE 980. For instance, the network entity 985-a may transmit a reference signal corresponding to a first beam as described with reference to FIG. 4.

At 915, the UE 980 may store first data. For instance, the UE 980 may store data (e.g., samples or measurements) based on the reference signal and based on one or more events (e.g., moving a threshold distance or based on one or more measurements of the reference signal) as described with reference to FIG. 4.

At 920, the network entity 985-b may transmit a reference signal to the UE 980. For instance, the network entity 985-b may transmit a reference signal corresponding to a second beam as described with reference to FIG. 4.

At 925, the UE 980 may store second data. For instance, the UE 980 may store data (e.g., samples or measurements) based on the reference signal and based on one or more events (e.g., moving a threshold distance or based on one or more measurements of the reference signal) as described with reference to FIG. 4.

At 930, the UE 980 may transmit data to the network entity 985-b. For instance, the UE 980 may transmit the first data and the second data as described with reference to FIG. 4.

At 935, the network entity 985-b may train an AI model based on the data. For instance, the network entity 985-b may utilize the first data and the second data collected by the UE 980 to train an AI model for beam prediction as described with reference to FIG. 4.

At 940, the network entity 985-b may execute the AI model. For instance, the network entity 985-b may utilize the AI model for beam prediction (e.g., to select a beam for one or more UEs). In some approaches, the network entity 985-b may output (e.g., transmit) the trained AI model to one or more network entities for use.

FIG. 10 shows an example of a node diagram 1000 that supports collection of data for training of AI models for beam prediction in accordance with one or more aspects of the present disclosure. AI models are programmatic or algorithmic structures that simulate intelligent behavior. Machine learning models may be examples of AI models. Machine learning models are programmatic or algorithmic structures that may be trained to infer or predict an output based on an input. For example, an ML model may be trained using training input data and ground truth data.

Machine learning models may be categorized as unsupervised or supervised. Unsupervised learning may be utilized to draw inferences and find patterns from input data without references to labeled outcomes. Two examples of unsupervised learning models include clustering and dimensionality reduction. Clustering is an unsupervised technique that involves the grouping, or clustering, of data points. Clustering techniques may include k-means clustering, hierarchical clustering, mean shift clustering, and density-based clustering. Dimensionality reduction may be a procedure for reducing a quantity of random variables under consideration by obtaining a set of principal variables. Dimensionality reduction may reduce the dimension of a feature set or reduce a quantity of features). Some dimensionality reduction techniques may be categorized as feature elimination or feature extraction. One example of dimensionality reduction may be referred to as principal component analysis (PCA). PCA may involve projecting higher dimensional data (e.g., three dimensions) to a lower-dimensional space (e.g., two dimensions), which may result in a lower dimension of data (e.g., two dimensions instead of three dimensions) while maintaining one or more variables in the model.

Supervised learning involves learning a function that maps an input to an output based on associated inputs and outputs. For instance, supervised learning may be utilized to draw inferences and find patterns from input data based on labeled data (e.g., training input data with associated ground truth data). A supervised model may sub-categorized as a regression or classification model. Regression models may provide continuous outputs. One example of a regression model is a linear regression, which may determine a line that fits (e.g., best fits) input data. Extensions of linear regression include multiple linear regression (e.g., finding a plane of best fit) and polynomial regression (e.g., finding a curve of best fit).

In classification models, the output may be discrete. One example of a classification model is logistic regression. Logistic regression may be similar to linear regression, but may be used to model a probability for a finite quantity of outcomes. For example, a logistic regression may be utilized such that the output values may be between 0 and 1. Another example of a classification model is a support vector machine. For two classes of data, for example, a support vector machine may determine a hyperplane or a boundary between the two classes of data that maximizes a margin between the two classes. For instance, many planes may separate two classes, while one plane may maximize the margin or distance between the classes. Another example of a classification model is Naïve Bayes, which is based on Bayes Theorem.

Other examples of classification models include decision tree models, random forest models, and neural network models, where an output may be discrete. In a decision tree model, a tree structure is defined with multiple nodes. Decisions may be used to move from a root node at the top of the decision tree to a leaf node (e.g., a node without a child node) at the bottom of the decision tree. A higher quantity of nodes in the decision tree model may correlate with higher decision accuracy.

Random forest models may utilize ensemble learning techniques that build from decision tree models. Random forests involve creating multiple decision trees using bootstrapped datasets of the original data and randomly selecting a subset of variables at each tier of the decision tree. The model may select the mode of all of the predictions of each decision tree. By relying on a “majority wins” model, the risk of error from an individual tree may be reduced.

Another example of an ML model is a neural network (NN). A neural network may be a network of functional nodes. Neural networks may utilize one or more input variables to traverse the nodes and generate one or more output variables. For example, a neural network may utilize an input vector to generate an output vector.

The AI model illustrated in FIG. 10 is an example of a neural network. The neural network includes an input layer i that receives n (one or more) inputs (illustrated as “Input 1,” “Input 2,” and “Input n”), one or more hidden layers (illustrated as hidden layers “h1,” “h2,” and “h3”) for processing the inputs from the input layer, and an output layer o that provides m (one or more) outputs (labeled “Output 1” and “Output m”). While examples of quantities of inputs n, hidden layers h, and outputs m are illustrated in FIG. 10 same or different quantities of inputs, hidden layers, or outputs may be utilized in other examples. In some approaches, the hidden layers h may include linear function(s) or activation function(s) that the nodes (illustrated as circles) of each successive hidden layer process from the nodes of the previous hidden layer.

In some aspects, the AI model illustrated in FIG. 10 or another AI model may be trained in accordance with one or more training techniques. In some examples of the training techniques described herein, one or more AI models (e.g., implemented by one or more devices) may be trained based on training input data (e.g., measurements or samples of reference signals to or from various UEs corresponding to one or more beams), thereby enabling later determination of an output (e.g., an inferred or predicted sample(s) or measurement(s)) when an AI model is executed with runtime input data (e.g., from other UEs).

Ground truth data may be data representing a target output associated with training input data. Ground truth data may be generated or observed (e.g., empirical) data. In some examples, ground truth data may indicate one or more observed measurements (e.g., reference signal samples) corresponding to training input data. Examples of training input data may include reference signal data (e.g., measurements of a PRS, SRS, reference signal of an SSB, CSI-RS, DMRS, or TRS, among other examples), signal data (e.g., signal strength data, RSRP data, RSRPP data, RSSI data, RSRQ data, SINR data, or SNR data, among other examples), channel data (e.g., CIR data, PDP data, DP data, CQI data, CSI data, decoding failure rate, or retransmission request rate, among other examples), or identifier data (e.g., beam identifier data, among other examples), among other examples.

An AI model (e.g., the AI model illustrated in FIG. 10 or an ML model) may be trained by executing the AI model with the training data to produce an output, comparing the output with the ground truth data, and adjusting weights of the AI model to reduce a disparity between the output and the ground truth data. For example, one or more of the nodes or connections of the AI model may have an associated weight that may be adjusted to modify one or more of the outputs. In some approaches, a cost function may be utilized to compare the output with the ground truth data to indicate a cost (e.g., error or disparity). Adjustments to the weights that reduce the cost may be retained, advanced, or increased, while adjustments to the weights that increase the cost may be discarded, avoided, or decreased. Training procedures may be repeated or iterated to improve AI model performance.

Input data (e.g., runtime input data) may be provided to a trained AI model, which may infer or predict an output based on the input data. Some examples of AI models may be trained to infer or predict a reference signal measurements, beam measurements, or beam operations (e.g., beam switching).

Some examples of the techniques described herein may be performed in conjunction with one or more of the AI models described with reference to FIG. 10. For instance, one or more samples of a reference signal described with reference to FIG. 3 may be examples of inputs for one or more the AI models.

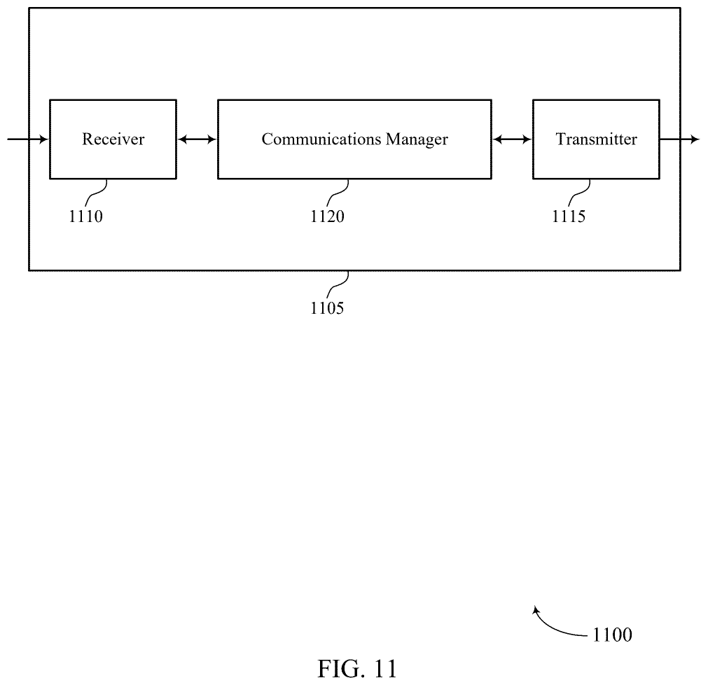

FIG. 11 shows a block diagram 1100 of a device 1105 that supports collection of data for training of AI models for beam prediction in accordance with one or more aspects of the present disclosure. The device 1105 may be an example of aspects of a UE 115 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for receiving information such as packets, user data, control information, or any combination thereof associated with various information channels (e.g., control channels, data channels, information channels related to data for training of AI models for beam prediction). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to data for training of AI models for beam prediction). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations or components thereof may be examples of means for performing various aspects of data for training of AI models for beam prediction as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for receiving, at a first location, a first reference signal that corresponds to a first beam. The communications manager 1120 is capable of, configured to, or operable to support a means for storing first data for training of an AI model for beam prediction, the first data based on the first reference signal. The communications manager 1120 is capable of, configured to, or operable to support a means for receiving, at a second location, a second reference signal that corresponds to a second beam. The communications manager 1120 is capable of, configured to, or operable to support a means for determining whether to store second data for training of the AI model for beam prediction based on a distance between the first location and the second location, the second data based on the second reference signal. The communications manager 1120 is capable of, configured to, or operable to support a means for transmitting, to a network entity, at least one of the first data or the second data.

Additionally, or alternatively, the communications manager 1120 may support wireless communications in accordance with examples as disclosed herein. For example, the communications manager 1120 is capable of, configured to, or operable to support a means for receiving, at a first occasion, a first reference signal that corresponds to a first beam. The communications manager 1120 is capable of, configured to, or operable to support a means for storing first data for training of an AI model for beam prediction based on a first indicator that corresponds to the first beam, the first data based on the first reference signal. The communications manager 1120 is capable of, configured to, or operable to support a means for receiving, at a second occasion, a second reference signal that corresponds to a second beam. The communications manager 1120 is capable of, configured to, or operable to support a means for determining whether to store second data for training of the AI model for beam prediction based on a second indicator that corresponds to the second beam, the second data based on the second reference signal. The communications manager 1120 is capable of, configured to, or operable to support a means for transmitting, to a network entity, at least one of the first data or the second data.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing, reduced power consumption, or more efficient utilization of communication resources.

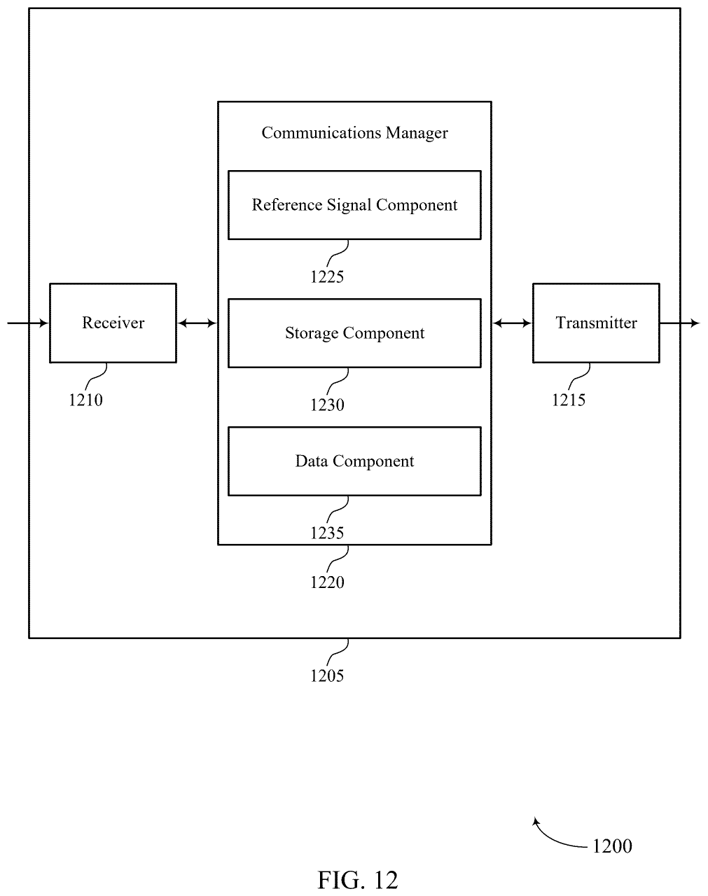

FIG. 12 shows a block diagram 1200 of a device 1205 that supports collection of data for training of AI models for beam prediction in accordance with one or more aspects of the present disclosure. The device 1205 may be an example of aspects of a device 1105 or a UE 115 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for receiving information such as packets, user data, control information, or any combination thereof associated with various information channels (e.g., control channels, data channels, information channels related to data for training of AI models for beam prediction). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to data for training of AI models for beam prediction). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of data for training of AI models for beam prediction as described herein. For example, the communications manager 1220 may include a reference signal component 1225, a storage component 1230, a data component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The reference signal component 1225 is capable of, configured to, or operable to support a means for receiving, at a first location, a first reference signal that corresponds to a first beam. The storage component 1230 is capable of, configured to, or operable to support a means for storing first data for training of an AI model for beam prediction, the first data based on the first reference signal. The reference signal component 1225 is capable of, configured to, or operable to support a means for receiving, at a second location, a second reference signal that corresponds to a second beam. The storage component 1230 is capable of, configured to, or operable to support a means for determine whether to store second data for training of the AI model for beam prediction based on a distance between the first location and the second location, the second data based on the second reference signal. The data component 1235 is capable of, configured to, or operable to support a means for transmitting, to a network entity, at least one of the first data or the second data.

Additionally, or alternatively, the communications manager 1220 may support wireless communications in accordance with examples as disclosed herein. The reference signal component 1225 is capable of, configured to, or operable to support a means for receiving, at a first occasion, a first reference signal that corresponds to a first beam. The storage component 1230 is capable of, configured to, or operable to support a means for storing first data for training of an AI model for beam prediction based on a first indicator that corresponds to the first beam, the first data based on the first reference signal. The reference signal component 1225 is capable of, configured to, or operable to support a means for receiving, at a second occasion, a second reference signal that corresponds to a second beam. The storage component 1230 is capable of, configured to, or operable to support a means for determining whether to store second data for training of the AI model for beam prediction based on a second indicator that corresponds to the second beam, the second data based on the second reference signal. The data component 1235 is capable of, configured to, or operable to support a means for transmitting, to a network entity, at least one of the first data or the second data.

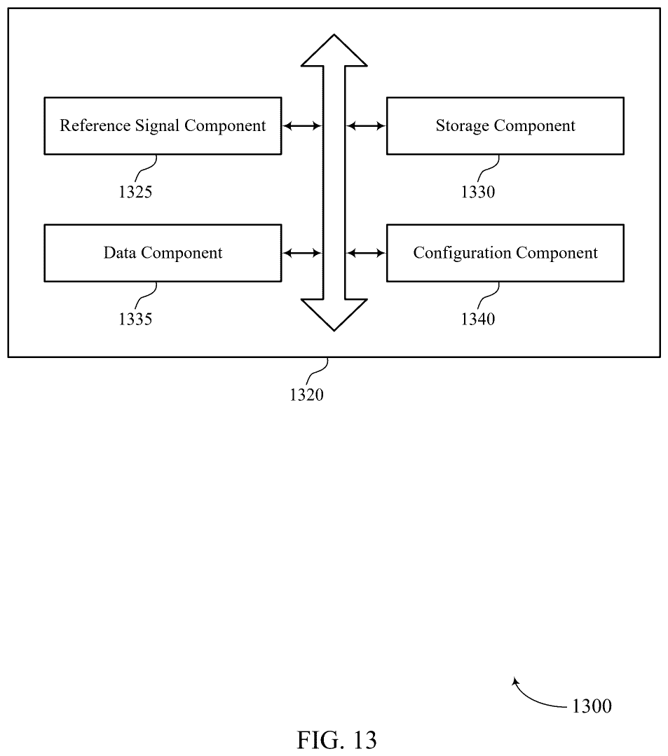

FIG. 13 shows a block diagram 1300 of a communications manager 1320 that supports collection of data for training of AI models for beam prediction in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of data for training of AI models for beam prediction as described herein. For example, the communications manager 1320 may include a reference signal component 1325, a storage component 1330, a data component 1335, a configuration component 1340, or any combination thereof. Each of these components, or components or subcomponents thereof (e.g., one or more processors, one or more memories), may communicate, directly or indirectly, with one another (e.g., via one or more buses).

The communications manager 1320 may support wireless communications in accordance with examples as disclosed herein. The reference signal component 1325 is capable of, configured to, or operable to support a means for receiving, at a first location, a first reference signal that corresponds to a first beam. The storage component 1330 is capable of, configured to, or operable to support a means for storing first data for training of an AI model for beam prediction, the first data based on the first reference signal. In some examples, the reference signal component 1325 is capable of, configured to, or operable to support a means for receiving, at a second location, a second reference signal that corresponds to a second beam. In some examples, the storage component 1330 is capable of, configured to, or operable to support a means for determine whether to store second data for training of the AI model for beam prediction based on a distance between the first location and the second location, the second data based on the second reference signal. The data component 1335 is capable of, configured to, or operable to support a means for transmitting, to a network entity, at least one of the first data or the second data.

In some examples, the UE stores the second data based on the distance between the first location and the second location that satisfies a threshold distance.

In some examples, the UE refrains from storing the second data based on the distance between the first location and the second location failing to satisfy a threshold distance.

In some examples, the configuration component 1340 is capable of, configured to, or operable to support a means for receiving configuration information that indicates a threshold distance, where the first reference signal is received at a first occasion of a set of occasions and the second reference signal is received at a second occasion of the set of occasions, and where the UE stores the second data based on the distance between the first location and the second location that satisfies the threshold distance.

In some examples, the determination whether to store the second data is based on a trajectory of the UE, the distance between the first location and the second location, or a quantity of occasions to receive reference signals.

Additionally, or alternatively, the communications manager 1320 may support wireless communications in accordance with examples as disclosed herein. In some examples, the reference signal component 1325 is capable of, configured to, or operable to support a means for receiving, at a first occasion, a first reference signal that corresponds to a first beam. In some examples, the storage component 1330 is capable of, configured to, or operable to support a means for storing first data for training of an AI model for beam prediction based on a first indicator that corresponds to the first beam, the first data based on the first reference signal. In some examples, the reference signal component 1325 is capable of, configured to, or operable to support a means for receiving, at a second occasion, a second reference signal that corresponds to a second beam. In some examples, the storage component 1330 is capable of, configured to, or operable to support a means for determining whether to store second data for training of the AI model for beam prediction based on a second indicator that corresponds to the second beam, the second data based on the second reference signal. In some examples, the data component 1335 is capable of, configured to, or operable to support a means for transmitting, to a network entity, at least one of the first data or the second data.

In some examples, the configuration component 1340 is capable of, configured to, or operable to support a means for receiving configuration information that indicates at least one indicator, a periodicity for sample collection, and at least one quantity of samples for collection, where the UE stores a first quantity of samples of the first reference signal of the first beam based on whether the first indicator corresponds to the at least one indicator and whether the first occasion corresponds to the periodicity for sample collection, and where the first quantity of samples is less than or equal to the at least one quantity of samples for collection.

In some examples, the data component 1335 is capable of, configured to, or operable to support a means for refraining from storing the second data when the second indicator does not correspond to the at least one indicator or the second occasion does not correspond to the periodicity.

In some examples, the UE stores a second quantity of samples of the second reference signal of the second beam based on whether the second indicator corresponds to the at least one indicator and whether the second occasion corresponds to the periodicity for sample collection. In some examples, the second quantity of samples is a different quantity than the first quantity of samples.

In some examples, the first indicator indicates a rank of the first beam in an order of beams based on a first measurement of the first beam, and the second indicator indicates a rank of the second beam in the order of beams based on a second measurement of the second beam.

In some examples, the UE stores the second data for the second occasion based on a change of the rank of the second indicator to a highest rank of the order of beams. In some examples, the rank of the second indicator that corresponds to the second beam changes to the highest rank of the order of beams from the rank of the first indicator that corresponds to the first beam.

In some examples, the UE stores the second data for the second occasion based on a change of the rank of the second indicator to a highest rank of the order of beams and a satisfaction of a threshold quantity of samples. In some examples, the highest rank of the order of beams changes from the first indicator that corresponds to the first beam to the second indicator that corresponds to the second beam for at least the threshold quantity of samples.

In some examples, the UE stores the first data for the first occasion based on a last sample of the first beam before a change to a highest rank of the order of beams.

In some examples, the UE stores the first data for the first occasion based on a last sample of the first beam before a change to a highest rank of the order of beams, and stores the second data for the second occasion based on an initial sample of the second beam after the change to the highest rank of the order of beams.

In some examples, the data component 1335 is capable of, configured to, or operable to support a means for refraining from storing the second data based on no change to one or more ranks of a set of highest ranks that includes the rank of the first beam in the order of beams.

In some examples, the data component 1335 is capable of, configured to, or operable to support a means for refraining from storing the second data based on a change that is less than a rank threshold change to, or no change to, one or more highest ranks, or less than a measurement threshold change to one or more measurements of one or more respective beams.

In some examples, the configuration component 1340 is capable of, configured to, or operable to support a means for receiving configuration information, where the configuration information indicates one or more first conditions to store data for training of the AI model associated with a first set of beams, and indicates one or more second conditions to store data for training of the AI model associated with a second set of beams.

In some examples, the configuration component 1340 is capable of, configured to, or operable to support a means for receiving configuration information, where the configuration information indicates one or more conditions to store data for training of the AI model associated with a first set of beams and a second set of beams.

In some examples, the configuration component 1340 is capable of, configured to, or operable to support a means for receiving configuration information, where the configuration information indicates one or more first conditions to store the first data associated with the first indicator that corresponds to the first beam, and indicates one or more second conditions to store the second data associated with the second indicator that corresponds to the second beam.

In some examples, the configuration component 1340 is capable of, configured to, or operable to support a means for receiving configuration information from the network entity, where the configuration information indicates one or more conditions to store data for training of the AI model associated with one or more beams or one or more sets of beams, and indicates one or more indicators associated with the one or more beams or the one or more sets of beams.

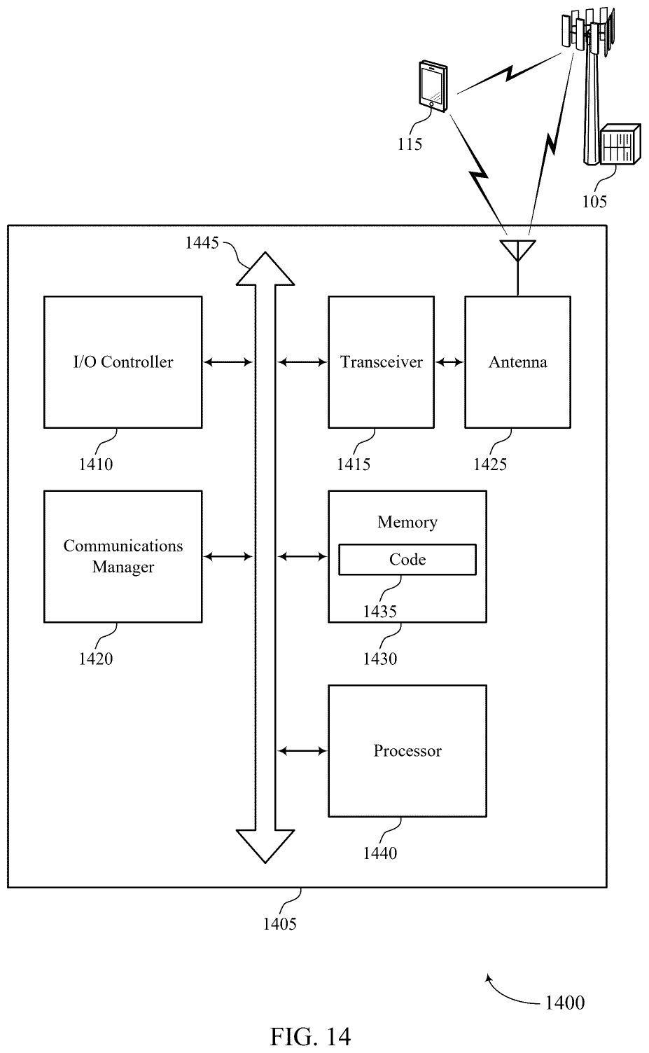

FIG. 14 shows a diagram of a system 1400 including a device 1405 that supports collection of data for training of AI models for beam prediction in accordance with one or more aspects of the present disclosure. The device 1405 may be an example of or include components of a device 1105, a device 1205, or a UE 115 as described herein. The device 1405 may communicate (e.g., wirelessly) with one or more other devices (e.g., network entities 105, UEs 115, or a combination thereof). The device 1405 may include components for bi-directional voice and data communications including components for transmitting and receiving communications, such as a communications manager 1420, an input/output (I/O) controller, such as an I/O controller 1410, a transceiver 1415, one or more antennas 1425, at least one memory 1430, code 1435, and at least one processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. Additionally, or alternatively, the I/O controller 1410 may represent or interact with a modem, a keyboard, a mouse, a touchscreen, or a similar device. In some cases, the I/O controller 1410 may be implemented as part of one or more processors, such as the at least one processor 1440. In some cases, a user may interact with the device 1405 via the I/O controller 1410 or via hardware components controlled by the I/O controller 1410.

In some cases, the device 1405 may include a single antenna. However, in some other cases, the device 1405 may have more than one antenna, which may be capable of concurrently transmitting or receiving multiple wireless transmissions. The transceiver 1415 may communicate bi-directionally via the one or more antennas 1425 using wired or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The at least one memory 1430 may include random access memory (RAM) and read-only memory (ROM). The at least one memory 1430 may store computer-readable, computer-executable, or processor-executable code, such as the code 1435. The code 1435 may include instructions that, when executed by the at least one processor 1440, cause the device 1405 to perform various functions described herein. The code 1435 may be stored in a non-transitory computer-readable medium such as system memory or another type of memory. In some cases, the code 1435 may not be directly executable by the at least one processor 1440 but may cause a computer (e.g., when compiled and executed) to perform functions described herein. In some cases, the at least one memory 1430 may include, among other things, a basic I/O system (BIOS) which may control basic hardware or software operation such as the interaction with peripheral components or devices.

The at least one processor 1440 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1440 may be configured to operate a memory array using a memory controller. In some other cases, a memory controller may be integrated into the at least one processor 1440. The at least one processor 1440 may be configured to execute computer-readable instructions stored in a memory (e.g., the at least one memory 1430) to cause the device 1405 to perform various functions (e.g., functions or tasks supporting data for training of AI models for beam prediction). For example, the device 1405 or a component of the device 1405 may include at least one processor 1440 and at least one memory 1430 coupled with or to the at least one processor 1440, the at least one processor 1440 and the at least one memory 1430 configured to perform various functions described herein.

In some examples, the at least one processor 1440 may include multiple processors and the at least one memory 1430 may include multiple memories. One or more of the multiple processors may be coupled with one or more of the multiple memories, which may, individually or collectively, be configured to perform various functions described herein. In some examples, the at least one processor 1440 may be a component of a processing system, which may refer to a system (such as a series) of machines, circuitry (including, for example, one or both of processor circuitry (which may include the at least one processor 1440) and memory circuitry (which may include the at least one memory 1430)), or components, that receives or obtains inputs and processes the inputs to produce, generate, or obtain a set of outputs. The processing system may be configured to perform one or more of the functions described herein. For example, the at least one processor 1440 or a processing system including the at least one processor 1440 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code 1435 (e.g., processor-executable code) stored in the at least one memory 1430 or otherwise, to perform one or more of the functions described herein.

The communications manager 1420 may support wireless communications in accordance with examples as disclosed herein. For example, the communications manager 1420 is capable of, configured to, or operable to support a means for receiving, at a first location, a first reference signal that corresponds to a first beam. The communications manager 1420 is capable of, configured to, or operable to support a means for storing first data for training of an AI model for beam prediction, the first data based on the first reference signal. The communications manager 1420 is capable of, configured to, or operable to support a means for receiving, at a second location, a second reference signal that corresponds to a second beam. The communications manager 1420 is capable of, configured to, or operable to support a means for determining whether to store second data for training of the AI model for beam prediction based on a distance between the first location and the second location, the second data based on the second reference signal. The communications manager 1420 is capable of, configured to, or operable to support a means for transmitting, to a network entity, at least one of the first data or the second data.

Additionally, or alternatively, the communications manager 1420 may support wireless communications in accordance with examples as disclosed herein. For example, the communications manager 1420 is capable of, configured to, or operable to support a means for receiving, at a first occasion, a first reference signal that corresponds to a first beam. The communications manager 1420 is capable of, configured to, or operable to support a means for storing first data for training of an AI model for beam prediction based on a first indicator that corresponds to the first beam, the first data based on the first reference signal. The communications manager 1420 is capable of, configured to, or operable to support a means for receiving, at a second occasion, a second reference signal that corresponds to a second beam. The communications manager 1420 is capable of, configured to, or operable to support a means for determining whether to store second data for training of the AI model for beam prediction based on a second indicator that corresponds to the second beam, the second data based on the second reference signal. The communications manager 1420 is capable of, configured to, or operable to support a means for transmitting, to a network entity, at least one of the first data or the second data.

By including or configuring the communications manager 1420 in accordance with examples as described herein, the device 1405 may support techniques for improved communication reliability, reduced latency, reduced power consumption, more efficient utilization of communication resources, improved coordination between devices, longer battery life, or improved utilization of processing capability.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the at least one processor 1440, the at least one memory 1430, the code 1435, or any combination thereof. For example, the code 1435 may include instructions executable by the at least one processor 1440 to cause the device 1405 to perform various aspects of data for training of AI models for beam prediction as described herein, or the at least one processor 1440 and the at least one memory 1430 may be otherwise configured to, individually or collectively, perform or support such operations.

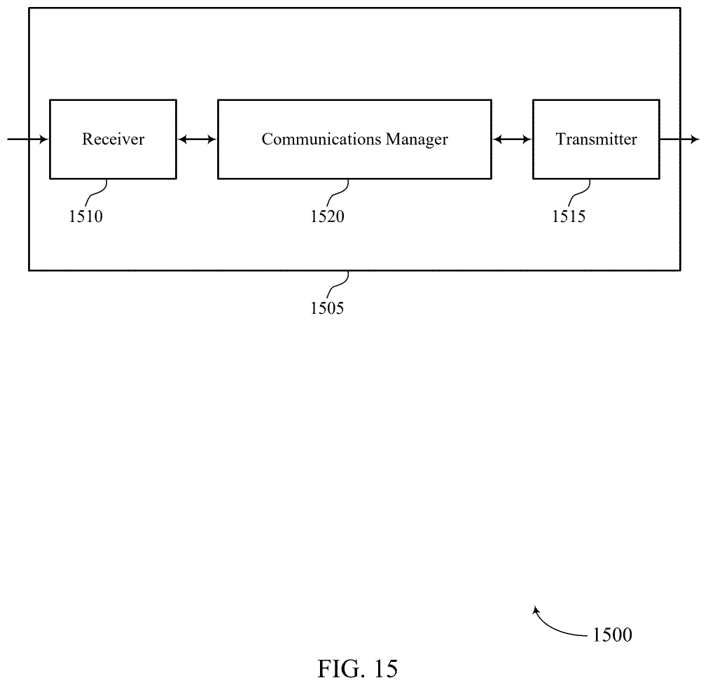

FIG. 15 shows a block diagram 1500 of a device 1505 that supports collection of data for training of AI models for beam prediction in accordance with one or more aspects of the present disclosure. The device 1505 may be an example of aspects of a network entity 105 as described herein. The device 1505 may include a receiver 1510, a transmitter 1515, and a communications manager 1520. The device 1505, or one or more components of the device 1505 (e.g., the receiver 1510, the transmitter 1515, the communications manager 1520), may include at least one processor, which may be coupled with at least one memory, to, individually or collectively, support or enable the described techniques. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1505. In some examples, the receiver 1510 may support obtaining information by receiving signals via one or more antennas. Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some examples, the transmitter 1515 and the receiver 1510 may be co-located in a transceiver, which may include or be coupled with a modem.

The communications manager 1520, the receiver 1510, the transmitter 1515, or various combinations or components thereof may be examples of means for performing various aspects of data for training of AI models for beam prediction as described herein. For example, the communications manager 1520, the receiver 1510, the transmitter 1515, or various combinations or components thereof may be capable of performing one or more of the functions described herein.

In some examples, the communications manager 1520, the receiver 1510, the transmitter 1515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1520, the receiver 1510, the transmitter 1515, or various combinations or components thereof may be implemented in code (e.g., as communications management software or firmware) executed by at least one processor (e.g., referred to as a processor-executable code). If implemented in code executed by at least one processor, the functions of the communications manager 1520, the receiver 1510, the transmitter 1515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1520 may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications in accordance with examples as disclosed herein. For example, the communications manager 1520 is capable of, configured to, or operable to support a means for transmitting configuration information that indicates a threshold distance from a first location at which a UE stores first data for training of an AI model for beam prediction. The communications manager 1520 is capable of, configured to, or operable to support a means for obtaining, from the UE, at least one of the first data associated with the first location or second data for training of the AI model associated with a second location, where the second data is obtained based on whether a distance between the first location and the second location satisfies the threshold distance.

Additionally, or alternatively, the communications manager 1520 may support wireless communications in accordance with examples as disclosed herein. For example, the communications manager 1520 is capable of, configured to, or operable to support a means for transmitting configuration information that indicates at least one indicator that includes a first indicator that corresponds to a first beam. The communications manager 1520 is capable of, configured to, or operable to support a means for obtaining, from a UE, at least one of first data for training of an AI model for beam prediction or second data for training of the AI model for beam prediction, where the first data is based on the first beam that corresponds to the first indicator, and where the second data is obtained based on a second indicator that corresponds to a second beam.

By including or configuring the communications manager 1520 in accordance with examples as described herein, the device 1505 (e.g., at least one processor controlling or otherwise coupled with the receiver 1510, the transmitter 1515, the communications manager 1520, or a combination thereof) may support techniques for reduced processing, reduced power consumption, or more efficient utilization of communication resources.

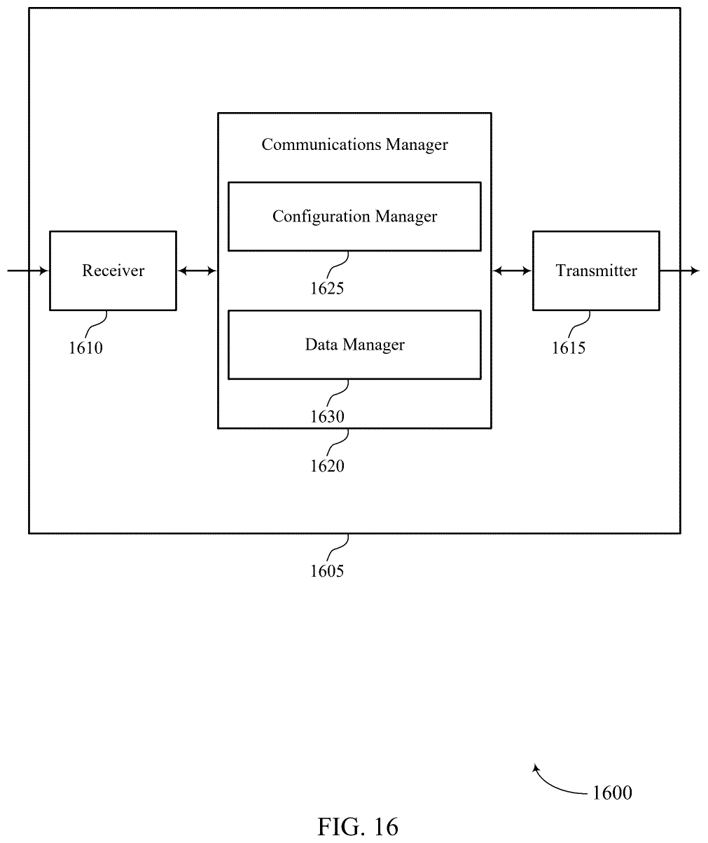

FIG. 16 shows a block diagram 1600 of a device 1605 that supports collection of data for training of AI models for beam prediction in accordance with one or more aspects of the present disclosure. The device 1605 may be an example of aspects of a device 1505 or a network entity 105 as described herein. The device 1605 may include a receiver 1610, a transmitter 1615, and a communications manager 1620. The device 1605, or one or more components of the device 1605 (e.g., the receiver 1610, the transmitter 1615, the communications manager 1620), may include at least one processor, which may be coupled with at least one memory, to support the described techniques. Each of these components may be in communication with one another (e.g., via one or more buses).

The receiver 1610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1605. In some examples, the receiver 1610 may support obtaining information by receiving signals via one or more antennas. Additionally, or alternatively, the receiver 1610 may support obtaining information by receiving signals via one or more wired (e.g., electrical, fiber optic) interfaces, wireless interfaces, or any combination thereof.

The transmitter 1615 may provide a means for outputting (e.g., transmitting, providing, conveying, sending) information generated by other components of the device 1605. For example, the transmitter 1615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1615 may support outputting information by transmitting signals via one or more antennas. Additionally, or alternatively, the transmitter 1615 may support outputting information by transmitting signals via one or more wired (e.g., electrical, fiber optic) interfaces, wireless interfaces, or any combination thereof. In some examples, the transmitter 1615 and the receiver 1610 may be co-located in a transceiver, which may include or be coupled with a modem.

The device 1605, or various components thereof, may be an example of means for performing various aspects of data for training of AI models for beam prediction as described herein. For example, the communications manager 1620 may include a configuration manager 1625 a data manager 1630, or any combination thereof. The communications manager 1620 may be an example of aspects of a communications manager 1520 as described herein. In some examples, the communications manager 1620, or various components thereof, may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communications in accordance with examples as disclosed herein. The configuration manager 1625 is capable of, configured to, or operable to support a means for transmitting configuration information that indicates a threshold distance from a first location at which a UE stores first data for training of an AI model for beam prediction. The data manager 1630 is capable of, configured to, or operable to support a means for obtaining, from the UE, at least one of the first data associated with the first location or second data for training of the AI model associated with a second location, where the second data is obtained based on whether a distance between the first location and the second location satisfies the threshold distance.

Additionally, or alternatively, the communications manager 1620 may support wireless communications in accordance with examples as disclosed herein. The configuration manager 1625 is capable of, configured to, or operable to support a means for transmitting configuration information that indicates at least one indicator that includes a first indicator that corresponds to a first beam. The data manager 1630 is capable of, configured to, or operable to support a means for obtaining, from a UE, at least one of first data for training of an AI model for beam prediction or second data for training of the AI model for beam prediction, where the first data is based on the first beam that corresponds to the first indicator, and where the second data is obtained based on a second indicator that corresponds to a second beam.

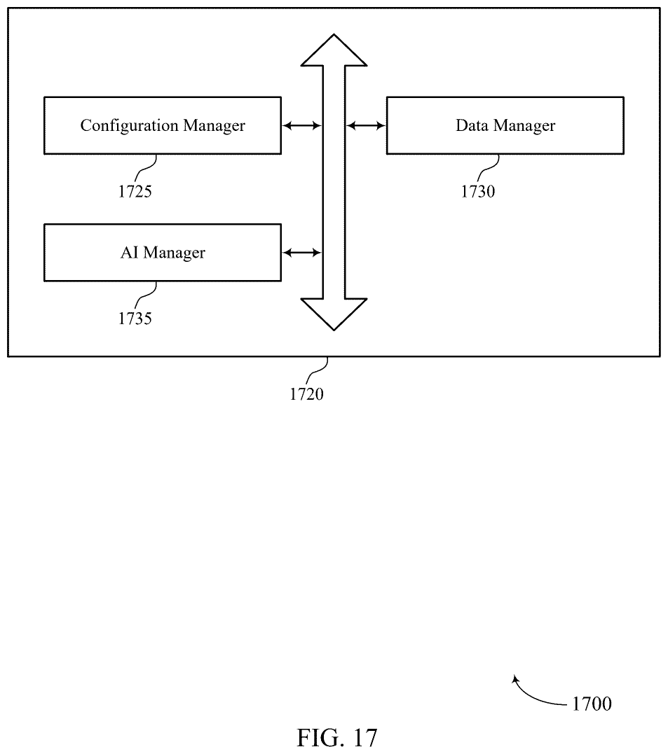

FIG. 17 shows a block diagram 1700 of a communications manager 1720 that supports collection of data for training of AI models for beam prediction in accordance with one or more aspects of the present disclosure. The communications manager 1720 may be an example of aspects of a communications manager 1520, a communications manager 1620, or both, as described herein. The communications manager 1720, or various components thereof, may be an example of means for performing various aspects of data for training of AI models for beam prediction as described herein. For example, the communications manager 1720 may include a configuration manager 1725, a data manager 1730, an AI manager 1735, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1720 may support wireless communications in accordance with examples as disclosed herein. The configuration manager 1725 is capable of, configured to, or operable to support a means for transmitting configuration information that indicates a threshold distance from a first location at which a UE stores first data for training of an AI model for beam prediction. The data manager 1730 is capable of, configured to, or operable to support a means for obtaining, from the UE, at least one of the first data associated with the first location or second data for training of the AI model associated with a second location, where the second data is obtained based on whether a distance between the first location and the second location satisfies the threshold distance.

In some examples, the second data is not obtained based on the distance between the first location and the second location failing to satisfy the threshold distance.

In some examples, the second data is obtained based on one or more distances between the first location and at least one second distance that satisfies the threshold distance.

In some examples, the second data is obtained based on a trajectory of the UE, the distance between the first location and the second location, or a quantity of occasions to receive reference signals.

In some examples, the AI manager 1735 is capable of, configured to, or operable to support a means for training the AI model based on at least one of the first data associated with the first location or the second data associated with the second location.

Additionally, or alternatively, the communications manager 1720 may support wireless communications in accordance with examples as disclosed herein. In some examples, the configuration manager 1725 is capable of, configured to, or operable to support a means for transmitting configuration information that indicates at least one indicator that includes a first indicator that corresponds to a first beam. In some examples, the data manager 1730 is capable of, configured to, or operable to support a means for obtaining, from a UE, at least one of first data for training of an AI model for beam prediction or second data for training of the AI model for beam prediction, where the first data is based on the first beam that corresponds to the first indicator, and where the second data is obtained based on a second indicator that corresponds to a second beam.

In some examples, the configuration information further indicates at least one indicator, a periodicity for sample collection, and at least one quantity of samples for collection. In some examples, the first data is obtained based on whether the first indicator corresponds to the at least one indicator and whether a first occasion to collect the first data corresponds to the periodicity for sample collection. In some examples, a first quantity of samples of the first data is limited to the at least one quantity of samples for collection.

In some examples, the second data is not obtained when the second indicator does not correspond to the at least one indicator or a second occasion to collect the second data does not correspond to the periodicity.

In some examples, the second data is obtained based on whether the second indicator corresponds to the at least one indicator and whether a second occasion to collect the second data corresponds to the periodicity for sample collection. In some examples, the second data is limited to a different quantity of samples than the first data.

In some examples, the first indicator indicates a rank of the first beam in an order of beams based on a first measurement of the first beam.

In some examples, the second data is obtained for a second occasion based on a change to a highest rank of the order of beams. In some examples, a rank of the second indicator that corresponds to the second beam changes to the highest rank of the order of beams from the rank of the first indicator that corresponds to the first beam.

In some examples, the second data is obtained for a second occasion based on a change to a highest rank of the order of beams and a satisfaction of a threshold quantity of samples. In some examples, the highest rank of the order of beams changes from the first indicator that corresponds to the first beam to the second indicator that corresponds to the second beam for at least the threshold quantity of samples.

In some examples, the first data for a first occasion is obtained based on a last sample of the first beam before a change to a highest rank of the order of beams.

In some examples, the first data for a first occasion is obtained based on a last sample of the first beam before a change to a highest rank of the order of beams, and the second data for a second occasion is obtained based on an initial sample of the second beam after the change to the highest rank of the order of beams.

In some examples, the second data is not obtained based on no change to a set of highest ranks that includes the rank of the first beam in the order of beams.

In some examples, the second data is not obtained based on a change that is less than a rank threshold change to, or no change to, one or more highest ranks or less than a measurement threshold change to one or more measurements of one or more respective beams.

In some examples, the configuration information indicates one or more first conditions to report data for training of the AI model associated with a first set of beams, and indicates one or more second conditions to report data for training of the AI model associated with a second set of beams.

In some examples, the configuration information indicates one or more conditions to report data for training of the AI model associated with a first set of beams and a second set of beams.

In some examples, the configuration information indicates one or more first conditions to report the first data for training of the AI model associated with the first indicator that corresponds to the first beam, and indicates one or more second conditions to report the second data for training of the AI model associated with the second indicator that corresponds to the second beam.

In some examples, the configuration information indicates one or more conditions to report data for training of the AI model associated with one or more beams or one or more sets of beams, and indicates one or more indicators associated with the one or more beams or the one or more sets of beams.

In some examples, the AI manager 1735 is capable of, configured to, or operable to support a means for training the AI model based on at least one of the first data or the second data.

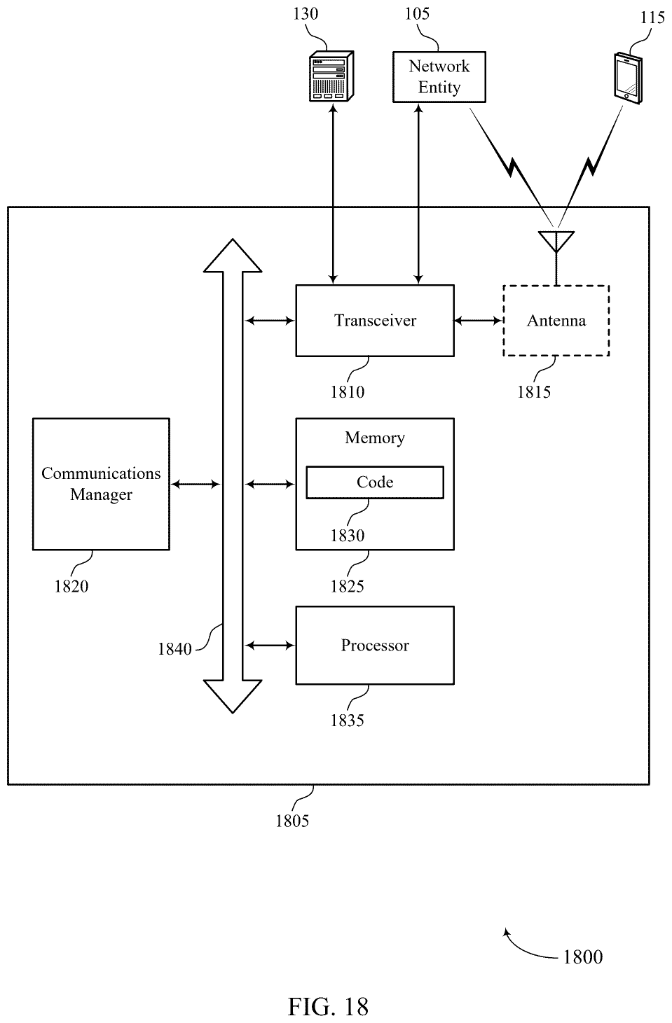

FIG. 18 shows a diagram of a system 1800 including a device 1805 that supports collection of data for training of AI models for beam prediction in accordance with one or more aspects of the present disclosure. The device 1805 may be an example of or include components of a device 1505, a device 1605, or a network entity 105 as described herein. The device 1805 may communicate with other network devices or network equipment such as one or more of the network entities 105, UEs 115, or any combination thereof. The communications may include communications over one or more wired interfaces, over one or more wireless interfaces, or any combination thereof. The device 1805 may include components that support outputting and obtaining communications, such as a communications manager 1820, a transceiver 1810, one or more antennas 1815, at least one memory 1825, code 1830, and at least one processor 1835. These components may be in electronic communication or otherwise coupled (e.g., operatively, communicatively, functionally, electronically, electrically) via one or more buses (e.g., a bus 1840).

The transceiver 1810 may support bi-directional communications via wired links, wireless links, or both as described herein. In some examples, the transceiver 1810 may include a wired transceiver and may communicate bi-directionally with another wired transceiver. Additionally, or alternatively, in some examples, the transceiver 1810 may include a wireless transceiver and may communicate bi-directionally with another wireless transceiver. In some examples, the device 1805 may include one or more antennas 1815, which may be capable of transmitting or receiving wireless transmissions (e.g., concurrently). The transceiver 1810 may also include a modem to modulate signals, to provide the modulated signals for transmission (e.g., by one or more antennas 1815, by a wired transmitter), to receive modulated signals (e.g., from one or more antennas 1815, from a wired receiver), and to demodulate signals. In some implementations, the transceiver 1810 may include one or more interfaces, such as one or more interfaces coupled with the one or more antennas 1815 that are configured to support various receiving or obtaining operations, or one or more interfaces coupled with the one or more antennas 1815 that are configured to support various transmitting or outputting operations, or a combination thereof. In some implementations, the transceiver 1810 may include or be configured for coupling with one or more processors or one or more memory components that are operable to perform or support operations based on received or obtained information or signals, or to generate information or other signals for transmission or other outputting, or any combination thereof. In some implementations, the transceiver 1810, or the transceiver 1810 and the one or more antennas 1815, or the transceiver 1810 and the one or more antennas 1815 and one or more processors or one or more memory components (e.g., the at least one processor 1835, the at least one memory 1825, or both), may be included in a chip or chip assembly that is installed in the device 1805. In some examples, the transceiver 1810 may be operable to support communications via one or more communications links (e.g., communication link(s) 125, backhaul communication link(s) 120, a midhaul communication link 162, a fronthaul communication link 168).

The at least one memory 1825 may include RAM, ROM, or any combination thereof. The at least one memory 1825 may store computer-readable, computer-executable, or processor-executable code, such as the code 1830. The code 1830 may include instructions that, when executed by one or more of the at least one processor 1835, cause the device 1805 to perform various functions described herein. The code 1830 may be stored in a non-transitory computer-readable medium such as system memory or another type of memory. In some cases, the code 1830 may not be directly executable by a processor of the at least one processor 1835 but may cause a computer (e.g., when compiled and executed) to perform functions described herein. In some cases, the at least one memory 1825 may include, among other things, a BIOS which may control basic hardware or software operation such as the interaction with peripheral components or devices. In some examples, the at least one processor 1835 may include multiple processors and the at least one memory 1825 may include multiple memories. One or more of the multiple processors may be coupled with one or more of the multiple memories which may, individually or collectively, be configured to perform various functions herein (for example, as part of a processing system).

The at least one processor 1835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1835 may be configured to operate a memory array using a memory controller. In some other cases, a memory controller may be integrated into one or more of the at least one processor 1835. The at least one processor 1835 may be configured to execute computer-readable instructions stored in a memory (e.g., one or more of the at least one memory 1825) to cause the device 1805 to perform various functions (e.g., functions or tasks supporting data for training of AI models for beam prediction). For example, the device 1805 or a component of the device 1805 may include at least one processor 1835 and at least one memory 1825 coupled with one or more of the at least one processor 1835, the at least one processor 1835 and the at least one memory 1825 configured to perform various functions described herein. The at least one processor 1835 may be an example of a cloud-computing platform (e.g., one or more physical nodes and supporting software such as operating systems, virtual machines, or container instances) that may host the functions (e.g., by executing code 1830) to perform the functions of the device 1805. The at least one processor 1835 may be any one or more suitable processors capable of executing scripts or instructions of one or more software programs stored in the device 1805 (such as within one or more of the at least one memory 1825).

In some examples, the at least one processor 1835 may include multiple processors and the at least one memory 1825 may include multiple memories. One or more of the multiple processors may be coupled with one or more of the multiple memories, which may, individually or collectively, be configured to perform various functions herein. In some examples, the at least one processor 1835 may be a component of a processing system, which may refer to a system (such as a series) of machines, circuitry (including, for example, one or both of processor circuitry (which may include the at least one processor 1835) and memory circuitry (which may include the at least one memory 1825)), or components, that receives or obtains inputs and processes the inputs to produce, generate, or obtain a set of outputs. The processing system may be configured to perform one or more of the functions described herein. For example, the at least one processor 1835 or a processing system including the at least one processor 1835 may be configured to, configurable to, or operable to cause the device 1805 to perform one or more of the functions described herein. Further, as described herein, being “configured to,” being “configurable to,” and being “operable to” may be used interchangeably and may be associated with a capability, when executing code stored in the at least one memory 1825 or otherwise, to perform one or more of the functions described herein.

In some examples, a bus 1840 may support communications of (e.g., within) a protocol layer of a protocol stack. In some examples, a bus 1840 may support communications associated with a logical channel of a protocol stack (e.g., between protocol layers of a protocol stack), which may include communications performed within a component of the device 1805, or between different components of the device 1805 that may be co-located or located in different locations (e.g., where the device 1805 may refer to a system in which one or more of the communications manager 1820, the transceiver 1810, the at least one memory 1825, the code 1830, and the at least one processor 1835 may be located in one of the different components or divided between different components).

In some examples, the communications manager 1820 may manage aspects of communications with a core network 130 (e.g., via one or more wired or wireless backhaul links). For example, the communications manager 1820 may manage the transfer of data communications for client devices, such as one or more UEs 115. In some examples, the communications manager 1820 may manage communications with one or more other network entities 105, and may include a controller or scheduler for controlling communications with UEs 115 (e.g., in cooperation with the one or more other network devices). In some examples, the communications manager 1820 may support an X2 interface within an LTE/LTE-A wireless communications network technology to provide communication between network entities 105.

The communications manager 1820 may support wireless communications in accordance with examples as disclosed herein. For example, the communications manager 1820 is capable of, configured to, or operable to support a means for transmitting configuration information that indicates a threshold distance from a first location at which a UE stores first data for training of an AI model for beam prediction. The communications manager 1820 is capable of, configured to, or operable to support a means for obtaining, from the UE, at least one of the first data associated with the first location or second data for training of the AI model associated with a second location, where the second data is obtained based on whether a distance between the first location and the second location satisfies the threshold distance.

Additionally, or alternatively, the communications manager 1820 may support wireless communications in accordance with examples as disclosed herein. For example, the communications manager 1820 is capable of, configured to, or operable to support a means for transmitting configuration information that indicates at least one indicator that includes a first indicator that corresponds to a first beam. The communications manager 1820 is capable of, configured to, or operable to support a means for obtaining, from a UE, at least one of first data for training of an AI model for beam prediction or second data for training of the AI model for beam prediction, where the first data is based on the first beam that corresponds to the first indicator, and where the second data is obtained based on a second indicator that corresponds to a second beam.

By including or configuring the communications manager 1820 in accordance with examples as described herein, the device 1805 may support techniques for improved communication reliability, reduced latency, reduced power consumption, more efficient utilization of communication resources, improved coordination between devices, longer battery life, or improved utilization of processing capability.

In some examples, the communications manager 1820 may be configured to perform various operations (e.g., receiving, obtaining, monitoring, outputting, transmitting) using or otherwise in cooperation with the transceiver 1810, the one or more antennas 1815 (e.g., where applicable), or any combination thereof. Although the communications manager 1820 is illustrated as a separate component, in some examples, one or more functions described with reference to the communications manager 1820 may be supported by or performed by the transceiver 1810, one or more of the at least one processor 1835, one or more of the at least one memory 1825, the code 1830, or any combination thereof (for example, by a processing system including at least a portion of the at least one processor 1835, the at least one memory 1825, the code 1830, or any combination thereof). For example, the code 1830 may include instructions executable by one or more of the at least one processor 1835 to cause the device 1805 to perform various aspects of data for training of AI models for beam prediction as described herein, or the at least one processor 1835 and the at least one memory 1825 may be otherwise configured to, individually or collectively, perform or support such operations.

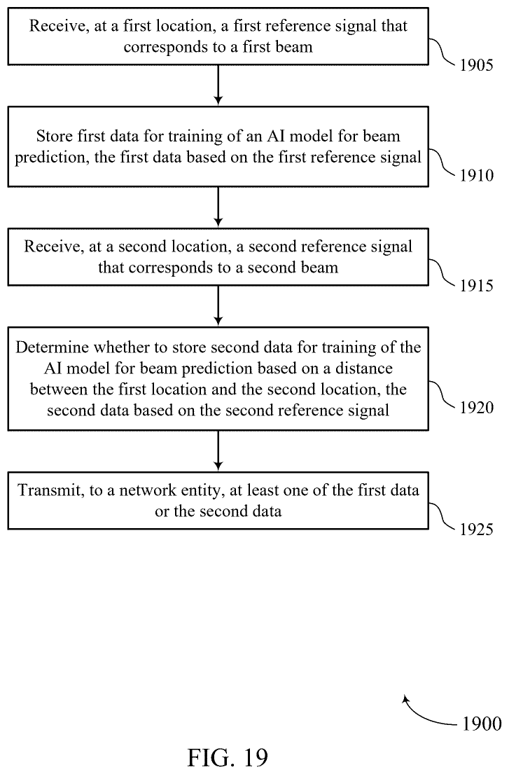

FIG. 19 shows a flowchart illustrating a method 1900 that supports collection of data for training of AI models for beam prediction in accordance with one or more aspects of the present disclosure. The operations of the method 1900 may be implemented by a UE or its components as described herein. For example, the operations of the method 1900 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1905, the method may include receiving, at a first location, a first reference signal that corresponds to a first beam. The operations of 1905 may be performed in accordance with examples as disclosed herein. In some examples, aspects of the operations of 1905 may be performed by a reference signal component 1325 as described with reference to FIG. 13.

At 1910, the method may include storing first data for training of an AI model for beam prediction, the first data based on the first reference signal. The operations of 1910 may be performed in accordance with examples as disclosed herein. In some examples, aspects of the operations of 1910 may be performed by a storage component 1330 as described with reference to FIG. 13.

At 1915, the method may include receiving, at a second location, a second reference signal that corresponds to a second beam. The operations of 1915 may be performed in accordance with examples as disclosed herein. In some examples, aspects of the operations of 1915 may be performed by a reference signal component 1325 as described with reference to FIG. 13.

At 1920, the method may include determine whether to store second data for training of the AI model for beam prediction based on a distance between the first location and the second location, the second data based on the second reference signal. The operations of 1920 may be performed in accordance with examples as disclosed herein. In some examples, aspects of the operations of 1920 may be performed by a storage component 1330 as described with reference to FIG. 13.

At 1925, the method may include transmitting, to a network entity, at least one of the first data or the second data. The operations of 1925 may be performed in accordance with examples as disclosed herein. In some examples, aspects of the operations of 1925 may be performed by a data component 1335 as described with reference to FIG. 13.

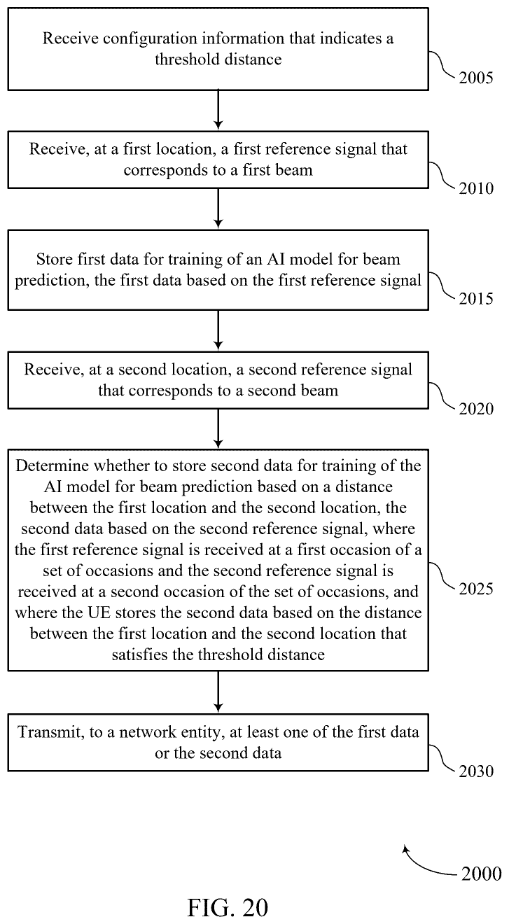

FIG. 20 shows a flowchart illustrating a method 2000 that supports collection of data for training of AI models for beam prediction in accordance with one or more aspects of the present disclosure. The operations of the method 2000 may be implemented by a UE or its components as described herein. For example, the operations of the method 2000 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 2005, the method may include receiving configuration information that indicates a threshold distance. The operations of 2005 may be performed in accordance with examples as disclosed herein. In some examples, aspects of the operations of 2005 may be performed by a configuration component 1340 as described with reference to FIG. 13.

At 2010, the method may include receiving, at a first location, a first reference signal that corresponds to a first beam. The operations of 2010 may be performed in accordance with examples as disclosed herein. In some examples, aspects of the operations of 2010 may be performed by a reference signal component 1325 as described with reference to FIG. 13.

At 2015, the method may include storing first data for training of an AI model for beam prediction, the first data based on the first reference signal. The operations of 2015 may be performed in accordance with examples as disclosed herein. In some examples, aspects of the operations of 2015 may be performed by a storage component 1330 as described with reference to FIG. 13.

At 2020, the method may include receiving, at a second location, a second reference signal that corresponds to a second beam. The operations of 2020 may be performed in accordance with examples as disclosed herein. In some examples, aspects of the operations of 2020 may be performed by a reference signal component 1325 as described with reference to FIG. 13.

At 2025, the method may include determine whether to store second data for training of the AI model for beam prediction based on a distance between the first location and the second location, the second data based on the second reference signal, where the first reference signal is received at a first occasion of a set of occasions and the second reference signal is received at a second occasion of the set of occasions, and where the UE stores the second data based on the distance between the first location and the second location that satisfies the threshold distance. The operations of 2025 may be performed in accordance with examples as disclosed herein. In some examples, aspects of the operations of 2025 may be performed by a storage component 1330 as described with reference to FIG. 13.

At 2030, the method may include transmitting, to a network entity, at least one of the first data or the second data. The operations of 2030 may be performed in accordance with examples as disclosed herein. In some examples, aspects of the operations of 2030 may be performed by a data component 1335 as described with reference to FIG. 13.

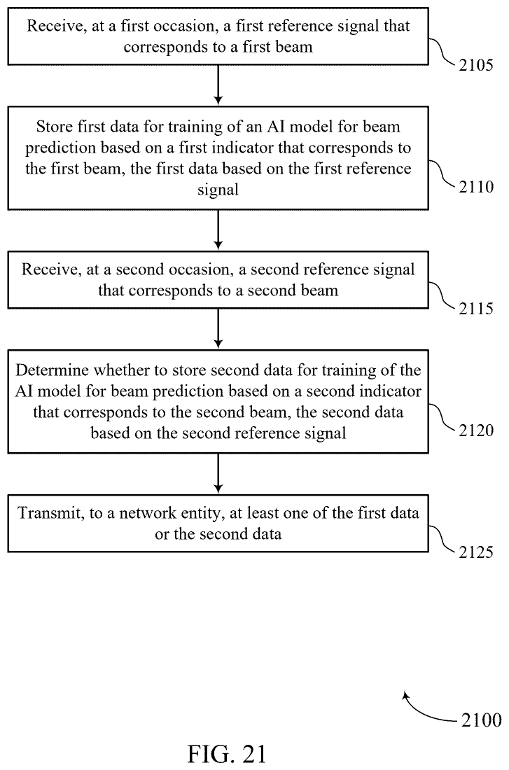

FIG. 21 shows a flowchart illustrating a method 2100 that supports collection of data for training of AI models for beam prediction in accordance with one or more aspects of the present disclosure. The operations of the method 2100 may be implemented by a UE or its components as described herein. For example, the operations of the method 2100 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 2105, the method may include receiving, at a first occasion, a first reference signal that corresponds to a first beam. The operations of 2105 may be performed in accordance with examples as disclosed herein. In some examples, aspects of the operations of 2105 may be performed by a reference signal component 1325 as described with reference to FIG. 13.

At 2110, the method may include storing first data for training of an AI model for beam prediction based on a first indicator that corresponds to the first beam, the first data based on the first reference signal. The operations of 2110 may be performed in accordance with examples as disclosed herein. In some examples, aspects of the operations of 2110 may be performed by a storage component 1330 as described with reference to FIG. 13.

At 2115, the method may include receiving, at a second occasion, a second reference signal that corresponds to a second beam. The operations of 2115 may be performed in accordance with examples as disclosed herein. In some examples, aspects of the operations of 2115 may be performed by a reference signal component 1325 as described with reference to FIG. 13.

At 2120, the method may include determining whether to store second data for training of the AI model for beam prediction based on a second indicator that corresponds to the second beam, the second data based on the second reference signal. The operations of 2120 may be performed in accordance with examples as disclosed herein. In some examples, aspects of the operations of 2120 may be performed by a storage component 1330 as described with reference to FIG. 13.

At 2125, the method may include transmitting, to a network entity, at least one of the first data or the second data. The operations of 2125 may be performed in accordance with examples as disclosed herein. In some examples, aspects of the operations of 2125 may be performed by a data component 1335 as described with reference to FIG. 13.

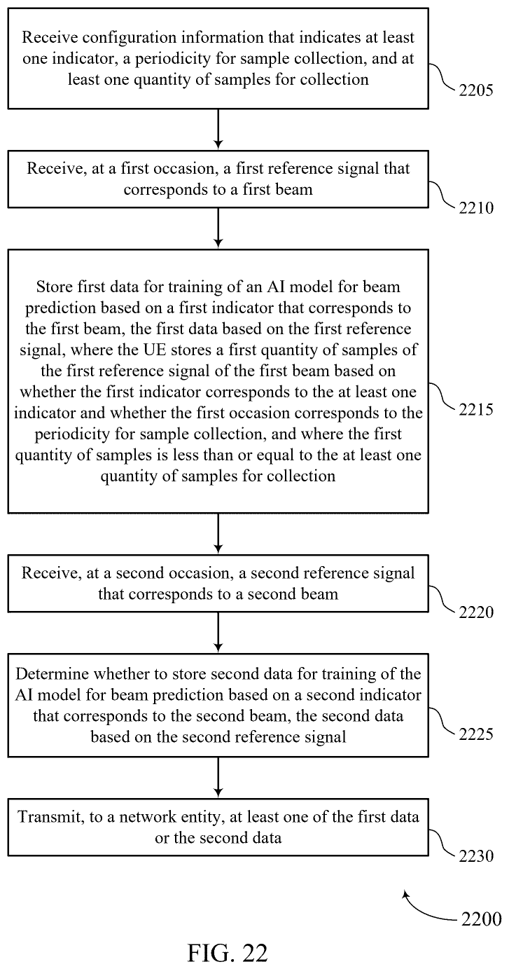

FIG. 22 shows a flowchart illustrating a method 2200 that supports collection of data for training of AI models for beam prediction in accordance with one or more aspects of the present disclosure. The operations of the method 2200 may be implemented by a UE or its components as described herein. For example, the operations of the method 2200 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 2205, the method may include receiving configuration information that indicates at least one indicator, a periodicity for sample collection, and at least one quantity of samples for collection. The operations of 2205 may be performed in accordance with examples as disclosed herein. In some examples, aspects of the operations of 2205 may be performed by a configuration component 1340 as described with reference to FIG. 13.

At 2210, the method may include receiving, at a first occasion, a first reference signal that corresponds to a first beam. The operations of 2210 may be performed in accordance with examples as disclosed herein. In some examples, aspects of the operations of 2210 may be performed by a reference signal component 1325 as described with reference to FIG. 13.

At 2215, the method may include storing first data for training of an AI model for beam prediction based on a first indicator that corresponds to the first beam, the first data based on the first reference signal, where the UE stores a first quantity of samples of the first reference signal of the first beam based on whether the first indicator corresponds to the at least one indicator and whether the first occasion corresponds to the periodicity for sample collection, and where the first quantity of samples is less than or equal to the at least one quantity of samples for collection. The operations of 2215 may be performed in accordance with examples as disclosed herein. In some examples, aspects of the operations of 2215 may be performed by a storage component 1330 as described with reference to FIG. 13.

At 2220, the method may include receiving, at a second occasion, a second reference signal that corresponds to a second beam. The operations of 2220 may be performed in accordance with examples as disclosed herein. In some examples, aspects of the operations of 2220 may be performed by a reference signal component 1325 as described with reference to FIG. 13.

At 2225, the method may include determining whether to store second data for training of the AI model for beam prediction based on a second indicator that corresponds to the second beam, the second data based on the second reference signal. The operations of 2225 may be performed in accordance with examples as disclosed herein. In some examples, aspects of the operations of 2225 may be performed by a storage component 1330 as described with reference to FIG. 13.

At 2230, the method may include transmitting, to a network entity, at least one of the first data or the second data. The operations of 2230 may be performed in accordance with examples as disclosed herein. In some examples, aspects of the operations of 2230 may be performed by a data component 1335 as described with reference to FIG. 13.

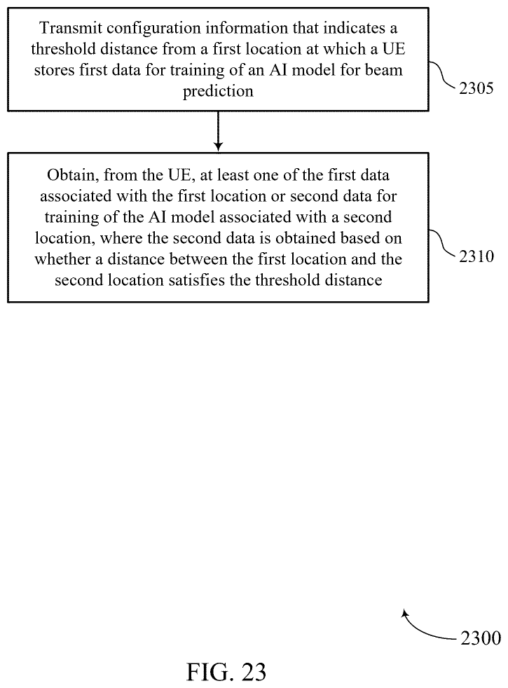

FIG. 23 shows a flowchart illustrating a method 2300 that supports collection of data for training of AI models for beam prediction in accordance with one or more aspects of the present disclosure. The operations of the method 2300 may be implemented by a network entity or its components as described herein. For example, the operations of the method 2300 may be performed by a network entity as described with reference to FIGS. 1 through 10 and 15 through 18. In some examples, a network entity may execute a set of instructions to control the functional elements of the network entity to perform the described functions. Additionally, or alternatively, the network entity may perform aspects of the described functions using special-purpose hardware.

At 2305, the method may include transmitting configuration information that indicates a threshold distance from a first location at which a UE stores first data for training of an AI model for beam prediction. The operations of 2305 may be performed in accordance with examples as disclosed herein. In some examples, aspects of the operations of 2305 may be performed by a configuration manager 1725 as described with reference to FIG. 17.

At 2310, the method may include obtaining, from the UE, at least one of the first data associated with the first location or second data for training of the AI model associated with a second location, where the second data is obtained based on whether a distance between the first location and the second location satisfies the threshold distance. The operations of 2310 may be performed in accordance with examples as disclosed herein. In some examples, aspects of the operations of 2310 may be performed by a data manager 1730 as described with reference to FIG. 17.

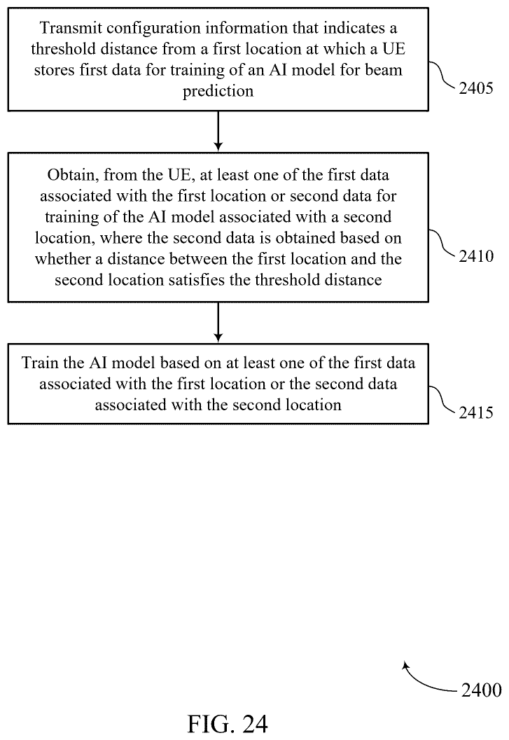

FIG. 24 shows a flowchart illustrating a method 2400 that supports collection of data for training of AI models for beam prediction in accordance with one or more aspects of the present disclosure. The operations of the method 2400 may be implemented by a network entity or its components as described herein. For example, the operations of the method 2400 may be performed by a network entity as described with reference to FIGS. 1 through 10 and 15 through 18. In some examples, a network entity may execute a set of instructions to control the functional elements of the network entity to perform the described functions. Additionally, or alternatively, the network entity may perform aspects of the described functions using special-purpose hardware.

At 2405, the method may include transmitting configuration information that indicates a threshold distance from a first location at which a UE stores first data for training of an AI model for beam prediction. The operations of 2405 may be performed in accordance with examples as disclosed herein. In some examples, aspects of the operations of 2405 may be performed by a configuration manager 1725 as described with reference to FIG. 17.

At 2410, the method may include obtaining, from the UE, at least one of the first data associated with the first location or second data for training of the AI model associated with a second location, where the second data is obtained based on whether a distance between the first location and the second location satisfies the threshold distance. The operations of 2410 may be performed in accordance with examples as disclosed herein. In some examples, aspects of the operations of 2410 may be performed by a data manager 1730 as described with reference to FIG. 17.

At 2415, the method may include training the AI model based on at least one of the first data associated with the first location or the second data associated with the second location. The operations of 2415 may be performed in accordance with examples as disclosed herein. In some examples, aspects of the operations of 2415 may be performed by an AI manager 1735 as described with reference to FIG. 17.

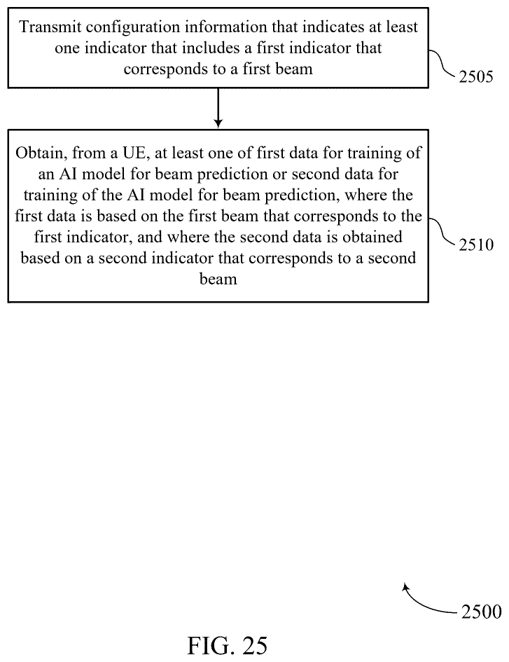

FIG. 25 shows a flowchart illustrating a method 2500 that supports collection of data for training of AI models for beam prediction in accordance with one or more aspects of the present disclosure. The operations of the method 2500 may be implemented by a network entity or its components as described herein. For example, the operations of the method 2500 may be performed by a network entity as described with reference to FIGS. 1 through 10 and 15 through 18. In some examples, a network entity may execute a set of instructions to control the functional elements of the network entity to perform the described functions. Additionally, or alternatively, the network entity may perform aspects of the described functions using special-purpose hardware.

At 2505, the method may include transmitting configuration information that indicates at least one indicator that includes a first indicator that corresponds to a first beam. The operations of 2505 may be performed in accordance with examples as disclosed herein. In some examples, aspects of the operations of 2505 may be performed by a configuration manager 1725 as described with reference to FIG. 17.

At 2510, the method may include obtaining, from a UE, at least one of first data for training of an AI model for beam prediction or second data for training of the AI model for beam prediction, where the first data is based on the first beam that corresponds to the first indicator, and where the second data is obtained based on a second indicator that corresponds to a second beam. The operations of 2510 may be performed in accordance with examples as disclosed herein. In some examples, aspects of the operations of 2510 may be performed by a data manager 1730 as described with reference to FIG. 17.

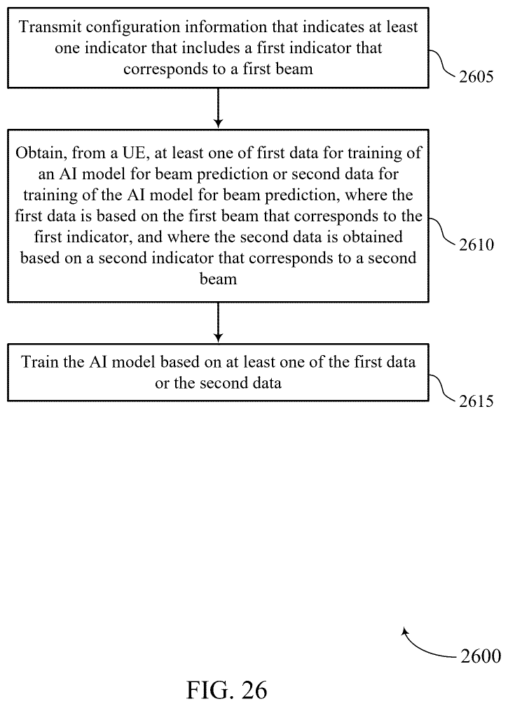

FIG. 26 shows a flowchart illustrating a method 2600 that supports collection of data for training of AI models for beam prediction in accordance with one or more aspects of the present disclosure. The operations of the method 2600 may be implemented by a network entity or its components as described herein. For example, the operations of the method 2600 may be performed by a network entity as described with reference to FIGS. 1 through 10 and 15 through 18. In some examples, a network entity may execute a set of instructions to control the functional elements of the network entity to perform the described functions. Additionally, or alternatively, the network entity may perform aspects of the described functions using special-purpose hardware.

At 2605, the method may include transmitting configuration information that indicates at least one indicator that includes a first indicator that corresponds to a first beam. The operations of 2605 may be performed in accordance with examples as disclosed herein. In some examples, aspects of the operations of 2605 may be performed by a configuration manager 1725 as described with reference to FIG. 17.

At 2610, the method may include obtaining, from a UE, at least one of first data for training of an AI model for beam prediction or second data for training of the AI model for beam prediction, where the first data is based on the first beam that corresponds to the first indicator, and where the second data is obtained based on a second indicator that corresponds to a second beam. The operations of 2610 may be performed in accordance with examples as disclosed herein. In some examples, aspects of the operations of 2610 may be performed by a data manager 1730 as described with reference to FIG. 17.

At 2615, the method may include training the AI model based on at least one of the first data or the second data. The operations of 2615 may be performed in accordance with examples as disclosed herein. In some examples, aspects of the operations of 2615 may be performed by an AI manager 1735 as described with reference to FIG. 17.

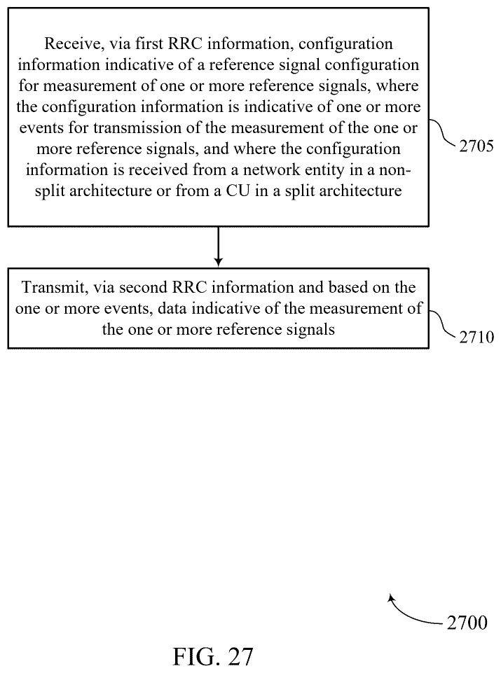

FIG. 27 shows a flowchart illustrating a method 2700 that supports data collection or reporting in accordance with one or more aspects of the present disclosure. The operations of the method 2700 may be implemented by a UE or its components as described herein. For example, the operations of the method 2700 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 2705, the method may include receiving, via first RRC information, configuration information indicative of a reference signal configuration for measurement of one or more reference signals, where the configuration information is indicative of one or more events for transmission of the measurement of the one or more reference signals, and where the configuration information is received from a network entity in a non-split architecture or from a CU in a split architecture. In some examples, aspects of the operations of 2705 may be performed by a configuration component 1340. In some examples, the configuration information may be communicated as described with reference to FIG. 3. For instance, a reference signal configuration may be configured via RRC signaling, where a network entity (e.g., gNB in a non-split architecture or a CU in a split architecture) may configure events for data collection and/or reporting.

At 2710, the method may include transmitting, via second RRC information and based on the one or more events, data indicative of the measurement of the one or more reference signals. In some examples, aspects of the operations of 2710 may be performed by a data component 1335. In some examples, the data may be communicated as described with reference to FIG. 3. For instance, a UE may report the data using RRC signaling based on the event(s) for data collection and/or reporting.

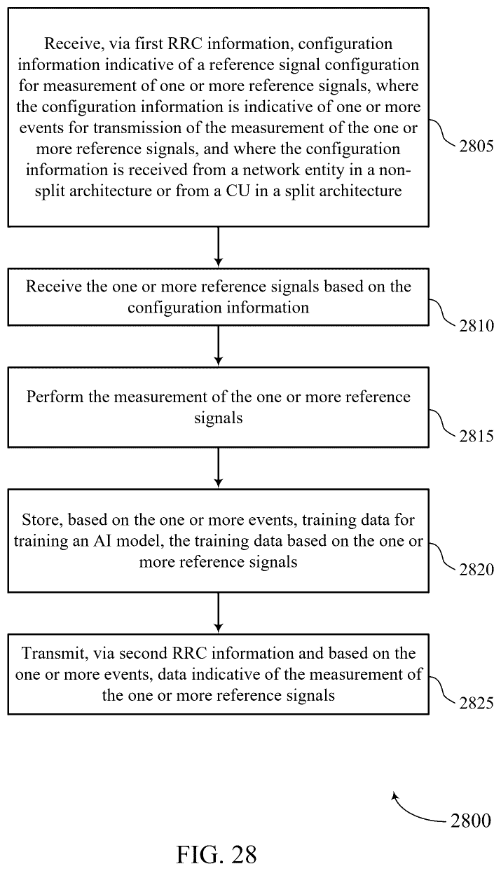

FIG. 28 shows a flowchart illustrating a method 2800 that supports data collection or reporting in accordance with one or more aspects of the present disclosure. The operations of the method 2800 may be implemented by a UE or its components as described herein. For example, the operations of the method 2800 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 2805, the method may include receiving, via first RRC information, configuration information indicative of a reference signal configuration for measurement of one or more reference signals, where the configuration information is indicative of one or more events for transmission of the measurement of the one or more reference signals, and where the configuration information is received from a network entity in a non-split architecture or from a CU in a split architecture. In some examples, aspects of the operations of 2805 may be performed by a configuration component 1340. In some examples, the configuration information may be communicated as described with reference to FIG. 3. For instance, a reference signal configuration may be configured via RRC signaling, where a network entity (e.g., gNB in a non-split architecture or a CU in a split architecture) may configure events for data collection and/or reporting.

At 2810, the method may include receiving the one or more reference signals based on the configuration information. In some examples, aspects of the operations of 2810 may be performed by a reference signal component 1325. In some examples, the one or more reference signals may be received as described with reference to FIG. 3. For instance, the UE receives reference signals based on the configuration information for measurement purposes.

At 2815, the method may include performing the measurement of the one or more reference signals. The measurement may be stored based on the one or more events. In some examples, aspects of the operations of 2815 may be performed by a reference signal component 1325. In some examples, measuring the one or more reference signals may be performed as described with reference to FIG. 3. For instance, the UE measures the reference signal(s) to obtain data.

At 2820, the method may include storing, based on the one or more events, training data for training an AI model, the training data based on the one or more reference signals. In some examples, aspects of the operations of 2820 may be performed by a storage component 1330. In some examples, the training data may be stored as described with reference to FIG. 3. For instance, samples and/or measurements based on reference signals may be stored in memory for AI model training, where the UE stores the data based on configured events.

At 2825, the method may include transmitting, via second RRC information and based on the one or more events, data indicative of the measurement of the one or more reference signals. In some examples, aspects of the operations of 2825 may be performed by a data component 1335. In some examples, the data may be communicated as described with reference to FIG. 3. For instance, a UE may report the data using RRC signaling based on the event(s) for data collection and/or reporting.

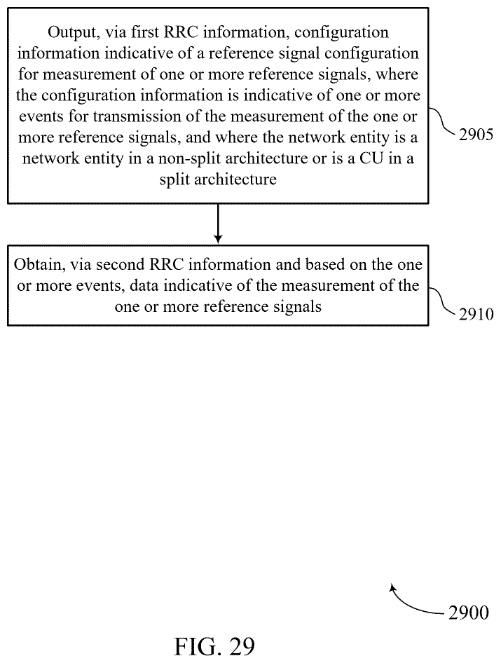

FIG. 29 shows a flowchart illustrating a method 2900 that supports data collection or reporting in accordance with one or more aspects of the present disclosure. The operations of the method 2900 may be implemented by a network entity or its components as described herein. For example, the operations of the method 2900 may be performed by a network entity as described with reference to FIGS. 1 through 10 and 15 through 18. In some examples, a network entity may execute a set of instructions to control the functional elements of the network entity to perform the described functions. Additionally, or alternatively, the network entity may perform aspects of the described functions using special-purpose hardware.

At 2905, the method may include outputting, via first RRC information, configuration information indicative of a reference signal configuration for measurement of one or more reference signals, where the configuration information is indicative of one or more events for transmission of the measurement of the one or more reference signals, and where the network entity is a network entity in a non-split architecture or is a CU in a split architecture. In some examples, aspects of the operations of 2905 may be performed by a configuration manager 1725. In some examples, the configuration information may be communicated as described with reference to FIG. 3. For instance, a reference signal configuration may be configured via RRC signaling, where a network entity (e.g., gNB in a non-split architecture or a CU in a split architecture) may configure events for data collection and/or reporting.

At 2910, the method may include obtaining, via second RRC information and based on the one or more events, data indicative of the measurement of the one or more reference signals. In some examples, aspects of the operations of 2910 may be performed by a data manager 1730. In some examples, the data may be communicated as described with reference to FIG. 3. For instance, a UE may report the data to a network entity using RRC signaling based on the event(s) for data collection and/or reporting.

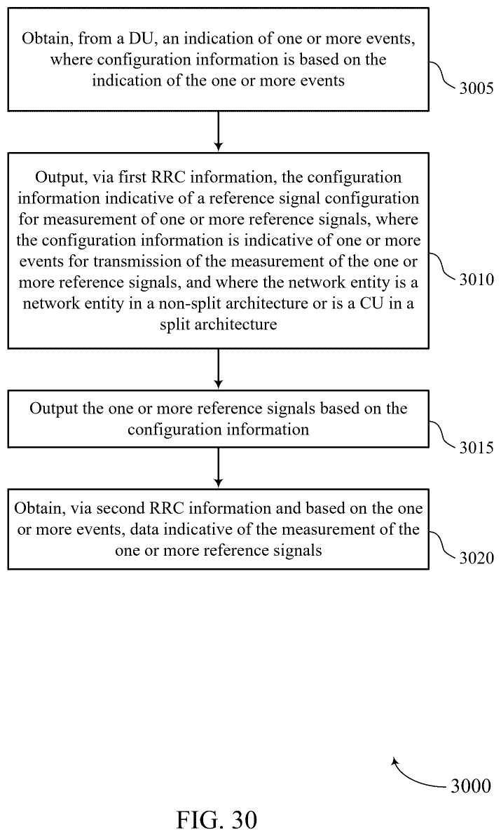

FIG. 30 shows a flowchart illustrating a method 3000 that supports data collection or reporting in accordance with one or more aspects of the present disclosure. The operations of the method 3000 may be implemented by a network entity or its components as described herein. For example, the operations of the method 3000 may be performed by a network entity as described with reference to FIGS. 1 through 10 and 15 through 18. In some examples, a network entity may execute a set of instructions to control the functional elements of the network entity to perform the described functions. Additionally, or alternatively, the network entity may perform aspects of the described functions using special-purpose hardware.

At 3005, the method may include obtaining, from a DU, an indication of one or more events. Configuration information may be based on the indication of the one or more events. In some examples, aspects of the operations of 3005 may be performed by a configuration manager 1725. In some examples, the indication of one or more events may be obtained as described with reference to FIG. 3. For instance, one or more events may be determined by a DU and/or provided to a CU via F1 signaling, where the event information corresponds to configuration information.

At 3010, the method may include outputting, via first RRC information, the configuration information indicative of a reference signal configuration for measurement of one or more reference signals, where the configuration information is indicative of one or more events for transmission of the measurement of the one or more reference signals, and where the network entity is a network entity in a non-split architecture or is a CU in a split architecture. In some examples, aspects of the operations of 3010 may be performed by a configuration manager 1725. In some examples, the configuration information may be communicated as described with reference to FIG. 3. For instance, a reference signal configuration may be configured via RRC signaling, where a network entity (e.g., gNB in a non-split architecture or a CU in a split architecture) may configure events for data collection and/or reporting.

At 3015, the method may include outputting the one or more reference signals based on the configuration information. In some examples, aspects of the operations of 3015 may be performed by a configuration manager 1725. In some examples, the one or more reference signals may be communicated (e.g., output) as described with reference to FIG. 3. For instance, the network entity may output reference signals based on the configuration information for measurement purposes.

At 3020, the method may include obtaining, via second RRC information and based on the one or more events, data indicative of the measurement of the one or more reference signals. In some examples, aspects of the operations of 3020 may be performed by a data manager 1730. In some examples, the data may be communicated as described with reference to FIG. 3. For instance, a UE may report the data to a network entity using RRC signaling based on the event(s) for data collection and/or reporting.

The following provides an overview of aspects of the present disclosure:

Aspect 1: A method for wireless communications by a UE, comprising: receiving, at a first location, a first reference signal that corresponds to a first beam; storing first data for training of an AI model for beam prediction, the first data based at least in part on the first reference signal; receiving, at a second location, a second reference signal that corresponds to a second beam; determine whether to store second data for training of the AI model for beam prediction based at least in part on a distance between the first location and the second location, the second data based at least in part on the second reference signal; and transmitting, to a network entity, at least one of the first data or the second data.

Aspect 2: The method of aspect 1, wherein the UE stores the second data based at least in part on the distance between the first location and the second location that satisfies a threshold distance.

Aspect 3: The method of aspect 1, wherein the UE refrains from storing the second data based at least in part on the distance between the first location and the second location failing to satisfy a threshold distance.

Aspect 4: The method of any of aspects 1 through 2, further comprising: receiving configuration information that indicates a threshold distance, wherein the first reference signal is received at a first occasion of a set of occasions and the second reference signal is received at a second occasion of the set of occasions, and wherein the UE stores the second data based at least in part on the distance between the first location and the second location that satisfies the threshold distance.

Aspect 5: The method of any of aspects 1 through 4, wherein the determination whether to store the second data is based at least in part on a trajectory of the UE, the distance between the first location and the second location, or a quantity of occasions to receive reference signals.

Aspect 6: A method for wireless communications by a UE, comprising: receiving, at a first occasion, a first reference signal that corresponds to a first beam; storing first data for training of an AI model for beam prediction based at least in part on a first indicator that corresponds to the first beam, the first data based at least in part on the first reference signal; receiving, at a second occasion, a second reference signal that corresponds to a second beam; determining whether to store second data for training of the AI model for beam prediction based at least in part on a second indicator that corresponds to the second beam, the second data based at least in part on the second reference signal; and transmitting, to a network entity, at least one of the first data or the second data.

Aspect 7: The method of aspect 6, further comprising: receiving configuration information that indicates at least one indicator, a periodicity for sample collection, and at least one quantity of samples for collection, wherein the UE stores a first quantity of samples of the first reference signal of the first beam based at least in part on whether the first indicator corresponds to the at least one indicator and whether the first occasion corresponds to the periodicity for sample collection, and wherein the first quantity of samples is less than or equal to the at least one quantity of samples for collection.

Aspect 8: The method of aspect 7, further comprising: refraining from storing the second data when the second indicator does not correspond to the at least one indicator or the second occasion does not correspond to the periodicity.

Aspect 9: The method of aspect 7, wherein the UE stores a second quantity of samples of the second reference signal of the second beam based at least in part on whether the second indicator corresponds to the at least one indicator and whether the second occasion corresponds to the periodicity for sample collection, and the second quantity of samples is a different quantity than the first quantity of samples.

Aspect 10: The method of any of aspects 6 through 7, wherein the first indicator indicates a rank of the first beam in an order of beams based at least in part on a first measurement of the first beam, and the second indicator indicates a rank of the second beam in the order of beams based at least in part on a second measurement of the second beam.

Aspect 11: The method of aspect 10, wherein the UE stores the second data for the second occasion based at least in part on a change of the rank of the second indicator to a highest rank of the order of beams, the rank of the second indicator that corresponds to the second beam changes to the highest rank of the order of beams from the rank of the first indicator that corresponds to the first beam.

Aspect 12: The method of any of aspects 10 through 11, wherein the UE stores the second data for the second occasion based at least in part on a change of the rank of the second indicator to a highest rank of the order of beams and a satisfaction of a threshold quantity of samples, the highest rank of the order of beams changes from the first indicator that corresponds to the first beam to the second indicator that corresponds to the second beam for at least the threshold quantity of samples.

Aspect 13: The method of any of aspects 10 through 12, wherein the UE stores the first data for the first occasion based at least in part on a last sample of the first beam before a change of the rank of the second indicator to a highest rank of the order of beams.

Aspect 14: The method of any of aspects 10 through 13, wherein the UE stores the first data for the first occasion based at least in part on a last sample of the first beam before a change to a highest rank of the order of beams, and stores the second data for the second occasion based at least in part on an initial sample of the second beam after the change to the highest rank of the order of beams.

Aspect 15: The method of aspect 10, further comprising: refraining from storing the second data based at least in part on no change to one or more ranks of a set of highest ranks that includes the rank of the first beam in the order of beams.

Aspect 16: The method of any of aspects 10 and 15, further comprising: refraining from storing the second data based at least in part on a change that is less than a rank threshold change to, or no change to, one or more highest ranks, or less than a measurement threshold change to one or more measurements of one or more respective beams.

Aspect 17: The method of any of aspects 6 through 16, further comprising: receiving configuration information, wherein the configuration information indicates one or more first conditions to store data for training of the AI model associated with a first set of beams, and indicates one or more second conditions to store data for training of the AI model associated with a second set of beams.

Aspect 18: The method of any of aspects 6 through 17, further comprising: receiving configuration information, wherein the configuration information indicates one or more conditions to store data for training of the AI model associated with a first set of beams and a second set of beams.

Aspect 19: The method of any of aspects 6 through 18, further comprising: receiving configuration information, wherein the configuration information indicates one or more first conditions to store the first data associated with the first indicator that corresponds to the first beam, and indicates one or more second conditions to store the second data associated with the second indicator that corresponds to the second beam.

Aspect 20: The method of any of aspects 6 through 19, further comprising: receiving configuration information from the network entity, wherein the configuration information indicates one or more conditions to store data for training of the AI model associated with one or more beams or one or more sets of beams, and indicates one or more indicators associated with the one or more beams or the one or more sets of beams.

Aspect 21: A method for wireless communications by a network entity, comprising: transmitting configuration information that indicates a threshold distance from a first location at which a UE stores first data for training of an AI model for beam prediction; and obtaining, from the UE, at least one of the first data associated with the first location or second data for training of the AI model associated with a second location, wherein the second data is obtained based at least in part on whether a distance between the first location and the second location satisfies the threshold distance.

Aspect 22: The method of aspect 21, wherein the second data is not obtained based at least in part on the distance between the first location and the second location failing to satisfy the threshold distance.

Aspect 23: The method of aspect 21, wherein the second data is obtained based at least in part on one or more distances between the first location and at least one second distance that satisfies the threshold distance.

Aspect 24: The method of any of aspects 21 through 22, wherein the second data is obtained based at least in part on a trajectory of the UE, the distance between the first location and the second location, or a quantity of occasions to receive reference signals.

Aspect 25: The method of any of aspects 21 through 24, further comprising: training the AI model based at least in part on at least one of the first data associated with the first location or the second data associated with the second location.

Aspect 26: A method for wireless communications by a network entity, comprising: transmitting configuration information that indicates at least one indicator that includes a first indicator that corresponds to a first beam; and obtaining, from a UE, at least one of first data for training of an AI model for beam prediction or second data for training of the AI model for beam prediction, wherein the first data is based at least in part on the first beam that corresponds to the first indicator, and wherein the second data is obtained based at least in part on a second indicator that corresponds to a second beam.

Aspect 27: The method of aspect 26, wherein the configuration information further indicates at least one indicator, a periodicity for sample collection, and at least one quantity of samples for collection, the first data is obtained based at least in part on whether the first indicator corresponds to the at least one indicator and whether a first occasion to collect the first data corresponds to the periodicity for sample collection, and a first quantity of samples of the first data is limited to the at least one quantity of samples for collection.

Aspect 28: The method of aspect 27, wherein the second data is not obtained when the second indicator does not correspond to the at least one indicator or a second occasion to collect the second data does not correspond to the periodicity.

Aspect 29: The method of aspect 27, wherein the second data is obtained based at least in part on whether the second indicator corresponds to the at least one indicator and whether a second occasion to collect the second data corresponds to the periodicity for sample collection, and the second data is limited to a different quantity of samples than the first data.

Aspect 30: The method of any of aspects 26 through 27, wherein the first indicator indicates a rank of the first beam in an order of beams based at least in part on a first measurement of the first beam.

Aspect 31: The method of aspect 30, wherein the second data is obtained for a second occasion based at least in part on a change to a highest rank of the order of beams, a rank of the second indicator that corresponds to the second beam changes to the highest rank of the order of beams from the rank of the first indicator that corresponds to the first beam.

Aspect 32: The method of any of aspects 30 through 31, wherein the second data is obtained for a second occasion based at least in part on a change to a highest rank of the order of beams and a satisfaction of a threshold quantity of samples, the highest rank of the order of beams changes from the first indicator that corresponds to the first beam to the second indicator that corresponds to the second beam for at least the threshold quantity of samples.

Aspect 33: The method of any of aspects 30 through 32, wherein the first data for a first occasion is obtained based at least in part on a last sample of the first beam before a change to a highest rank of the order of beams.

Aspect 34: The method of any of aspects 30 through 33, wherein the first data for a first occasion is obtained based at least in part on a last sample of the first beam before a change to a highest rank of the order of beams, and the second data for a second occasion is obtained based at least in part on an initial sample of the second beam after the change to the highest rank of the order of beams.

Aspect 35: The method of any of aspect 30, wherein the second data is not obtained based at least in part on no change to one or more ranks of a set of highest ranks that includes the rank of the first beam in the order of beams.

Aspect 36: The method of any of aspects 30 and 35, wherein the second data is not obtained based at least in part on a change that is less than a rank threshold change to, or no change to, to one or more highest ranks or less than a measurement threshold change to one or more measurements of one or more respective beams.

Aspect 37: The method of any of aspects 26 through 36, wherein the configuration information indicates one or more first conditions to report data for training of the AI model associated with a first set of beams, and indicates one or more second conditions to report data for training of the AI model associated with a second set of beams.

Aspect 38: The method of any of aspects 26 through 37, wherein the configuration information indicates one or more conditions to report data for training of the AI model associated with a first set of beams and a second set of beams.

Aspect 39: The method of any of aspects 26 through 38, wherein the configuration information indicates one or more first conditions to report the first data for training of the AI model associated with the first indicator that corresponds to the first beam, and indicates one or more second conditions to report the second data for training of the AI model associated with the second indicator that corresponds to the second beam.

Aspect 40: The method of any of aspects 26 through 39, wherein the configuration information indicates one or more conditions to report data for training of the AI model associated with one or more beams or one or more sets of beams, and indicates one or more indicators associated with the one or more beams or the one or more sets of beams.

Aspect 41: The method of any of aspects 26 through 40, further comprising: training the AI model based at least in part on at least one of the first data or the second data.

Aspect 42: A UE for wireless communications, comprising one or more memories storing processor-executable code, and one or more processors coupled with the one or more memories and individually or collectively operable to execute the code to cause the UE to perform a method of any of aspects 1 through 5.

Aspect 43: A UE for wireless communications, comprising at least one means for performing a method of any of aspects 1 through 5.

Aspect 44: A non-transitory computer-readable medium storing code for wireless communications, the code comprising instructions executable by one or more processors to perform a method of any of aspects 1 through 5.

Aspect 45: A UE for wireless communications, comprising one or more memories storing processor-executable code, and one or more processors coupled with the one or more memories and individually or collectively operable to execute the code to cause the UE to perform a method of any of aspects 6 through 20.

Aspect 46: A UE for wireless communications, comprising at least one means for performing a method of any of aspects 6 through 20.

Aspect 47: A non-transitory computer-readable medium storing code for wireless communications, the code comprising instructions executable by one or more processors to perform a method of any of aspects 6 through 20.

Aspect 48: A network entity for wireless communications, comprising one or more memories storing processor-executable code, and one or more processors coupled with the one or more memories and individually or collectively operable to execute the code to cause the network entity to perform a method of any of aspects 21 through 25.

Aspect 49: A network entity for wireless communications, comprising at least one means for performing a method of any of aspects 21 through 25.

Aspect 50: A non-transitory computer-readable medium storing code for wireless communications, the code comprising instructions executable by one or more processors to perform a method of any of aspects 21 through 25.

Aspect 51: A network entity for wireless communications, comprising one or more memories storing processor-executable code, and one or more processors coupled with the one or more memories and individually or collectively operable to execute the code to cause the network entity to perform a method of any of aspects 26 through 41.

Aspect 52: A network entity for wireless communications, comprising at least one means for performing a method of any of aspects 26 through 41.

Aspect 53: A non-transitory computer-readable medium storing code for wireless communications, the code comprising instructions executable by one or more processors to perform a method of any of aspects 26 through 41.

Aspect 54: A method for wireless communications by a UE, comprising: receiving, via first RRC information, configuration information indicative of a reference signal configuration for measurement of one or more reference signals, wherein the configuration information is indicative of one or more events for transmission of the measurement of the one or more reference signals, and wherein the configuration information is received from a network entity in a non-split architecture or from a CU in a split architecture; and transmitting, via second RRC information and based at least in part on the one or more events, data indicative of the measurement of the one or more reference signals.

Aspect 55: The method of aspect 54, further comprising: receiving the one or more reference signals based at least in part on the configuration information; and performing the measurement of the one or more reference signals, wherein the measurement is stored based at least in part on the one or more events.

Aspect 56: The method of any of aspects 54 through 55, further comprising: storing, based at least in part on the one or more events, training data for training an AI model, the training data based at least in part on the one or more reference signals.

Aspect 57: The method of any of aspects 54 through 56, wherein the one or more events comprise a first event of a serving cell signal that is greater than a first absolute threshold, a second event of a serving cell signal that is less than a second absolute threshold, or a combination thereof.

Aspect 58: The method of any of aspects 54 through 57, wherein the configuration information is indicative of one or more identifiers corresponding to the reference signal configuration.

Aspect 59: The method of any of aspects 54 through 58, wherein the second RRC information comprises L3 measurements or MDT information.

Aspect 60: The method of any of aspects 54 through 59, wherein the reference signal configuration corresponds to one or more sets of beams for measurement.

Aspect 61: A method for wireless communications by a network entity, comprising: outputting, via first RRC information, configuration information indicative of a reference signal configuration for measurement of one or more reference signals, wherein the configuration information is indicative of one or more events for transmission of the measurement of the one or more reference signals, and wherein the network entity is a network entity in a non-split architecture or is a CU in a split architecture; and obtaining, via second RRC information and based at least in part on the one or more events, data indicative of the measurement of the one or more reference signals.

Aspect 62: The method of aspect 61, further comprising: outputting the one or more reference signals based at least in part on the configuration information.

Aspect 63: The method of any of aspects 61 through 62, further comprising: obtaining, from a DU, an indication of the one or more events, wherein the configuration information is based at least in part on the indication of the one or more events.

Aspect 64: The method of aspect 63, wherein the indication of the one or more events is obtained via a midhaul communication link.

Aspect 65: The method of any of aspects 61 through 64, wherein the one or more events comprise a first event of a serving cell signal that is greater than a first absolute threshold, a second event of a serving cell signal that is less than a second absolute threshold, or a combination thereof.

Aspect 66: The method of any of aspects 61 through 65, wherein the configuration information is indicative of one or more identifiers corresponding to the reference signal configuration.

Aspect 67: The method of any of aspects 61 through 66, wherein the second RRC information comprises L3 measurements or MDT information.

Aspect 68: The method of any of aspects 61 through 67, wherein the reference signal configuration corresponds to one or more sets of beams for measurement.

Aspect 69: A UE for wireless communications, comprising a processing system that includes processor circuitry and memory circuitry that stores code, the processing system configured to cause the UE to perform a method of any of aspects 54 through 60.

Aspect 70: A UE for wireless communications, comprising at least one means for performing a method of any of aspects 54 through 60.

Aspect 71: A non-transitory computer-readable medium storing code for wireless communications, the code comprising instructions executable by one or more processors to perform a method of any of aspects 54 through 60.

Aspect 72: A network entity for wireless communications, comprising a processing system that includes processor circuitry and memory circuitry that stores code, the processing system configured to cause the network entity to perform a method of any of aspects 61 through 68.

Aspect 73: A network entity for wireless communications, comprising at least one means for performing a method of any of aspects 61 through 68.

Aspect 74: A non-transitory computer-readable medium storing code for wireless communications, the code comprising instructions executable by one or more processors to perform a method of any of aspects 61 through 68.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, via first radio resource control (RRC) information, configuration information indicative of a reference signal configuration for measurement of one or more reference signals, wherein the configuration information is indicative of one or more events for transmission of the measurement of the one or more reference signals, and wherein the configuration information is received from a network entity in a non-split architecture or from a central unit (CU) in a split architecture; and
transmit, via second RRC information and based at least in part on the one or more events, data indicative of the measurement of the one or more reference signals.

2. The UE of claim 1, wherein the one or more processors are individually or collectively further operable to execute the code to cause the UE to:
receive the one or more reference signals based at least in part on the configuration information; and
perform the measurement of the one or more reference signals, wherein the measurement is stored based at least in part on the one or more events.

3. The UE of claim 1, wherein the one or more processors are individually or collectively further operable to execute the code to cause the UE to:
store, based at least in part on the one or more events, training data for training an artificial intelligence (AI) model, the training data based at least in part on the one or more reference signals.

4. The UE of claim 1, wherein the one or more events comprise a first event of a serving cell signal that is greater than a first absolute threshold, a second event of the serving cell signal that is less than a second absolute threshold, or a combination thereof.

5. The UE of claim 1, wherein the configuration information is indicative of one or more identifiers corresponding to the reference signal configuration.

6. The UE of claim 1, wherein the second RRC information comprises layer 3 (L3) measurements or minimization of drive test (MDT) information.

7. The UE of claim 1, wherein the reference signal configuration corresponds to one or more sets of beams for measurement.

8. A network entity, comprising:
one or more memories storing processor-executable code; and
one or more processors coupled with the one or more memories and individually or collectively operable to execute the code to cause the network entity to:
output, via first radio resource control (RRC) information, configuration information indicative of a reference signal configuration for measurement of one or more reference signals, wherein the configuration information is indicative of one or more events for transmission of the measurement of the one or more reference signals, and wherein the network entity is a network entity in a non-split architecture or is a central unit (CU) in a split architecture; and
obtain, via second RRC information and based at least in part on the one or more events, data indicative of the measurement of the one or more reference signals.

9. The network entity of claim 8, wherein the one or more processors are individually or collectively further operable to execute the code to cause the network entity to:
output the one or more reference signals based at least in part on the configuration information.

10. The network entity of claim 8, wherein the one or more processors are individually or collectively further operable to execute the code to cause the network entity to:
obtain, from a distributed unit (DU), an indication of the one or more events, wherein the configuration information is based at least in part on the indication of the one or more events.

11. The network entity of claim 10, wherein the indication of the one or more events is obtained via a midhaul communication link.

12. The network entity of claim 8, wherein the one or more events comprise a first event of a serving cell signal that is greater than a first absolute threshold, a second event of the serving cell signal that is less than a second absolute threshold, or a combination thereof.

13. The network entity of claim 8, wherein the configuration information is indicative of one or more identifiers corresponding to the reference signal configuration.

14. The network entity of claim 8, wherein the second RRC information comprises layer 3 (L3) measurements or minimization of drive test (MDT) information.

15. The network entity of claim 8, wherein the reference signal configuration corresponds to one or more sets of beams for measurement.

16. A user equipment (UE), comprising:
one or more memories storing processor-executable code; and
one or more processors coupled with the one or more memories and individually or collectively operable to execute the code to cause the UE to:
receive, at a first location, a first reference signal that corresponds to a first beam;
store first data for training of an artificial intelligence (AI) model for beam prediction, the first data based at least in part on the first reference signal;
receive, at a second location, a second reference signal that corresponds to a second beam;
determine whether to store second data for training of the AI model for beam prediction based at least in part on a distance between the first location and the second location, the second data based at least in part on the second reference signal; and
transmit, to a network entity, at least one of the first data or the second data.

17. The UE of claim 16, wherein the UE stores the second data based at least in part on the distance between the first location and the second location that satisfies a threshold distance.

18. The UE of claim 16, wherein the UE refrains from storing the second data based at least in part on the distance between the first location and the second location failing to satisfy a threshold distance.

19. The UE of claim 16, wherein the one or more processors are individually or collectively further operable to execute the code to cause the UE to:
receive configuration information that indicates a threshold distance, wherein the first reference signal is received at a first occasion of a set of occasions and the second reference signal is received at a second occasion of the set of occasions, and wherein the UE stores the second data based at least in part on the distance between the first location and the second location that satisfies the threshold distance.

20. The UE of claim 16, wherein the determination whether to store the second data is based at least in part on a trajectory of the UE, the distance between the first location and the second location, or a quantity of occasions to receive reference signals.
